(19) United States
(12) Patent Application Publication
(10) Pub. No.: US 2025/0022480 A1
(43) Pub. Date: Jan. 16, 2025

(54) APPARATUSES FOR PROVIDING A PROCESSED AUDIO SIGNAL, APPARATUSES FOR PROVIDING NEURAL NETWORK PARAMETERS, METHODS AND COMPUTER PROGRAM

(71) Applicant: Fraunhofer-Gesellschaft zur Förderung der angewandten Forschung e.V., München (DE)

(72) Inventors: Martin STRAUSS, Nürnberg (DE); Bernd EDLER, Fürth (DE); Matteo TORCOLI, Nürnberg (DE)

(73) Assignee: Fraunhofer-Gesellschaft zur Förderung der angewandten Forschung e.V., München (DE)

(21) Appl. No.: 18/900,712

(22) Filed: Sep. 28, 2024

Related U.S. Application Data
(63) Continuation of application No. PCT/EP2023/058055, filed on Mar. 28, 2023.

(30) Foreign Application Priority Data
Mar. 28, 2022 (EP) 22164881.9

(51) Int. Cl. G10L 21/0208; G10L 19/022; G10L 25/30

(52) U.S. Cl. CPC G10L 21/0208; G10L 19/022; G10L 25/30

(57) ABSTRACT

Embodiments according to the invention relate to apparatuses for providing a processed audio signal, apparatuses for providing neural network parameters, methods and computer programs.

Embodiments according to the invention relate to Improved Normalizing Flow-Based Speech Enhancement Using an All-Pole Gammatone Filterbank for Conditional Input Representation.

Embodiments according to the invention relate to Improved Normalizing Flow-Based Speech Enhancement with Varied Input Conditions.

### CROSS-REFERENCE TO RELATED APPLICATIONS

This application is a continuation of copending International Application No. PCT/EP2023/058055, filed Mar. 28, 2023, which is incorporated herein by reference in its entirety, and additionally claims priority from European Application No. EP 22164881.9, filed Mar. 28, 2022, which is also incorporated herein by reference in its entirety.

Embodiments according to the invention relate to apparatuses for providing processed audio signals, apparatuses for providing neural network parameters, methods and computer programs.

Embodiments according to the invention relate to Improved Normalizing Flow-Based Speech Enhancement Using an All-Pole Gammatone Filterbank for Conditional Input Representation.

Embodiments according to the invention relate to Improved Normalizing Flow-Based Speech Enhancement with Varied Input Conditions.

### BACKGROUND OF THE INVENTION

Speech enhancement (SE) aims to improve the quality of a degraded speech signal, for example with regard to intelligibility. Degradation may, for example, be caused by background noise.

Applications of speech enhancement comprise, inter alia, automatic speech recognition [2], speech coding [3], hearing aids [4], and broadcasting [5].

Hence, a multitude of approaches for speech enhancement involving the distinction of a target speech signal from an intrusive background is currently known.

Therefore, a multitude of approaches have been developed. These approaches comprise more traditional techniques such as spectral subtraction [6], Wiener filter [7] or subspace methods [8], as well as approaches based on Deep Neural Networks (DNN).

For example, according to common approaches, a separation mask is estimated by minimizing a distance metric to extract the clean speech components in Time-Frequency (TF) domain [9, 10] or a learned subspace [11].

Still, in recent years, there has been an increasing interest in generative approaches trying to outline the probability distribution of speech signals. The most prominent examples include Generative Adversarial Networks (GANs) [12, 13], Variational Autoencoders (VAE) [14], autoregressive models [15] and diffusion probabilistic models [16].

However, such conventional approaches still suffer drawbacks, with regard to enhanced audio quality. As an example, even state-of-the-art GAN-based methods, especially at lower SNRs, still yield unsatisfactory results in perceptual evaluation via listening tests.

In view of the above, there is a desire to create a concept for an audio signal enhancement which provides for an improved tradeoff between computational complexity, training efficiency and achievable audio quality.

This object is achieved by the subject matter of the independent claims. Further advantageous aspects are the subject of the dependent claims.

### SUMMARY

In the following, embodiments according to a first aspect of the invention are discussed. It is to be noted that the presentation of embodiments according to separate aspects is only for ease of understanding. Furthermore, it is to be noted that embodiments according to the first aspect may optionally comprise any of the features, functionalities and/or details of any embodiment of any of the other inventive aspects (in particular of any of the embodiments of the second and/or third aspect) both individually or taken in combination. Vice versa, embodiments according to any of the other inventive aspects (in particular of any of the embodiments of the second and/or third aspect) may optionally comprise any of the features, functionalities and/or details of any embodiment of the first aspect both individually or taken in combination.

Furthermore, it is to be noted that features, functionalities and details in brackets, e.g. (feature), are optional.

An embodiment may have an apparatus for providing a processed audio signal on the basis of an input audio signal, wherein the apparatus is configured to process a noise signal, or a signal derived from the noise signal, using one or more flow blocks, in order to obtain the processed audio signal, wherein the apparatus is configured to adapt a processing performed using the one or more flow blocks in dependence on the input audio signal and using a neural network; wherein the apparatus is configured to obtain a preprocessed representation of the input audio signal using a filterbank including time resolutions and/or frequency resolutions which are adapted to time resolutions and/or frequency resolutions of a human auditory system; and wherein the neural network is configured to receive the preprocessed representation of the input audio signal.

Another embodiment may have an apparatus for providing a processed audio signal on the basis of an input audio signal, wherein the apparatus is configured to process a noise signal, or a signal derived from the noise signal, using one or more flow blocks, in order to obtain the processed audio signal, wherein the apparatus is configured to adapt a processing performed using the one or more flow blocks in dependence on the input audio signal and using a neural network; wherein the apparatus is configured to obtain a preprocessed representation of the input audio signal using an All-Pole-Gammatone Filterbank; and wherein the neural network is configured to receive the preprocessed representation of the input audio signal.

Another embodiment may have an apparatus for providing a processed audio signal on the basis of an input audio signal, wherein the apparatus is configured to process a noise signal, or a signal derived from the noise signal, using one or more flow blocks, in order to obtain the processed audio signal, wherein the apparatus is configured to adapt a processing performed using the one or more flow blocks in dependence on the input audio signal and using a neural network; wherein the apparatus is configured to apply depth-wise separable convolutions to a representation of the input audio signal, in order to derive a preprocessed representation of the input audio signal; wherein the neural network is configured to receive the preprocessed representation of the input audio signal.

Another embodiment may have an apparatus for providing a processed audio signal on the basis of an input audio signal, wherein the apparatus is configured to process a noise signal, or a signal derived from the noise signal, using one or more flow blocks, in order to obtain the processed audio signal, wherein the apparatus is configured to adapt a processing performed using the one or more flow blocks in dependence on the input audio signal and using a neural network; wherein the one or more flow blocks include at least one double coupling flow block; wherein the double coupling flow block is configured to apply a first affine transform to a first portion of input signals to be modified by the double coupling flow block, and wherein the double coupling flow block is configured to apply a second affine transform to a second portion of the input signals to be modified by the double coupling flow block.

Another embodiment may have an apparatus for providing neural network parameters for an audio processing, wherein the apparatus is configured to process a training audio signal, or a processed version thereof, using one or more flow blocks in order to obtain a training result signal, wherein the apparatus is configured to adapt a processing performed using the one or more flow blocks in dependence on a distorted version of the training audio signal and using a neural network; wherein the apparatus is configured to determine neural network parameters of the neural networks, such that a characteristic of the training result audio signal approximates or includes a predetermined characteristic, wherein the apparatus is configured to apply depth-wise separable convolutions to a representation of the distorted version of the training audio signal, in order to derive a preprocessed representation of the distorted version of the training audio signal; wherein the neural network is configured to receive the preprocessed representation of the distorted version of the training audio signal.

Another embodiment may have an apparatus for providing neural network parameters for an audio processing, wherein the apparatus is configured to process a training audio signal, or a processed version thereof, using one or more flow blocks in order to obtain a training result signal, wherein the apparatus is configured to adapt a processing performed using the one or more flow blocks in dependence on a distorted version of the training audio signal and using a neural network; wherein the apparatus is configured to determine neural network parameters of the neural networks, such that a characteristic of the training result audio signal approximates or includes a predetermined characteristic, wherein the one or more flow blocks include at least one double coupling flow block; wherein the double coupling flow block is configured to apply a first affine transform to a first portion of input signals to be modified by the double coupling flow block, and wherein the double coupling flow block is configured to apply a second affine transform to a second portion of the input signals to be modified by the double coupling flow block.

Another embodiment may have an apparatus for providing neural network parameters for an audio processing, wherein the apparatus is configured to process a training audio signal, or a processed version thereof, using one or more flow blocks in order to obtain a training result signal, wherein the apparatus is configured to adapt a processing performed using the one or more flow blocks in dependence on a distorted version of the training audio signal and using a neural network; wherein the apparatus is configured to determine neural network parameters of the neural networks, such that a characteristic of the training result audio signal approximates or includes a predetermined characteristic, wherein the apparatus is configured to obtain a preprocessed representation of the distorted version of the training audio signal using a filterbank including time resolutions and/or frequency resolutions which are adapted to time resolutions and/or frequency resolutions of a human auditory system; and wherein the neural network is configured to receive the preprocessed representation of the distorted version of the training audio signal.

According to another embodiment, a method for providing a processed audio signal on the basis of an input audio signal, may have the steps of: processing a noise signal, or a signal derived from the noise signal, using one or more flow blocks, in order to obtain the processed audio signal, adapting a processing performed using the one or more flow blocks in dependence on the input audio signal and using a neural network; applying depth-wise separable convolutions to a representation of the input audio signal, in order to derive a preprocessed representation of the input audio signal; wherein the neural network receives the preprocessed representation of the input audio signal.

According to another embodiment, a method for providing a processed audio signal on the basis of an input audio signal may have the steps of: processing a noise signal, or a signal derived from the noise signal, using one or more flow blocks, in order to obtain the processed audio signal, adapting a processing performed using the one or more flow blocks in dependence on the input audio signal and using a neural network; wherein the one or more flow blocks include at least one double coupling flow block; wherein the double coupling flow block applies a first affine transform to a first portion of input signals to be modified by the double coupling flow block, and wherein the double coupling flow block applies a second affine transform to a second portion of the input signals to be modified by the double coupling flow block.

According to another embodiment, a method for providing a processed audio signal on the basis of an input audio signal may have the steps of: processing a noise signal, or a signal derived from the noise signal, using one or more flow blocks, in order to obtain the processed audio signal, adapting a processing performed using the one or more flow blocks in dependence on the input audio signal and using a neural network; obtaining a preprocessed representation of the input audio signal using a filterbank including time resolutions and/or frequency resolutions which are adapted to time resolutions and/or frequency resolutions of a human auditory system; and wherein the neural network receives the preprocessed representation of the input audio signal.

According to another embodiment, a method for providing neural network parameters for an audio processing may have the steps of processing a training audio signal, or a processed version thereof, using one or more flow blocks in order to obtain a training result signal, adapting a processing performed using the one or more flow blocks in dependence on a distorted version of the training audio signal and using a neural network; determining neural network parameters of the neural networks, such that a characteristic of the training result audio signal approximates or includes a predetermined characteristic, applying depth-wise separable convolutions to a representation of the distorted version of the training audio signal, in order to derive a preprocessed representation of the distorted version of the training audio signal; wherein the neural network receives the preprocessed representation of the distorted version of the training audio signal.

According to another embodiment, a method for providing neural network parameters for an audio processing may have the steps of: processing a training audio signal, or a processed version thereof, using one or more flow blocks in order to obtain a training result signal, adapting a processing performed using the one or more flow blocks in dependence on a distorted version of the training audio signal and using a neural network; determining neural network parameters of the neural networks, such that a characteristic of the training result audio signal approximates or includes a predetermined characteristic, wherein the one or more flow blocks include at least one double coupling flow block; wherein the double coupling flow block applies a first affine transform to a first portion of input signals to be modified by the double coupling flow block, and wherein the double coupling flow block applies a second affine transform to a second portion of the input signals to be modified by the double coupling flow block.

According to another embodiment, a method for providing neural network parameters for an audio processing may have the steps of: processing a training audio signal, or a processed version thereof, using one or more flow blocks in order to obtain a training result signal, adapting a processing performed using the one or more flow blocks in dependence on a distorted version of the training audio signal and using a neural network; determining neural network parameters of the neural networks, such that a characteristic of the training result audio signal approximates or includes a predetermined characteristic, obtaining a preprocessed representation of the distorted version of the training audio signal using a filterbank including time resolutions and/or frequency resolutions which are adapted to time resolutions and/or frequency resolutions of a human auditory system; and wherein the neural network receives the preprocessed representation of the distorted version of the training audio signal.

Another embodiment may have a transitory digital storage medium having a computer program stored thereon to perform any of the inventive methods when said computer program is run by a computer.

Embodiments according to the first aspect of the invention comprise an apparatus for providing a processed audio (e.g. speech) signal (e.g. an enhanced audio signal) (e.g. an enhanced speech signal or an enhanced general audio signal; e.g. x\hat{ }, e.g. \hat{x}) on the basis of an input audio (e.g. speech) signal (e.g. a distorted audio signal, e.g. a noisy speech signal y, e.g. a clean signal x extracted from the noisy speech signal y, e.g. y=x+n (noise, e.g. noisy background)), wherein the apparatus is configured to process (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }, e.g. \hat{x}). The apparatus is configured to adapt a processing performed using the one or more flow blocks in dependence on the input audio signal (e.g. the distorted audio signal, e.g. in dependence on a noisy speech signal y; e.g. in dependence on noisy time domain speech samples) and using a neural network (which may, for example, provide one or more processing parameters for the flow block, e.g. parameters of an affine processing, like a scaling factor and a shift value, on the basis of the distorted audio signal, and also in dependence on at least a part of the noise signal, or a processed version thereof).

Furthermore, the apparatus is configured to obtain a preprocessed representation of the input audio signal (e.g. a “conditional signal representation”, wherein, for example, the input audio signal may serve as a conditional signal which is used to adapt the processing performed using the one or more flow blocks) using a filterbank comprising time resolutions and/or frequency resolutions which are adapted to time resolutions and/or frequency resolutions of a human auditory system (e.g. using an All-Pole-Gammatone Filterbank) (which may, for example, comprise a set of bandpass filters, wherein, for example, the bandpass filters may be infinite-impulse-response bandpass filters) (wherein, for example, time/resolutions and/or frequency resolutions of individual filters of the filterbank may be adapted to time resolutions and/or to frequency resolutions of the human auditory system).

In addition, the neural network is configured to receive the preprocessed representation of the input audio signal (e.g. as input values) (and, optionally, to provide one or more processing parameters for the flow block on the basis of the preprocessed representation of the input audio signal).

Embodiments according to the first aspect of the invention are based on the finding that processing of audio signals, for example, for speech enhancement purpose, can be performed directly using flow blocks processing, which may, for example, model a generative process. It has been found that the flow block processing allows to process a noise signal, e.g. a noise signal z, e.g. generated by the apparatus, or e.g. stored in the apparatus, in a manner conditioned on the input audio signal, e.g. a noisy audio signal y. The noise signal z represents (or comprises) a given (e.g. simple or complex) probability distribution, advantageously a Gaussian probability distribution. It has been found that upon processing of the noise signal conditioned on the distorted audio signal, an enhanced clean part of the input audio signal is provided as a result of the processing without introducing this clean part, e.g. without a noisy background, as an input to the apparatus.

Furthermore, the inventors recognized that using a filterbank comprising time resolutions and/or frequency resolutions which are adapted to time resolutions and/or frequency resolutions of a human auditory system allows to obtain the preprocessed representation of the input audio signal with improved audio quality, which may hence improve a quality of an adaptation of the processing of the input audio signal, e.g. in the form of the noise signal via the flow block by the neural network, and hence the processed audio signal. In particular, it was recognized that a preprocessing of an distorted, e.g. to be enhanced, audio signal in the context of noise shaping may be improved significantly by taking into account human hearing characteristics. Furthermore, the inventors found out that human hearing characteristics may be taken into account by adapting the design of a respective filterbank with regard to time resolutions and/or frequency resolutions.

Moreover, it has been recognized that the preprocessing using the filterbank may provide a particularly meaningful input information to the neural network, which means that the neural network can efficiently determine the processing parameters for the flow block. It has been recognized that the output of the filterbank, which is adapted to the human auditory system, comprises the most important information in a “condensed” form, and therefore is well suited as an input for the neural network. Thus, it has been recognized that the filterbank is well suited as a pre-processing flow block based audio enhancement.

Hence, an improved tradeoff between computational complexity, training efficiency and achievable audio quality may be achieved.

According to embodiments of the first aspect of the invention, time resolutions of the filterbank and frequency resolutions of the filterbank approximate time resolutions and frequency resolutions of the human auditory system. The inventors recognized that usage of a perceptually motivated filterbank, for example mimicing or approximating the human auditory system allows to improve a quality of the preprocessed representation of the input audio signal.

According to embodiments of the first aspect of the invention, filters of the filterbank (e.g. at least a plurality of filters of the filterbank, or even all filters of the filterbank) are infinite impulse response filters. Such filters may be implemented efficiently.

According to embodiments of the first aspect of the invention, the filterbank is an All-Pole Gammatone Filterbank (e.g. a complex All-Pole-Gammatone-Filterbank). The inventors found out that All-Pole Gammatone Filterbank allow a good trade-off with regard to computational complexity and representing human hearing characteristics.

Embodiments according to the first aspect of the invention comprise an apparatus for providing a processed audio (e.g. speech) signal (e.g. an enhanced audio signal) (e.g. an enhanced speech signal or an enhanced general audio signal; e.g. x\hat{ }, e.g. \hat{x}) on the basis of an input audio (e.g. speech) signal (e.g. a distorted audio signal, e.g. a noisy speech signal y, e.g. a clean signal x extracted from the noisy speech signal y, e.g. y=x+n (noise, e.g. noisy background)), wherein the apparatus is configured to process (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }, e.g. \hat{x}). Furthermore, the apparatus is configured to adapt a processing performed using the one or more flow blocks in dependence on the input audio signal (e.g. the distorted audio signal, e.g. in dependence on a noisy speech signal y; e.g. in dependence on noisy time domain speech samples) and using a neural network (which optionally provides one or more processing parameters for the flow block, e.g. parameters of an affine processing, like a scaling factor and a shift value, on the basis of the distorted audio signal, and also in dependence on at least a part of the noise signal, or a processed version thereof).

In addition, the apparatus is configured to obtain a preprocessed representation of the input audio signal (e.g. a “conditional signal representation”, wherein, for example, the input audio signal may serve as a conditional signal which is used to adapt the processing performed using the one or more flow blocks) using an All-Pole-Gammatone Filterbank (which may, for example, comprise a set of bandpass filters, wherein, for example, the bandpass filters may be infinite-impulse-response bandpass filters) and the neural network is configured to receive the preprocessed representation of the input audio signal (e.g. as input values) (and to provide one or more processing parameters for the flow block on the basis of the preprocessed representation of the input audio signal).

According to embodiments of the first aspect of the invention, the All-Pole-Gamatone Filterbank is configured to obtain a plurality of channel signals associated with a plurality of (overlapping or non-overlapping) frequency bands (wherein, for example, a ratio between a width of a lowest frequency band of the All-Pole-Gammatone Filterbank and a width of a highest frequency band of the All-Pole-Gammatone Filterbank lies within a range between 1:10 and 1:50), wherein widths of the frequency bands increase monotonically with increasing center frequencies of the respective frequency bands, and/or wherein widths of the frequency bands are adapted in accordance with a psychoacoustic model (e.g. in accordance with a Bark-scale or an ERB scale), and/or wherein center frequencies of the frequency bands are adapted in accordance with a psychoacoustic model (e.g. in accordance with a Bark-scale or an ERB scale). The pre-processing of a plurality of channel signals of different frequency bands and in particular in accordance with a psychoacoustic model allows good trade-off with regard to computational complexity and processed signal quality.

According to embodiments of the first aspect of the invention, the All-Pole-Gammatone Filterbank comprises a plurality of filters (e.g. infinite impulse response filters) and center frequencies of the filters comprise constant distances (e.g., optionally, within a tolerance of +/−10 percent or +/−5 percent) on a Bark scale with increasing bandwidth at increasing frequencies (e.g. proportional to the Bark-bandwidths). The inventors recognized that a filter design taking into account the Bark scale may allow to efficiently represent human hearing characteristics in the filtering step.

According to embodiments of the first aspect of the invention, the All-Pole-Gammatone Filterbank is configured to at least partially compensate different group delays between different filters (e.g. using a look-ahead for one or more of the filters of the All-Pole-Gammatone Filterbank) (wherein, for example, look-aheads for different filters are configured in dependence on, or in accordance with, group delays at center frequencies of the different filters of the All-Pole-Gammatone Filterbank). The inventors recognized that a compensation of group delays may increase the filter efficiency.

According to embodiments of the first aspect of the invention, a transfer function of the All-Pole-Gammatone Filterbank does not comprise any finite zero point.

According to embodiments of the first aspect of the invention, imaginary parts of poles of a transfer function of the All-Pole-Gammatone Filterbank all comprise a same sign (e.g. all comprise a positive sign or, alternatively, all comprise a negative sign). It has been found that such a choice of the poles of the transfer function results in output signals of the filterbank which are efficiently useable by the neural network.

According to embodiments of the first aspect of the invention, the All-Pole-Gamatone Filterbank is a Complex All-Pole-Gammatone-Filterbank (e.g. is an All-Pole-Gammatone-Filterbank which provides complex-valued output signals in response to a real-valued input signal).

According to embodiments of the first aspect of the invention, the one or more poles of a transfer function of the All-Pole-Gamatone Filterbank (or even all poles of a transfer function of the All-Pole-Gammatone Filterbank) coincide.

The inventors recognized that the above explained implementation variants of the All-Pole-Gamatone Filterbank allow a provision of an efficient filterbank for the preprocessing of the input audio signal in order to provide an input signal for the neural network that allows to provide well adapted parameters for the processing in the flow block.

According to embodiments of the first aspect of the invention, the apparatus is configured to obtain the preprocessed representation of the input audio signal on the basis of magnitudes of (e.g. complex-valued) output signals of the All-Pole-Gammatone-Filterbank (wherein, for example, the apparatus is configured to determine a magnitude of a complex-valued output value of the All-Pole-Gammatone-Filterbank). In addition or alternatively, the apparatus is configured to neglect phase information of the (e.g. complex-valued) output signals of the All-Pole-Gammatone-Filterbank. Hence, the amount of information processed may be reduced in order to increase the processing efficiency.

According to embodiments of the first aspect of the invention, the All-Pole-Gammatone-Filterbank is configured to provide between 20 and 100 output signals (e.g. output signals, associated with between 20 and 100 different frequency bands), wherein the output signals of the filterbank may, for example, be input into the neural network. It has been recognized that such a number of output signals of the filterbank is well-manageable by the neural network and well reflects the psycho-accoustically most relevant features of the input audio signal. Accordingly, the neural network can efficiently provide good processing parameters for the flow block on the basis of such a set of input signals.

According to embodiments of the first aspect of the invention, the apparatus is configured to apply a plurality of convolutions to a set of output values of the All-Pole-Gammatone Filterbank (e.g. to a set of output values of the All-Pole-Gammatone Filterbank associated with a plurality of frequency bands and with a plurality of time instances), or to a set of magnitude values derived from output values of the All-Pole-Gammatone Filterbank (e.g. to magnitude values derived from a set of output values of the All-Pole-Gammatone Filterbank associated with a plurality of frequency bands and with a plurality of time instances), in order to obtain input values of the neural network. Hence, in addition to a filter bank a preprocessing unit, e.g. an additional preprocessing unit configured to perform convolutions may be implemented between filterbank and neural network. The inventors recognized that the input signal for the neural network may be improved using the combination of the filtering and succeeding convolutions.

According to embodiments of the first aspect of the invention, the apparatus is configured to apply depth-wise separable convolutions (e.g. a plurality of depth-wise separable convolutions) to a set of output values of the All-Pole-Gammatone Filterbank (e.g. to a set of output values of the All-Pole-Gammatone Filterbank associated with a plurality of frequency bands and with a plurality of time instances), or to a set of magnitude values derived from output values of the All-Pole-Gammatone Filterbank (e.g. to magnitude values derived from a set of output values of the All-Pole-Gammatone Filterbank associated with a plurality of frequency bands and with a plurality of time instances), in order to obtain input values of the neural network (wherein the input values of the neural network, which may, for example, represent the preprocessed version of the input audio signal, may, for example, comprise, per sample of the input audio signal, a plurality of convolution values, wherein the convolution values are, for example, results of different convolutions of the representation of the input audio signal with different convolution kernels). This may allow to reduce a complexity and/or number of parameters involved in the processing, see e.g. FIG. 4.

Furthermore, according to some embodiments of the first aspect of the invention, usage of the filterbank may improve results, e.g. in audio quality, but may increase the complexity of the processing, e.g. because of an increased number of parameters. However, yet a better compromise between audio quality and processing complexity may be achieved based on a significant improvement in processed, e.g. enhanced, audio quality and a, in relation, minor increase in number of parameters.

In the following embodiments according to a second aspect of the invention are discussed. It is to be noted that embodiments according to the second aspect may optionally comprise any of the features, functionalities and/or details of any embodiment of any of the other inventive aspects (in particular of any of the embodiments of the first and/or third aspect) both individually or taken in combination. Vice versa embodiments according to any of the other inventive aspects (in particular of any of the embodiments of the first and/or third aspect) may optionally comprise any of the features, functionalities and/or details of any embodiment of the second aspect both individually or taken in combination.

Embodiments according to the second aspect of the invention comprise an apparatus for providing a processed audio (e.g. speech) signal (e.g. an enhanced audio signal) (e.g. an enhanced speech signal or an enhanced general audio signal; e.g. x\hat{ }, e.g. \hat{x}) on the basis of an input audio (e.g. speech) signal (e.g. a distorted audio signal, e.g. a noisy speech signal y, e.g. a clean signal x extracted from the noisy speech signal y, y=x+n (noise, e.g. noisy background)), wherein the apparatus is configured to process (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }, e.g. \hat{x}).

Furthermore, the apparatus is configured to adapt a processing performed using the one or more flow blocks in dependence on the input audio signal (e.g. the distorted audio signal, e.g. in dependence on a noisy speech signal y; e.g. in dependence on noisy time domain speech samples) and using a neural network (which optionally provides one or more processing parameters for the flow block, e.g. parameters of an affine processing, like a scaling factor and a shift value, on the basis of the distorted audio signal, and also in dependence on at least a part of the noise signal, or a processed version thereof).

In addition, the apparatus is configured to apply depth-wise separable convolutions to a representation of the input audio signal, in order to derive a preprocessed representation of the input audio signal (wherein the preprocessed version of the input audio signal may, for example, comprise, per sample of the input audio signal, a plurality of convolution values, wherein the convolution values are, for example, results of different convolutions of the representation of the input audio signal with different convolution kernels).

Furthermore, the neural network is configured to receive the preprocessed representation of the input audio signal (and to provide one or more processing parameters for the flow block on the basis of the preprocessed representation of the input audio signal).

Embodiments according to the second aspect are based on the finding that based on the preprocessing of the input audio signal the quality of information provided to the neural network may be improved. Based on the preprocessing, the neural network may hence provide an adaptation information for the flow block, wherein the noise shaping may be adapted or guided based on the input audio signal. The inventors further recognized that an implementation of such a preprocessing, e.g. optionally with or without a preceding filtering step, e.g. using a filterbank, may be performed efficiently based on depthwise separable convolutions. This way a complexity of the processing of the input audio signal may be reduced via an reduction of the number of parameters involved, see e.g. FIG. 4. It has been recognized that the storage of the parameters of depthwise separable convolutions consumes significantly less memory space than a storage of the parameters of a non-depthwise-separable convolution. Furthermore, the application of the depthwise separable convolutions can also be made with significantly reduced effort when compared to non-depthwise-separable convolutions, since processing blocks can be reused multiple times without a parameter update. Moreover, it has been found that the usage of depthwise separable convolutions does not noticeably degrade a result of the processing. Consequently, the usage of depthwise separable convolutions brings along a good compromise between processing complexity and an achievable audio quality.

According to embodiments of the second aspect of the invention, the depth-wise separable convolutions are configured to perform temporal convolutions and convolutions in a frequency direction.

According to embodiments of the second aspect of the invention, the apparatus is configured to obtain a representation of the input audio signal using an All-Pole-Gammatone Filterbank, and the apparatus is configured to apply the depth-wise separate convolutions to the representation of the input audio signal obtained using the All-Pole-Gammatone Filterbank.

According to embodiments of the second aspect of the invention, the representation of the input audio signal obtained using the All-Pole Gammatone Filterbank comprises a plurality (e.g. between 20 and 100) of subband signals (e.g. a plurality, e.g. between 20 and 100, signal values per sample of the input audio signal).

According to embodiments of the second aspect of the invention, the apparatus is configured to apply different convolutions to the plurality of subband signals, in order to obtain input signals for the neural network (wherein, for example, a number input signals is larger, e.g. at least ten times larger, than a number of subband signals provided by the All-Pole Gammatone Filterbank).

According to embodiments of the second aspect of the invention, the apparatus is configured to apply separate temporal convolutions (e.g. 80 temporal convolutions, each considering 3 values associated with different time instances) to a plurality of signals representing the input audio signal (e.g. to channel signals of an All-Pole Gammatone Filterbank; e.g. to 80 channel signals of the All-Pole Gammatone Filterbank), in order to obtain a plurality of temporally convolved signal values (wherein said temporal convolutions may, for example, be defined by different temporal convolution kernels, e.g. associated with different frequencies or with different frequency bands)(e.g. 80 result values of the 80 separate temporal convolutions).

Furthermore the apparatus is configured to apply a plurality of convolutions (e.g. 2000 different convolutions) over frequency to a given set of temporally convolved signal values (e.g. to a given set of convolved signal values associated with a given time instance)(e.g. to the 80 result values of the 80 separate temporal convolutions), in order to obtain a plurality of input values of the neural network.

Optionally, as an example, each of the input values of the neural network may be obtained using a respective convolution, and, as an example, different input values of the neural network (e.g. associated with a same time) may be obtained using respective convolutions on the basis of a common (e.g. given) set of temporally convolved signal values.

Furthermore, optionally, as an example, a number of input values of the neural network (e.g. per sample time instance) may be larger, e.g. at least by a factor of 10, than a number of values of the representation of the input audio signal to which the depth-wise separable convolutions are applied.

According to embodiments of the second aspect of the invention, the apparatus is configured to apply the depth-wise separable convolutions to a representation of the input audio signal, in order to map an input space (e.g. defined by values of channel signals associated with different frequency bands and derived from the input audio signal, e.g. using an All-Pole-Gammatone Filterbank) to a higher dimension (or to higher dimensions).

According to embodiments of the second aspect of the invention, the apparatus is configured to perform a plurality of convolutions over frequency (e.g. 2000 convolutions over frequency) on the basis of a same set of result values of (e.g. 80) separate temporal convolutions, wherein the separate temporal convolutions are performed separately on the basis of signals of a frequency-domain representation (e.g. provided by an All-Pole-Gammatone Filterbank) of the input audio signal.

According to embodiments of the second aspect of the invention, the one or more flow blocks comprise at least one double coupling flow block (e.g. inside an affine coupling layer), wherein the (respective) double coupling flow block is configured to apply a first affine transform (transform coefficients of which may, for example, be determined using a neural network, e.g. using a subnetwork providing s1, e.g. s₁ and t1, e.g. t₁) to a first portion (e.g. x1, e.g. x₁) of input signals (e.g. x) to be modified by the (e.g. respective) double coupling flow block, and wherein the (e.g. respective) double coupling flow block is configured to apply a second affine transform (e.g. transform coefficients of which may, for example, be determined using a neural network, e.g. using a neural subnetwork providing s2, e.g. \hat{x}₂ and t2, e.g. t₂) to a second portion (which may be different from the first portion) (e.g. x2, e.g. x₂) of the input signals (e.g. x) to be modified by the (respective) double coupling flow block.

According to embodiments of the second aspect of the invention, the apparatus is configured to obtain a preprocessed representation of the input audio signal (e.g. a “conditional signal representation”, wherein, for example, the input audio signal may serve as a conditional signal which is used to adapt the processing performed using the one or more flow blocks) using a filterbank comprising time resolutions and/or frequency resolutions which are adapted to time resolutions and/or frequency resolutions of a human auditory system (e.g. using an All-Pole-Gammatone Filterbank) (which may, for example, comprise a set of bandpass filters, wherein, for example, the bandpass filters may be infinite-impulse-response bandpass filters) (wherein, for example, time/resolutions and/or frequency resolutions of individual filters of the filterbank may be adapted to time resolutions and/or to frequency resolutions of the human auditory system. Furthermore, the neural network is configured to receive the preprocessed representation of the input audio signal (e.g. as input values) (and, optionally, to provide one or more processing parameters for the flow block on the basis of the preprocessed representation of the input audio signal).

According to embodiments of the second aspect of the invention, the apparatus is configured to obtain a preprocessed representation of the input audio signal (e.g. a “conditional signal representation”, wherein, for example, the input audio signal may serve as a conditional signal which is used to adapt the processing performed using the one or more flow blocks) using an All-Pole-Gammatone Filterbank (which may, for example, comprise a set of bandpass filters, wherein, for example, the bandpass filters may be infinite-impulse-response bandpass filters). In addition, the neural network is configured to receive the preprocessed representation of the input audio signal (e.g. as input values) (and to provide one or more processing parameters for the flow block on the basis of the preprocessed representation of the input audio signal).

In the following embodiments according to a third aspect of the invention are discussed. It is to be noted that embodiments according to the third aspect may optionally comprise any of the features, functionalities and/or details of any embodiment of any of the other inventive aspects (in particular of any of the embodiments of the first and/or second aspect) both individually or taken in combination. Vice versa embodiments according to any of the other inventive aspects (in particular of any of the embodiments of the first and/or second aspect) may optionally comprise any of the features, functionalities and/or details of any embodiment of the third aspect both individually or taken in combination.

Embodiments according to the third aspect of the invention comprise an apparatus for providing a processed audio (e.g. speech) signal (e.g. an enhanced audio signal) (e.g. an enhanced speech signal or an enhanced general audio signal; e.g. x\hat{ }, e.g. \hat{x}) on the basis of an input audio (e.g. speech) signal (e.g. a distorted audio signal, e.g. a noisy speech signal y, e.g. a clean signal x extracted from the noisy speech signal y, y=x+n (noise, e.g. noisy background)), wherein the apparatus is configured to process (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }, e.g. \hat{x}).

Furthermore, the apparatus is configured to adapt a processing performed using the one or more flow blocks in dependence on the input audio signal (e.g. the distorted audio signal, e.g. in dependence on a noisy speech signal y; e.g. in dependence on noisy time domain speech samples) and using a neural network (which optionally provides one or more processing parameters for the flow block, e.g. parameters of an affine processing, like a scaling factor and a shift value, on the basis of the distorted audio signal, and also in dependence on at least a part of the noise signal, or a processed version thereof). The one or more flow blocks comprise at least one double coupling flow block (e.g. inside an affine coupling layer), wherein the (respective) double coupling flow block is configured to apply a first affine transform (transform coefficients of which may, for example, be determined using a neural network, e.g. using a subnetwork providing s1, e.g. s₁, and t1, e.g. t₁) to a first portion (e.g. x1, e.g. x₁) of input signals (e.g. x) to be modified by the (respective) double coupling flow block, and wherein the (respective) double coupling flow block is configured to apply a second affine transform (transform coefficients of which may, for example, be determined using a neural network, e.g. using a neural subnetwork providing s2, e.g. s₂, and t2, e.g. t₂) to a second portion (which is different from the first portion) (e.g. x2, e.g. x₂) of the input signals (e.g. x) to be modified by the (respective) double coupling flow block.

The inventors recognized that using the inventive double coupling scheme allows a direct processing of the entire input signal, which allows for a better overall performance. Hence, an expressibility, e.g. expressiveness, may be improved. It has been found that by using two separate affine transforms, which typically comprise some independence, a generation of the output audio signal is facilitated. For example, it can easily be understood that splitting up a signal into two components, separately processing the components, and re-combining the processed components reduces statistical dependencies of the samples that make up the components. This facilitates converting an input signal into white noise. Now, it can be understood that, in the other direction, the processing using two (e.g. separate) affine transforms is well suited to convert a noise signal into the desired processed audio signal. Worded differently, it has been found that splitting up a signal into two (or more) portions, applying separate affine transforms to the two (or more) portions (wherein the affine transforms are controlled by a neural network), and recombining the affinely transformed portions is well suited to generate a good quality output signal on the basis of a noise signal.

As an example, the flow block may comprise an affine coupling layer (optionally together with an invertible convolutional layer). In a first step, the input signal may, for example, be subsampled. For example using the optional invertible convolution layer, the input may, for example, be separated into, for example, two halves, for example, with one part being provided to a subnetwork of the neural network, for example, inside the coupling layer, for example, to learn affine transformation parameters for the second half. The transformed signal may, for example, be concatenated with the unchanged second part and may, for example, serve as an input for the next block. This operation may, for example, be invertible, ensuring that the network is invertible overall, for example, although the subnetwork inside the coupling layer estimating the affine parameters does not need to be invertible. An example of a respective flow block with neural network is shown in FIG. 15.

According to embodiments of the third aspect, the apparatus is configured to adapt a processing to be performed by the first affine transform (e.g. by the affine transform receiving x1 and providing \hat{x}₁) of the double coupling flow block using a neural network (e.g. using a first neural network or using a first subnet) in dependence on input signals (e.g. x2, e.g. x₂) of the second affine transform, and the apparatus is configured to adapt a processing to be performed by the second affine transform (e.g. by the affine transform receiving x2 and providing \hat{x}₂) of the double coupling flow block using a neural network (e.g. using a second neural network or using a second subnet) in dependence on the first portion (e.g. x1) of the input signals (e.g. x) to be modified by the double coupling flow block (e.g. in dependence on output signals of the first affine transform, e.g. in dependence on \hat{x}₁).

According to embodiments of the third aspect, the apparatus is configured to apply a processing using a sequence of a plurality of double-coupling flow blocks, and the apparatus is configured to apply an invertible convolution (which may, for example, be trained in a training phase), in order to obtain input signals for a second double-coupling flow block on the basis of output signals of a preceding first double coupling flow block.

According to embodiments of the third aspect, the (respective) double-coupling flow block is configured to split up the input signals (e.g. x) of the double-coupling flow block, in order to obtain the first portion (e.g. x1, e.g. x₁) of the input signals and the second portion (e.g. x2, e.g. x₂) of the input signals, and to apply separate affine transforms to the first portion of the input signal and to the second portion of the input signal.

According to embodiments of the third aspect, the apparatus is configured to concatenate output signals (e.g. \hat{x}₁ and \hat{x}₂) of the first affine transform and of the second affine transform, in order to obtain the output signals of the (respective) double-coupling flow block (wherein the output signals of the respective double-coupling flow block may serve, e.g. after an invertible 1×1 convolution, as input signals of a subsequent double coupling flow block).

According to embodiments of the third aspect, the apparatus is configured to use the second portion of the input signals (e.g. x2, e.g. x₂) as input signals of a neural network (e.g. a first neural network) for determining transform parameters of the first affine transform (wherein said (e.g. first) neural network (e.g. subnetwork or subnetwork of the neural network) also receives a representation of the input audio signal) and as input signals (e.g. as input signals to be affinely transformed) of the second affine transform.

According to embodiments of the third aspect, the apparatus is configured to use output signals of the first affine transform (e.g. \hat{x}₁) as input signals of a neural network (e.g. a second neural network) for determining transform parameters of the of the second affine transform (wherein said (e.g. second) neural network also, optionally, receives a representation of the input audio signal).

According to embodiments of the third aspect, the double-coupling flow block is configured to separate the input signals (e.g. x) to be modified by the (respective) double coupling flow block into two halves (e.g. into a first portion or first half x1, e.g. x₁, and a second portion of second half x2, e.g. x₂). Furthermore, the double-coupling flow block is configured to use a second half (e.g. x2, e.g. x₂) of the input signals (e.g. x) to be modified by the (respective) double coupling flow block for estimating (e.g. using a first neural network) parameters of an affine transform to be applied to a first half (e.g. x1, e.g. x₁) of the input signals (e.g. x) to be modified by the (respective) double coupling flow block.

According to embodiments of the third aspect, the double-coupling flow block is configured to only modify signals of the first portion (e.g. x1, e.g. x₁) of input signals (e.g. x) to be modified by the (respective) double coupling flow block in a first affine transform (while the signals of the second portion, e.g. x2, e.g. x₂, are left unchanged by the first affine transform), and to only modify signals of the second portion (e.g. x2, e.g. x₂) of input signals (e.g. x) to be modified by the (respective) double coupling flow block in a second affine transform (while the signals of the first portion, e.g. x1 and \hat{x}₁, are left unchanged by the second affine transform).

In the following, further embodiments, in particular embodiments according to any of the first, second and/or third aspect, of the invention are discussed. It is to be noted that the following embodiments optionally comprise any of the features, functionalities and/or details of any embodiment of any of the other inventive aspects (in particular of any of the embodiments of the first, second and/or third aspect) both individually or taken in combination. Vice versa embodiments according to any of the other inventive aspects (in particular of any of the embodiments of the first, second and/or third aspect) may optionally comprise any of the features, functionalities and/or details of any of the following embodiments both individually or taken in combination.

According to embodiments of the invention, the input audio signal is represented by a set of time domain audio samples (e.g. noisy time domain audio, e.g. speech, samples, e.g. time domain speech utterances) (wherein, for example, the time domain audio samples of the input audio signal, or time domain audio samples derived therefrom, are input into the neural network)(wherein, for example, the time domain audio samples of the input audio signal. Or, as an example, the time domain audio samples derived therefrom, are processed in the neural network in the form of a time domain representation, without applying a transformation to transform domain representation (e.g. a spectral domain representation)).

According to embodiments of the invention, a neural network associated with a given flow block (e.g. a given stage of an affine processing) of the one or more flow blocks is configured to determine one or more processing parameters (e.g. s, t) for the given flow block in dependence on the noise signal (z), or a signal derived from the noise signal, and in dependence on the input audio signal (y). It is to be noted that an inventive apparatus may comprise a plurality of flow blocks, e.g. each with a respective neural network. However, the apparatus may as well comprise a neural network with a plurality of subnetworks, wherein sets of subnetworks, e.g. sets of 2 subnetworks, of the plurality of subnetworks may be associated with a respective flow block.

According to embodiments of the invention, a neural network associated with a given flow block (e.g. a given stage of an affine processing) is configured to provide one or more parameters (e.g. s, t) of an affine processing (e.g. in an affine coupling layer), which is applied to the noise signal, or to a processed version of the noise signal, or to a portion of the noise signal, or to a portion of a processed version of the noise signal (e.g. z) during the processing. The inventors recognized that an adaptation of a noise shaping using affine transformation may be performed efficiently using a neural network providing parameters of respective affine transformations.

According to embodiments of the invention, a neural network associated with the given flow block (e.g. the given stage of the affine processing) is configured to determine one or more parameters (e.g. s, t) of the affine processing, in dependence on a first part (z1, e.g. z₁) of a flow block input signal (z) and in dependence on the input audio signal (y). Furthermore, an affine processing associated with the given flow block (e.g. the given stage of the affine processing) is configured to apply the determined parameters (e.g. s, t) to a second part (z2, e.g. z₂) of the flow block input signal (z), to obtain an affinely processed signal(z2\hat{ }, e.g. \hat{z}₂). In addition the first part (z1, e.g. z₁) of the flow block input signal (z) (which is, for example, not modified by the affine processing) and the affinely processed signal (z2\hat{ }, e.g. \hat{z}₂) form (e.g. constitute) a flow block output signal (z_{new}) (e.g. a stage output signal) of the given flow block (the given stage of the affine processing). Hence, embodiments according to the invention may comprise a single-coupling scheme, e.g. as shown in FIG. 21

According to embodiments of the invention, the apparatus is configured to apply an invertible convolution (e.g. a 1×1 invertible convolution) to the flow block output signal (z_{new}) (the stage output signal) of the given flow block (e.g. the given stage of the affine processing) (which may, for example, be an input signal for a subsequent stage, for other subsequent stages following the first stage), to obtain a processed flow block output signal (z′_{new}) (a processed version of the flow block output signal, e.g. a convolved version of the flow block output signal).

According to embodiments of the invention, the apparatus is configured to apply a nonlinear expansion (e.g. an inverse p-law transformation, e.g. reverting a p-law transformation) to the processed (e.g. enhanced) audio signal.

According to embodiments of the invention, the apparatus is configured to apply an inverse μ-law transformation (e.g. inverse μ-law function; e.g. by reverting μ-law transform) as the nonlinear expansion to the processed (e.g. enhanced) audio signal (x\hat{ }, e.g. \hat{x}).

According to embodiments of the invention, the apparatus is configured to apply a transformation according to

$${g}^{- 1} ( x \hat{} ) = sgn ( x \hat{} ) \cdot ( \frac{{( 1 + μ )}^{x \hat{}} - 1}{μ} ) ;$$

to the processed (e.g. enhanced) audio signal (x\hat{ }, e.g. \hat{x}), wherein sgn( ) is a sign function and p is a parameter defining a level of expansion.

According to embodiments of the invention, neural network parameters of the neural network for processing the noise signal, or the signal derived from the noise signal, are obtained (e.g. predetermined, e.g. saved in the apparatus, e.g. saved in a remote server) using a processing of a training audio signal or a processed version thereof, in one or more training flow blocks in order to obtain a training result signal, wherein a processing of the training audio signal or of the processed version thereof using the one or more training flow blocks is adapted in dependence on a distorted version of the training audio signal and using the neural network.

Furthermore, the neural network parameters of the neural networks are determined, such that a characteristic (e.g. a probability distribution) of the training result audio signal approximates or comprises a predetermined characteristic (e.g. a noise-like characteristic; e.g. a Gaussian distribution). Optionally, the one or more neural networks used for the provision of the processed audio signal may be identical to the one or more neural networks used for the provision of the training result signal, wherein the training flow blocks may perform an affine processing that is inverse to an affine processing performed in the provision of the processed audio signal).

In general, it is to be noted that embodiments according to the invention may allow using structurally similar or even identical apparatuses comprising flow block and neural networks for training of the apparatus in the form neural network training, as well as audio signal enhancement. Between training and signal enhancement, affine transformations performed in the flow block may be inverted. Accordingly, for training, based on a clean speech signal, guided by a distorted version thereof, the neural network may be trained, so to adapt a processing using affine transformations in the flow block to obtain a training result audio signal, with specific characteristics. For applying signal enhancement for a real input audio signal, the affine transformations may be inverted, and the apparatus may be provided with a noise signal, e.g. having the specific characteristics, which may be shaped to an enhanced version of the real input audio signal, based on the real input audio signal, which is provided the neural network, in order to adapt the inverted affine transformation.

According to embodiments of the invention, the apparatus is configured to provide neural network parameters of the neural network for processing the noise signal, or the signal derived from the noise signal. The apparatus is configured to process a training audio signal or a processed version thereof, using the one or more flow blocks in order to obtain a training result signal, and the apparatus is configured to adapt a processing of the training audio signal or of the processed version thereof which is performed using the one or more flow blocks in dependence on a distorted version of the training audio signal and using the neural network. Furthermore, the apparatus is configured to determine neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution).

According to embodiments of the invention, the apparatus comprises an apparatus for providing neural network parameters, wherein the apparatus for providing neural network parameters is configured to provide neural network parameters of the neural network for processing the noise signal, or the signal derived from the noise signal. Furthermore, the apparatus for providing neural network parameters is configured to process a training audio signal or a processed version thereof, using one or more training flow blocks in order to obtain a training result signal, and the apparatus for providing neural network parameters is configured to adapt a processing of the training audio signal or the processed version thereof which is performed using the one or more flow blocks in dependence on a distorted version of the training audio signal and using the neural network. Furthermore, the apparatus is configured to determine neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution).

According to embodiments of the invention, the one or more flow blocks are configured to synthesize the processed audio (e.g. speech) signal on the basis of the noise signal under the guidance of the input audio (e.g. speech) signal.

According to embodiments of the invention, the one or more flow blocks are configured to synthesize the processed audio (e.g. speech) signal on the basis of the noise signal under the guidance of the input audio (e.g. speech) signal using the affine processing of sample values of the noise signal, or of a signal derived from the noise signal, and processing parameters (e.g. s,t) of the affine processing are determined on the basis of (e.g. time-domain) sample values of the input audio signal using the neural network.

According to embodiments of the invention, the apparatus is configured to perform a normalizing flow processing, in order to derive the processing audio signal from the noise signal (e.g. under the guidance of the input audio signal).

In the following embodiments, e.g. in particular according to the first, second and third aspect, as well as to further and/or additional aspects are disclosed. It is to be noted that features, functionalities and/or details can optionally be combined with any other aspect(s), features of other aspects can optionally be introduced into these aspects, both individually and taken in combination.

Embodiments according to the invention comprise an apparatus for providing neural network parameters (like e.g. edge weights (θ) of neural networks providing scaling factors (s) and shift values (t) on the basis of a portion (e.g. x1, e.g. x₁) of a clean audio signal, or a processed version thereof, and on the basis of a distorted audio signal (y) in a training mode, which may correspond to edge weights of neural networks providing scaling factors (s) and shift values (t) on the basis of a portion of a noise signal (z), or a processed version thereof, and on the basis of an input audio signal (y) in an inference mode) for an audio (e.g. speech) processing, wherein the apparatus is configured to (e.g. in multiple iterations) process a training audio (e.g. speech) signal (e.g. x), or a processed version thereof, using one or more flow blocks (e.g. using a flow block system, e.g. including affine coupling layers, e.g. including invertible convolution) in order to obtain a training result signal (which should, for example, be equal to a noise signal). Furthermore, the apparatus is configured to adapt a processing performed using the one or more flow blocks in dependence on a distorted version of the training audio signal (e.g. y) (e.g. the distorted audio signal, e.g. in dependence on a noisy speech signal y) and using a neural network (which optionally provides one or more processing parameters for the flow block, e.g. parameters of an affine processing, like a scaling factor and a shift value, on the basis of the distorted version of the training audio signal, and also in dependence on at least a part of the training audio signal, or a processed version thereof). In addition, the apparatus is configured to determine neural network parameters of the neural network or of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution). Moreover, the apparatus is configured to apply depth-wise separable convolutions to a representation of the distorted version of the training audio signal (which may, for example, take the place of the input audio signal in the training process), in order to derive a preprocessed representation of the distorted version of the training audio signal (wherein the preprocessed version of the distorted training audio signal may, for example, comprise, per sample of the distorted version of the training audio signal, a plurality of convolution values, wherein the convolution values are, for example, results of different convolutions of the representation of the distorted training audio signal with different convolution kernels). Furthermore, the neural network is configured to receive the preprocessed representation of the distorted version of the training audio signal (and optionally to provide one or more processing parameters for the flow block on the basis of the preprocessed representation of the distorted version of the training audio signal).

Embodiments according to the invention comprise an apparatus for providing neural network parameters (like e.g. edge weights (θ) of neural networks providing scaling factors (s) and shift values (t) on the basis of a portion (e.g. x1, e.g. x₁) of a clean audio signal, or a processed version thereof, and on the basis of a distorted audio signal (y) in a training mode, which may correspond to edge weights of neural networks providing scaling factors (s) and shift values (t) on the basis of a portion of a noise signal (z), or a processed version thereof, and on the basis of an input audio signal (y) in an inference mode) for an audio (e.g. speech) processing, wherein the apparatus is configured to (e.g. in multiple iterations) process a training audio (e.g. speech) signal (e.g. x), or a processed version thereof, using one or more flow blocks (e.g. using a flow block system, e.g. including affine coupling layers, e.g. including invertible convolution) in order to obtain a training result signal (which should be equal to a noise signal). Furthermore, the apparatus is configured to adapt a processing performed using the one or more flow blocks in dependence on a distorted version of the training audio signal (e.g. y) (e.g. the distorted audio signal, e.g. in dependence on a noisy speech signal y) and using a neural network (which optionally provides one or more processing parameters for the flow block, e.g. parameters of an affine processing, like a scaling factor and a shift value, on the basis of the distorted version of the training audio signal, and also in dependence on at least a part of the training audio signal, or a processed version thereof).

In addition, the apparatus is configured to determine neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution).

Moreover, the one or more flow blocks comprise at least one double coupling flow block (e.g. inside an affine coupling layer), wherein the (respective) double coupling flow block is configured to apply a first affine transform (transform coefficients of which may, for example, be determined using a neural network, e.g. using a subnetwork providing s1, e.g. s₁, and t1, e.g. t₁) to a first portion (e.g. x1, e.g. x₁) of input signals (e.g. x) to be modified by the (respective) double coupling flow block, and wherein the (respective) double coupling flow block is configured to apply a second affine transform (transform coefficients of which may, for example, be determined using a neural network, e.g. using a neural subnetwork providing s2, e.g. s₂, and t2, e.g. t₂) to a second portion (which may be different from the first portion) (e.g. x2, e.g. x₂) of the input signals (e.g. x) to be modified by the (respective) double coupling flow block.

Embodiments according to the invention comprise an apparatus for providing neural network parameters (like e.g. edge weights (θ) of neural networks providing scaling factors (s) and shift values (t) on the basis of a portion (e.g. x1, e.g. x₁) of a clean audio signal, or a processed version thereof, and on the basis of a distorted audio signal (y) in a training mode, which may correspond to edge weights of neural networks providing scaling factors (s) and shift values (t) on the basis of a portion of a noise signal (z), or a processed version thereof, and on the basis of an input audio signal (y) in an inference mode) for an audio (e.g. speech) processing, wherein the apparatus is configured to (e.g. in multiple iterations) process a training audio (e.g. speech) signal (e.g. x), or a processed version thereof, using one or more flow blocks (e.g. using a flow block system, e.g. including affine coupling layers, e.g. including invertible convolution) in order to obtain a training result signal (which should be equal to a noise signal).

Furthermore, the apparatus is configured to adapt a processing performed using the one or more flow blocks in dependence on a distorted version of the training audio signal (e.g. y) (e.g. the distorted audio signal, e.g. in dependence on a noisy speech signal y) and using a neural network (which provides one or more processing parameters for the flow block, e.g. parameters of an affine processing, like a scaling factor and a shift value, on the basis of the distorted version of the training audio signal, and also in dependence on at least a part of the training audio signal, or a processed version thereof).

Moreover, the apparatus is configured to determine neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution).

In addition, the apparatus is configured to obtain a preprocessed representation of the distorted version of the training audio signal (e.g. a “conditional signal representation”, wherein, for example, the distorted version of the training audio signal may serve as a conditional signal which is used to adapt the processing performed using the one or more flow blocks) using a filterbank comprising time resolutions and/or frequency resolutions which are adapted to time resolutions and/or frequency resolutions of a human auditory system (e.g. using an All-Pole-Gammatone Filterbank) (which may, for example, comprise a set of bandpass filters, wherein, for example, the bandpass filters may be infinite-impulse-response bandpass filters) (wherein, for example, time/resolutions and/or frequency resolutions of individual filters of the filterbank may be adapted to time resolutions and/or to frequency resolutions of the human auditory system).

Furthermore, the neural network is configured to receive the preprocessed representation of the distorted version of the training audio signal (e.g. as input values) (and to provide one or more processing parameters for the flow block on the basis of the preprocessed representation of the distorted version of the training audio signal).

According to embodiments of the invention, the apparatus is configured to evaluate a cost function (e.g. a loss function) in dependence on characteristics of the obtained training result signal (e.g. in dependence on a distribution, e.g. a Gaussian function distribution, of the obtained noise signal and a variance 52 of the obtained noise signal) (and optionally processing parameters, e.g. s, of the flow blocks, which may, for example, be dependent on input signals of respective flow blocks). Furthermore, the apparatus is configured to determine neural network parameters to reduce or minimize a cost defined by the cost function.

According to embodiments of the invention, the training audio signal (e.g. x) and/or the distorted version of the training audio signal (e.g. y) is represented by a set of time domain audio samples (e.g. noisy time domain audio, e.g. speech, samples, e.g. time domain speech utterances) (wherein, for example, the time domain audio samples of the input audio signal, or time domain audio samples derived therefrom, are optionally input into the neural network)(wherein, for example, the time domain audio samples of the training audio signal, or the time domain audio samples derived therefrom, are processed in the neural network in the form of a time domain representation, without applying a transformation to transform domain representation (e.g. a spectral domain representation)).

According to embodiments of the invention, a neural network associated with a given flow block (a given stage of an affine processing) of the one or more flow blocks is configured to determine one or more processing parameters (e.g. s, t) for the given flow block in dependence on the training audio signal (e.g. x), or a signal derived from the training audio signal, and in dependence on the distorted version of the training audio signal (e.g. y).

According to embodiments of the invention, a neural network associated with a given flow block (e.g. a given stage of an affine processing) is configured to provide one or more parameters (e.g. s, t) of an affine processing (e.g. in an affine coupling layer), which is applied to the training audio signal (e.g. x), or to a processed version of the training audio signal, or to a portion of the training audio signal, or to a portion of a processed version of the training audio signal during the processing.

According to embodiments of the invention, a neural network associated with the given flow block (the given stage of the affine processing) is configured to determine one or more parameters (s, t) of the affine processing, in dependence on a first part (x1, e.g. x₁) of a flow block input signal (x) or in dependence on a first part of a pre-processed flow block input signal (e.g. x′) and in dependence on the distorted version of the training audio signal (e.g. y). Furthermore, an affine processing associated with the given flow block (e.g. the given stage of the affine processing) is configured to apply the determined parameters to a second part (x2, e.g. x₂) of the flow block input signal (x) or to a second part of the pre-processed flow block input signal (x′), to obtain an affinely processed signal(x2\hat{ }, e.g. \hat{x}₂). In addition, the first part (x1, e.g. x₁) of the flow block input signal (x) or of the pre-processed flow block input signal (x′) (which is not modified by the affine processing) and the affinely processed signal (x2\hat{ }, e.g. \hat{x}₂) form (e.g. constitute) a flow block output signal (x_{new}) (e.g. a stage output signal) of the given flow block (the given stage of the affine processing).

According to embodiments of the invention, the apparatus is configured to apply an invertible convolution (e.g. a 1×1 invertible convolution) to the flow block input signal (x) (the stage input signal) of the given flow block (e.g. the given stage of the affine processing) (which may, for example, be the training audio signal or a signal derived from the training audio signal for a first stage, and which may, for example, be an output signal of a previous stage, for other subsequent stages following the first stage), to obtain the pre-processed flow block input signal (x′) (a pre-processed version of the flow block input signal, e.g. a convolved version of the flow block input signal).

According to embodiments of the invention, the apparatus is configured to apply a nonlinear input companding (e.g. a nonlinear compression, e.g. a μ-law transformation) to the training audio signal (x) prior to processing the training audio signal (x).

According to embodiments of the invention, the apparatus is configured to apply a μ-law transformation (e.g. a μ-law function) as the nonlinear input companding to the training audio signal (x).

According to embodiments of the invention, the apparatus is configured to apply a transformation according to

$$g ( x ) = sgn ( x ) \cdot \frac{ln ( 1 + μ \vert x \vert )}{ln ( 1 + μ )} ;$$

to the training audio signal (x), wherein sgn( ) is a sign function and wherein p is a parameter defining a level of compression.

According to embodiments of the invention, the one or more flow blocks are configured to convert the training audio signal into the training result signal (which optionally approximates a noise signal, or which comprises a noise-like characteristic).

According to embodiments of the invention, the one or more flow blocks are adjusted (e.g. by an appropriate determination of the neural network parameters) to convert the training audio signal into the training result signal under the guidance of the distorted version of the training audio signal (e.g. speech) signal, using the affine processing of sample values of the training audio signal, or of a signal derived from the training audio signal. In addition, processing parameters (e.g. s,t) of the affine processing are determined on the basis of (time-domain) sample values of the distorted version of the training audio signal using the neural network.

According to embodiments of the invention, the apparatus is configured to perform a normalizing flow processing, in order to derive the training result signal from the training audio signal (e.g. under the guidance of the distorted version of the training audio signal).

Embodiments according to the invention comprise a method for providing a processed audio (e.g. speech) signal (e.g. an enhanced audio signal) (e.g. an enhanced speech signal or an enhanced general audio signal; e.g. x\hat{ }) on the basis of an input audio (e.g. speech) signal (e.g. a distorted audio signal, e.g. a noisy speech signal y, e.g. a clean signal x extracted from the noisy speech signal y, y=x+n (noise, e.g. noisy background)). The method comprises processing (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }). Furthermore, the method comprises adapting a processing performed using the one or more flow blocks in dependence on the input audio signal (e.g. the distorted audio signal, e.g. in dependence on a noisy speech signal y; e.g. in dependence on noisy time domain speech samples) and using a neural network (which provides one or more processing parameters for the flow block, e.g. parameters of an affine processing, like a scaling factor and a shift value, on the basis of the distorted audio signal, and also in dependence on at least a part of the noise signal, or a processed version thereof). In addition, the method comprises applying depth-wise separable convolutions to a representation of the input audio signal, in order to derive a preprocessed representation of the input audio signal (wherein the preprocessed version of the input audio signal may, for example, comprise, per sample of the input audio signal, a plurality of convolution values, wherein the convolution values are, for example, results of different convolutions of the representation of the input audio signal with different convolution kernels). Furthermore, the neural network receives the preprocessed representation of the input audio signal (and to provide one or more processing parameters for the flow block on the basis of the preprocessed representation of the input audio signal).

Embodiments according to the invention comprise a method for providing a processed audio (e.g. speech) signal (e.g. an enhanced audio signal) (e.g. an enhanced speech signal or an enhanced general audio signal; e.g. x\hat{ }) on the basis of an input audio (e.g. speech) signal (e.g. a distorted audio signal, e.g. a noisy speech signal y, e.g. a clean signal x extracted from the noisy speech signal y, y=x+n (noise, e.g. noisy background)). The method comprises processing (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }), and adapting a processing performed using the one or more flow blocks in dependence on the input audio signal (e.g. the distorted audio signal, e.g. in dependence on a noisy speech signal y; e.g. in dependence on noisy time domain speech samples) and using a neural network (which provides one or more processing parameters for the flow block, e.g. parameters of an affine processing, like a scaling factor and a shift value, on the basis of the distorted audio signal, and also in dependence on at least a part of the noise signal, or a processed version thereof).

Furthermore, the one or more flow blocks comprise at least one double coupling flow block (e.g. inside an affine coupling layer); wherein the (respective) double coupling flow block applies a first affine transform (transform coefficients of which may, for example, be determined using a neural network, e.g. using a subnetwork providing s1 and t1) to a first portion (e.g. x1) of input signals (e.g. x) to be modified by the (respective) double coupling flow block, and wherein the (respective) double coupling flow block applies a second affine transform (transform coefficients of which may, for example, be determined using a neural network, e.g. using a neural subnetwork providing s2 and t2) to a second portion (which is different from the first portion) (e.g. x2) of the input signals (e.g. x) to be modified by the (respective) double coupling flow block.

Embodiments according to the invention comprise a method for providing a processed audio (e.g. speech) signal (e.g. an enhanced audio signal) (e.g. an enhanced speech signal or an enhanced general audio signal; e.g. x\hat{ }) on the basis of an input audio (e.g. speech) signal (e.g. a distorted audio signal, e.g. a noisy speech signal y, e.g. a clean signal x extracted from the noisy speech signal y, y=x+n (noise, e.g. noisy background)), wherein the method comprises processing (e.g. using an affine scaling, or using a sequence of affine scaling operations) a noise signal (e.g. z), or a signal derived from the noise signal, using one or more flow blocks (e.g. using a flow block system, e.g. including affine coupling layers, e.g. including invertible convolution), in order to obtain the processed (e.g. enhanced) audio signal (e.g. x\hat{ }). The method comprises adapting a processing performed using the one or more flow blocks in dependence on the input audio signal (e.g. the distorted audio signal, e.g. in dependence on a noisy speech signal y; e.g. in dependence on noisy time domain speech samples) and using a neural network (which provides one or more processing parameters for the flow block, e.g. parameters of an affine processing, like a scaling factor and a shift value, on the basis of the distorted audio signal, and also in dependence on at least a part of the noise signal, or a processed version thereof). Furthermore, the method comprises obtaining a preprocessed representation of the input audio signal (e.g. a “conditional signal representation”, wherein, for example, the input audio signal may serve as a conditional signal which is used to adapt the processing performed using the one or more flow blocks) using a filterbank comprising time resolutions and/or frequency resolutions which are adapted to time resolutions and/or frequency resolutions of a human auditory system (e.g. using an All-Pole-Gammatone Filterbank) (which may, for example, comprise a set of bandpass filters, wherein, for example, the bandpass filters may be infinite-impulse-response bandpass filters) (wherein, for example, time/resolutions and/or frequency resolutions of individual filters of the filterbank may be adapted to time resolutions and/or to frequency resolutions of the human auditory system). In addition, the neural network receives the preprocessed representation of the input audio signal (e.g. as input values) (and to provide one or more processing parameters for the flow block on the basis of the preprocessed representation of the input audio signal).

Embodiments comprise a method for providing neural network parameters (like e.g. edge weights (θ) of neural networks providing scaling factors (s) and shift values (t) on the basis of a portion (e.g. x1) of a clean audio signal, or a processed version thereof, and on the basis of a distorted audio signal (y) in a training mode, which may correspond to edge weights of neural networks providing scaling factors (s) and shift values (t) on the basis of a portion of a noise signal (z), or a processed version thereof, and on the basis of an input audio signal (y) in an inference mode) for an audio (e.g. speech) processing, wherein the method comprises (e.g. in multiple iterations) processing a training audio (e.g. speech) signal (e.g. x), or a processed version thereof, using one or more flow blocks (e.g. using a flow block system, e.g. including affine coupling layers, e.g. including invertible convolution) in order to obtain a training result signal (which should be equal to a noise signal). In addition, the method comprises adapting a processing performed using the one or more flow blocks in dependence on a distorted version of the training audio signal (e.g. y) (e.g. the distorted audio signal, e.g. in dependence on a noisy speech signal y) and using a neural network (which provides one or more processing parameters for the flow block, e.g. parameters of an affine processing, like a scaling factor and a shift value, on the basis of the distorted version of the training audio signal, and also in dependence on at least a part of the training audio signal, or a processed version thereof).

Furthermore, the method comprises determining neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution)

Moreover, the method comprises applying depth-wise separable convolutions to a representation of the distorted version of the training audio signal (which may, for example, take the place of the input audio signal in the training process), in order to derive a preprocessed representation of the distorted version of the training audio signal (wherein the preprocessed version of the distorted training audio signal may, for example, comprise, per sample of the distorted version of the training audio signal, a plurality of convolution values, wherein the convolution values are, for example, results of different convolutions of the representation of the distorted training audio signal with different convolution kernels).

Furthermore, the neural network receives the preprocessed representation of the distorted version of the training audio signal (and to provide one or more processing parameters for the flow block on the basis of the preprocessed representation of the distorted version of the training audio signal).

Embodiments comprise a method for providing neural network parameters (like e.g. edge weights (θ) of neural networks providing scaling factors (s) and shift values (t) on the basis of a portion (e.g. x1) of a clean audio signal, or a processed version thereof, and on the basis of a distorted audio signal (y) in a training mode, which may correspond to edge weights of neural networks providing scaling factors (s) and shift values (t) on the basis of a portion of a noise signal (z), or a processed version thereof, and on the basis of an input audio signal (y) in an inference mode) for an audio (e.g. speech) processing, wherein the method comprises (e.g. in multiple iterations) processing a training audio (e.g. speech) signal (e.g. x), or a processed version thereof, using one or more flow blocks (e.g. using a flow block system, e.g. including affine coupling layers, e.g. including invertible convolution) in order to obtain a training result signal (which should be equal to a noise signal).

Furthermore, the method comprises adapting a processing performed using the one or more flow blocks in dependence on a distorted version of the training audio signal (e.g. y) (e.g. the distorted audio signal, e.g. in dependence on a noisy speech signal y) and using a neural network (which provides one or more processing parameters for the flow block, e.g. parameters of an affine processing, like a scaling factor and a shift value, on the basis of the distorted version of the training audio signal, and also in dependence on at least a part of the training audio signal, or a processed version thereof).

In addition, the method comprises determining neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution).

Furthermore, the one or more flow blocks comprise at least one double coupling flow block (e.g. inside an affine coupling layer); wherein the (respective) double coupling flow block applies a first affine transform (transform coefficients of which may, for example, be determined using a neural network, e.g. using a subnetwork providing s1 and t1) to a first portion (e.g. x1) of input signals (e.g. x) to be modified by the (respective) double coupling flow block, and wherein the (respective) double coupling flow block applies a second affine transform (transform coefficients of which may, for example, be determined using a neural network, e.g. using a neural subnetwork providing s2 and t2) to a second portion (which is different from the first portion) (e.g. x2) of the input signals (e.g. x) to be modified by the (respective) double coupling flow block.

Embodiments comprise a method for providing neural network parameters (like e.g. edge weights (θ) of neural networks providing scaling factors (s) and shift values (t) on the basis of a portion (e.g. x1) of a clean audio signal, or a processed version thereof, and on the basis of a distorted audio signal (y) in a training mode, which may correspond to edge weights of neural networks providing scaling factors (s) and shift values (t) on the basis of a portion of a noise signal (z), or a processed version thereof, and on the basis of an input audio signal (y) in an inference mode) for an audio (e.g. speech) processing, wherein the method comprises (e.g. in multiple iterations) processing a training audio (e.g. speech) signal (e.g. x), or a processed version thereof, using one or more flow blocks (e.g. using a flow block system, e.g. including affine coupling layers, e.g. including invertible convolution) in order to obtain a training result signal (which should be equal to a noise signal).

In addition, the method comprises adapting a processing performed using the one or more flow blocks in dependence on a distorted version of the training audio signal (e.g. y) (e.g. the distorted audio signal, e.g. in dependence on a noisy speech signal y) and using a neural network (which optionally provides one or more processing parameters for the flow block, e.g. parameters of an affine processing, like a scaling factor and a shift value, on the basis of the distorted version of the training audio signal, and also in dependence on at least a part of the training audio signal, or a processed version thereof).

Furthermore, the method comprises determining neural network parameters of the neural networks (e.g. using an evaluation of a cost function, e.g. an optimization function; e.g. using a parameter optimization procedure), such that a characteristic (e.g. a probability distribution) of the training result audio signal approximates or comprises a predetermined characteristic (e.g. a noise-like characteristic; e.g. a Gaussian distribution).

In addition, the method comprises obtaining a preprocessed representation of the distorted version of the training audio signal (e.g. a “conditional signal representation”, wherein, for example, the distorted version of the training audio signal may serve as a conditional signal which is used to adapt the processing performed using the one or more flow blocks) using a filterbank comprising time resolutions and/or frequency resolutions which are adapted to time resolutions and/or frequency resolutions of a human auditory system (e.g. using an All-Pole-Gammatone Filterbank) (which may, for example, comprise a set of bandpass filters, wherein, for example, the bandpass filters may be infinite-impulse-response bandpass filters) (wherein, for example, time/resolutions and/or frequency resolutions of individual filters of the filterbank may be adapted to time resolutions and/or to frequency resolutions of the human auditory system).

Furthermore, the neural network receives the preprocessed representation of the distorted version of the training audio signal (e.g. as input values) (and to provide one or more processing parameters for the flow block on the basis of the preprocessed representation of the distorted version of the training audio signal).

Further embodiments comprise a computer program having a program code for performing any of the methods as disclosed herein, when running on a computer.

### BRIEF DESCRIPTION OF THE DRAWINGS

Embodiments of the present invention will be detailed subsequently referring to the appended drawings, in which:

FIG. 1 shows a block diagram of a method for providing an electrical connection according to an embodiment of the present invention;

FIG. 2 shows a schematic view of an apparatus according to embodiments of the first aspect of the invention with an optional All-Pole Gammatone-Filterbank;

FIG. 3 shows a schematic view of an apparatus for providing a processed audio signal according to embodiments of the second aspect of the invention;

FIG. 4 shows a comparison between an application of conventional convolutions and depth-wise separable convolutions according to embodiments of the second aspect of the invention;

FIG. 5 shows a schematic view of an apparatus according to embodiments of the second aspect of the invention with an optional double coupling flow block;

FIG. 6 shows a schematic view of an apparatus for providing a processed audio signal according to embodiments of the third aspect of the invention;

FIG. 7 shows a schematic view of an apparatus according to embodiments of the third aspect of the invention with additional, optional features;

FIG. 8 shows a schematic view of an apparatus for providing neural network parameters for an audio processing according to embodiments of the invention;

FIG. 9 shows a schematic block diagram of a method for providing a processed audio signal on the basis of an input audio signal, according to embodiments of the second aspect of the invention;

FIG. 10 shows a schematic block diagram of a method for providing a processed audio signal on the basis of an input audio signal, according to embodiments of the third aspect of the invention;

FIG. 11 shows a schematic block diagram of a method for providing a processed audio signal on the basis of an input audio signal, according to embodiments of the first aspect of the invention;

FIG. 12 shows a schematic block diagram of a method for providing neural network parameters for an audio processing, according to embodiments of the second aspect of the invention;

FIG. 13 shows a schematic block diagram of a method for providing neural network parameters for an audio processing, according to embodiments of the third aspect of the invention;

FIG. 14 shows a schematic block diagram of a method for providing neural network parameters for an audio processing, according to embodiments of the first aspect of the invention;

FIG. 15 shows a schematic view of a double coupling scheme according to an embodiment of the invention;

FIG. 16 shows a schematic plot of an example of magnitude of the filter response of the All-Pole Gammatone filterbank (APG) according to embodiments of the invention;

FIG. 17a shows a table showing examples for experimental results obtained from the VoiceBank-DEMAND test set according to embodiments of the invention;

FIG. 17b shows a schematic plot of listening test results;

FIG. 18 shows a schematic visualization of a basic principle for a training process according to embodiments of the invention;

FIG. 19 shows a schematic visualization of a basic principle for a training process together with an enhancement process according to embodiments of the invention;

FIG. 20 shows a schematic visualization of an improvement, for example a first improvement, according to embodiments of the invention;

FIG. 21 shows a schematic visualization of a single coupling scheme according to embodiments of the invention;

FIG. 22 shows a schematic visualization of a double coupling scheme according to embodiments of the invention;

FIG. 23 shows a schematic visualization of an improved principle for a training process together with an enhancement process according to embodiments of the invention; and

FIG. 24 shows another schematic plot of listening test results.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more throughout explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

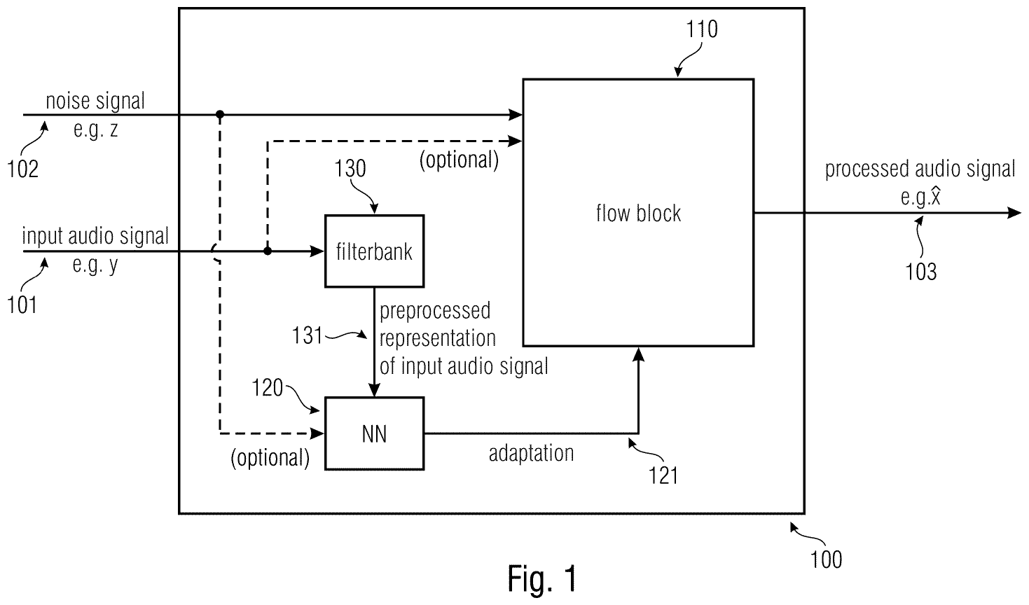

FIG. 1 shows a schematic view of an apparatus for providing a processed audio signal according to embodiments of the first aspect of the invention. FIG. 1 shows an apparatus 100 which is provided with an input audio signal 101, e.g. y, and a noise signal 102, e.g. z. It is to be noted that the noise signal 102 may, for example, be a signal derived from the noise signal. Apparatus 100 is configured to provide the processed audio signal 103, e.g. \hat{x}, which may optionally be an enhanced signal, e.g. an enhanced audio signal, for example, an enhanced version of the input audio signal 101.

Apparatus 100 comprises a flow block 110, a neural network 120 and a filterbank 130. Flow block 110 is provided with the noise signal 102. Using the flow block 110, the apparatus 100 is configured to provide the processed audio signal 103 based on a processing of said noise signal 102 (or a respective signal derived from the noise signal). Therefore, the flow block 110 may optionally comprise affine coupling layers, and/or invertible convolutions.

Furthermore, the apparatus 100 is configured to adapt a processing performed using the flow block 110 in dependence on the input audio signal 101 and using the neural network 120 (and optionally in dependence on the noise signal or a portion thereof). As shown, optionally, the neural network 120 may be configured to provide an information 121 for adapting a processing performed using flow block 110. Hence, apparatus 100 may adapt the processing in dependence on the input audio signal via the neural network 120. Optionally, as shown the input audio signal 101 may be provided directly to the flow block 110, in order to adapt the processing, e.g. in order to adapt affine transformations performed in flow block 110.

Therefore, the neural network 120 is configured to receive a preprocessed representation 131 of the input audio signal. As an example, based on the preprocessed representation 131, the neural network may provide one or more parameters used for the processing of the noise signal 102 in the flow block 110 via information 121 to said flow block 110.

In addition, the apparatus 100 is configured to obtain the preprocessed representation 131 of the input audio signal using the filterbank 130. The filterbank 130 comprises time resolutions and/or frequency resolutions which are adapted to time resolutions and/or frequency resolutions of a human auditory system.

Simplified, an apparatus 100 may be provided with an input signal 101, e.g. y=x+n which is distorted and/or noisy, hence comprising a clean speech portion x and a distortion thereof, and/or a noise portion, e.g. n. Furthermore, apparatus 100 may be provided with a noise signal 102, e.g. z, for example, sampled from a Gaussian distribution, e.g. with zero mean and unit variance. Apparatus 100 may shape the noise signal z using the flow block 110 (or using a chain of flow blocks) in order to provide an enhanced version of the input signal 101 as the processed audio signal, e.g. R. Therefore, the flow block 110 may, for example, comprise affine coupling layers, and/or may be configured to perform affine transformations, e.g. using invertible convolutions. In order to control the processing of the noise signal 102 using the flow block 110, the input signal 101 may be processed by the neural network 120 in order to provide parameters for performing said processing e.g. in the form of affine transformations. Thus, the neural network 120 may be used to provide parameters for such transformations, e.g. using adaptation information 121. The inventors recognized that an efficiency and robustness of such a processing may be improved by implementing a filterbank 130 having time resolutions and/or frequency resolutions which are adapted to time resolutions and/or frequency resolutions of a human auditory system as a preprocessing unit for the neural network. Hence, improved parameters for the flow block processing may be provided increasing the quality of the processed, e.g. enhanced, signal 103.

As shown in FIG. 1, optionally, the neural network 120 may be provided with the noise signal 102 (or a signal derived thereof), for the provision of the adaptation information 121.

As an optional feature, time resolutions of the filterbank 130 and frequency resolutions of the filterbank 130 approximate time resolutions and frequency resolutions of the human auditory system. As an example, the filterbank 130 may be designed to mimic human hearing characteristics or to represent human hearing characteristics and/or to take into account human hearing characteristics, in order to improve the preprocessing of the input audio signal 101 for the neural network 120.

As another optional feature, the filterbank 130 may comprise one or more filters and said filters or some of said filters may comprise or may be infinite impulse response filters.

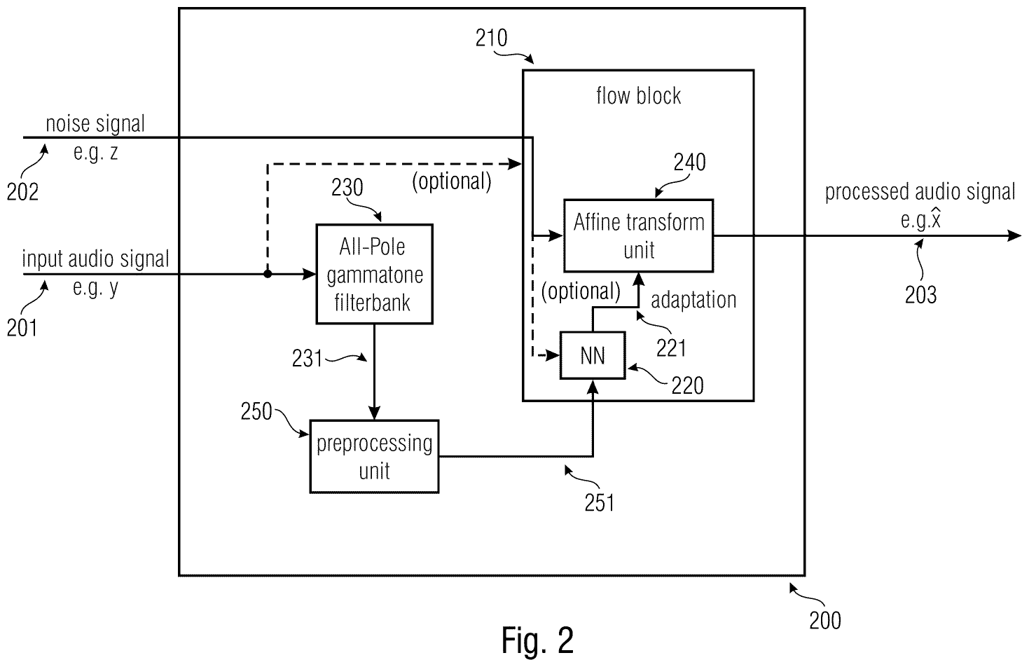

FIG. 2 shows a schematic view of an apparatus according to embodiments of the first aspect of the invention with an optional All-Pole Gammatone-Filterbank. FIG. 2 shows apparatus 200 comprising a flow block 210, a neural network 220 and a filterbank 230, having respective functionalities as explained in the context of FIG. 1 at least with regard to the non-optional features and functionalities. However, it is to be noted that apparatus 200 may comprise optional features and functionalities as disclosed in the context of FIG. 1.

Apparatus 200 is provided with a noise signal 202 (which is optionally a signal derived from the noise signal) and with an input audio signal 201 and provides a processed audio signal 203, as explained in the context of FIG. 1.

As an optional feature, flow block 210 comprises the neural network 220. Furthermore, as an optional feature, the processed audio signal 203 is provided using an optional affine transform unit 240, which is part of the flow block 210. As shown, the neural network optionally provides an adaptation information 221 to the affine transform unit 240, e.g. parameters for a processing of the noise signal 202. The affine transform unit 240 may optionally comprise affine coupling layers and/or invertible convolution, for providing the processed audio signal 203 based on the noise signal 202 and optionally the input audios signal 201.

As shown in FIG. 2, optionally, the neural network 220 may be provided with the noise signal 202 (or a signal derived thereof), for the provision of the adaptation information 221.

Furthermore, as another optional feature, apparatus 200 comprises a preprocessing unit 250 between filterbank 230 and neural network 220.

As another optional feature, the filterbank 230 is an All-Pole Gammatone Filterbank, e.g. a complex All-Pole-Gammatone-Filterbank. Optionally, the filterbank 230 may be a specifically designed complex-valued all-pole gammatone filterbank, e.g. APG, e.g. APGFB.

It is to be noted that a filterbank 230 being an All-Pole Gammatone Filterbank may be used with or without the optional preprocessing unit, and as well in a configuration wherein the neural network 220 is not part of the flow block 210.

Optionally, design of the filterbank 230 may be motivated by human hearing, such that the center frequencies of optional IIR-filters of the filterbank 230 may optionally have constant distances on the Bark scale, e.g., with increasing bandwidth at increasing frequencies, for example, proportional to the Bark bandwidths. To compensate for possible time differences in the filter outputs a lookahead for each filter may, for example, be implemented depending on its group delay at center frequency, for example, scaled with a common factor for all bands. For example, only the magnitude of the filterbank 230 outcome may, optionally, processed further with the network 220.

As an optional feature, the All-Pole-Gammatone Filterbank 230 is configured to obtain a plurality of channel signals associated with a plurality of frequency bands wherein widths of the frequency bands increase monotonically with increasing center frequencies of the respective frequency bands, and/or wherein widths of the frequency bands are adapted in accordance with a psychoacoustic model and/or wherein center frequencies of the frequency bands are adapted in accordance with a psychoacoustic model. As an optional feature, input audio signal 201 may comprise said channel signals associated with the plurality of frequency bands.

Furthermore, the All-Pole-Gamatone Filterbank 230 comprises, as an optional feature, a plurality of filters wherein center frequencies of the filters comprise constant distances on a Bark scale with increasing bandwidth at increasing frequencies.

Furthermore, as an optional feature, the All-Pole-Gammatone Filterbank 230 is configured to at least partially compensate different group delays between different filters.

Optionally, a transfer function of the All-Pole-Gammatone Filterbank does not comprise any finite zero point. Furthermore, as another optional feature, imaginary parts of poles of a transfer function of the All-Pole-Gammatone Filterbank 230 all comprise a same sign. Moreover, optionally, the All-Pole-Gammatone Filterbank 230 is a Complex All-Pole-Gammatone-Filterbank. As another optional feature, the or more poles of a transfer function of the All-Pole-Gammatone Filterbank 230 coincide.

As another optional feature, the apparatus 100 is configured to obtain the preprocessed representation 131 of the input audio signal on the basis of magnitudes of output signals of the All-Pole-Gammatone-Filterbank. In this case, the apparatus 100 is configured to neglect phase information of the output signals of the All-Pole-Gammatone-Filterbank.

As another optional feature, the All-Pole-Gammatone-Filterbank is configured to provide between 20 and 100 output signals.

As another optional feature, the apparatus 200 is configured to apply a plurality of convolutions, e.g. using preprocessing unit 250, to a set of output values of the All-Pole-Gammatone Filterbank 230 or to a set of magnitude values derived from output values of the All-Pole-Gammatone Filterbank 230, in order to obtain input values 251 of the neural network.

As shown in FIG. 2, an output signal 231 of the All-Pole-Gammatone Filterbank 230 is provided to the optional preprocessing unit 250, which is configured to apply the convolutions the output and/or magnitude values. Based thereon, input values 251 for the neural network 220 are provided.

As another optional feature, the apparatus 200 is configured to apply depth-wise separable convolutions to the set of output values of the All-Pole-Gammatone Filterbank 230 or to the set of magnitude values derived from output values of the All-Pole-Gammatone Filterbank 230 in order to obtain input values of the neural network. Hence, processing in the preprocessing unit 250 comprises, as an optional feature, application of depth-wise separable convolutions.

Accordingly, the preprocessed representation of the input audio signal 131, as explained in FIG. 1 may comprise the input values 251 or may even be said input values.

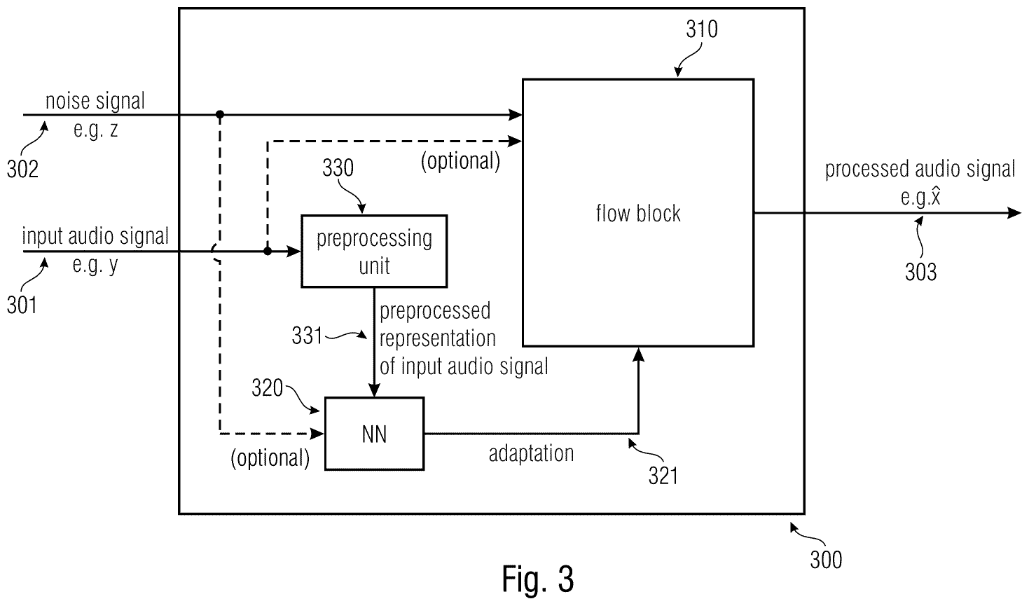

FIG. 3 shows a schematic view of an apparatus for providing a processed audio signal according to embodiments of the second aspect of the invention. FIG. 3 shows an apparatus 300 which is provided with an input audio signal 301, e.g. y, and a noise signal 302, e.g. z. It is to be noted that the noise signal 302 may, for example, be a signal derived from the noise signal. Apparatus 300 is configured to provide the processed audio signal 303, e.g. \hat{x}, which may optionally be an enhanced signal, e.g. an enhanced audio signal, for example, an enhanced version of the input audio signal 301.

Apparatus 300 comprises a flow block 310, a neural network 320 and a preprocessing unit 330. Flow block 310 is provided with the noise signal 302. Using the flow block 310, the apparatus 300 is configured to provide the processed audio signal 303 based on a processing of said noise signal 302 (or a respective signal derived from the noise signal).

Furthermore, the apparatus 300 is configured to adapt a processing performed using the flow block 310 in dependence on the input audio signal 301 and using the neural network 320. As shown, optionally, the neural network 320 may be configured to provide an information 321 for adapting a processing performed using flow block 310. Hence, apparatus 300 may adapt the processing in dependence on the input audio signal via the neural network 320, and/or, as optionally, shown the input audios signal 301 may be provided directly to the flow block 310, in order to adapt the processing, e.g. in order to adapt affine transformations performed in flow block 310.

Therefore, the neural network 320 is configured to receive a preprocessed representation 331 of the input audio signal. As an example, based on the preprocessed representation 331, the neural network may provide one or more parameters used for the processing of the noise signal 302 in the flow block 310 via information 321 to said flow block 310.

In addition, the apparatus 300 is configured to apply depth-wise separable convolutions to a representation of the input audio signal, in order to derive the preprocessed representation 331 of the input audio signal. The application of said convolutions is performed in the preprocessing unit.

Using depth-wise separable convolutions a reduction with regard to parameters, e.g. for performing an affine transformation, and/or with regard to complexity may be achieved.

As shown in FIG. 3, optionally, the neural network 320 may be provided with the noise signal 302 (or a signal derived thereof), for the provision of the adaptation information 321.

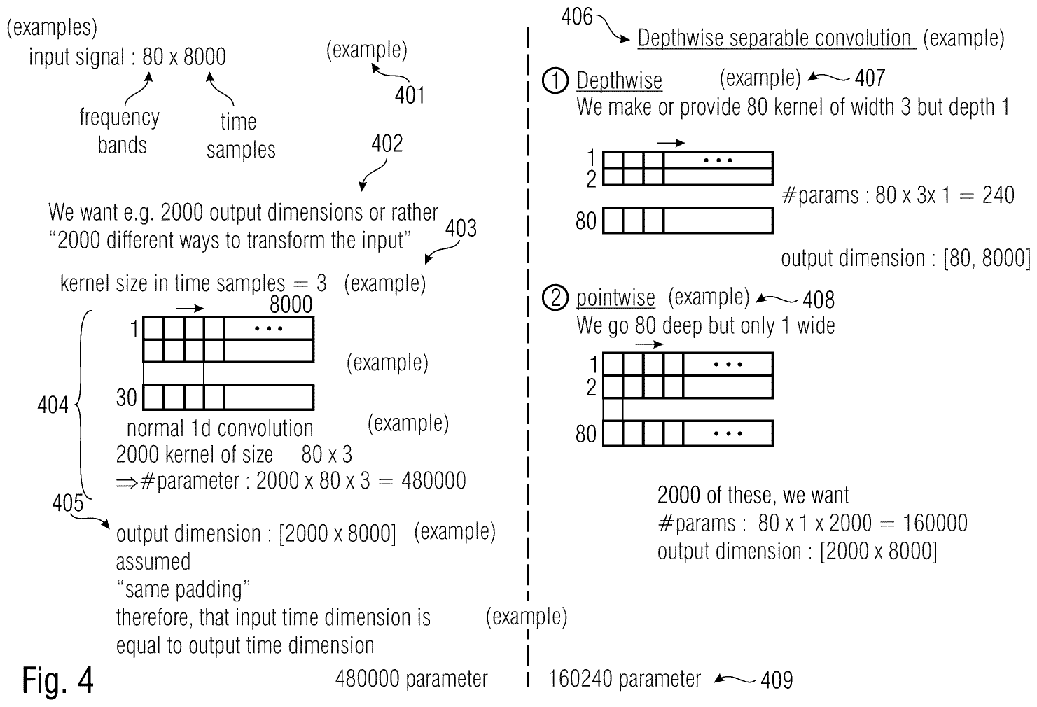

As an example, reference is made to FIG. 4. FIG. 4 shows a comparison between an application of conventional convolutions and depth-wise separable convolutions according to embodiments of the second aspect of the invention.

As an example, an input signal, e.g. signal 101, 201, and/or 301 may comprise 80 frequency bands and 8000 time samples (401). Based thereon, it may be desired to obtain 2000 output dimensions or rather, or in other words “2000 different ways to transform the input”.

As an example, a kernel size in time samples of 3 is assumed (403). Hence, applying a conventional or normal 1d convolution to the 80 frequency bands with 8000 time samples may yield 2000 kernels of size 80×3 and consequently 2000×80×3=480000 parameters (404). As optionally shown, output dimension may then be [2000×8000], for example assumed “same padding” or “time padding”, e.g. so that input time dimension is equal to output time dimension. (405).

In comparison, an example, of a depth-wise separable convolution is shown (406), comprising a depth-wise (407) and a pointwise (408) convolution. In accord with the depth-wise convolution (407) (e.g. as a first step or first convolution), as an example, 80 kernel of width 3 but depth 1 may be made or provided. Hence, as shown, a number of parameters may be 80×3×1=240 with output dimensions [80, 8000]. In accord with the pointwise convolution (e.g. as a second step or second convolution), simply speaking, the convolution may comprise a depth of 80, but only a width of 1.

As defined earlier (402), the output dimension should be 2000. Therefore, the number of parameters is 80×1×2000=160000, yielding an output dimension of [2000×8000].

Adding up the number of parameters of the depth-wise (407) and a pointwise (408) convolution yields a total of 160240 parameters in comparison to the 480000 parameters according to the conventional approach (409).

In other words, based on the depth-wise separable convolution, based on a same input signal and yielding a same output dimension, a number of parameters for a respective convolution or succession of convolutions may be reduced significantly.

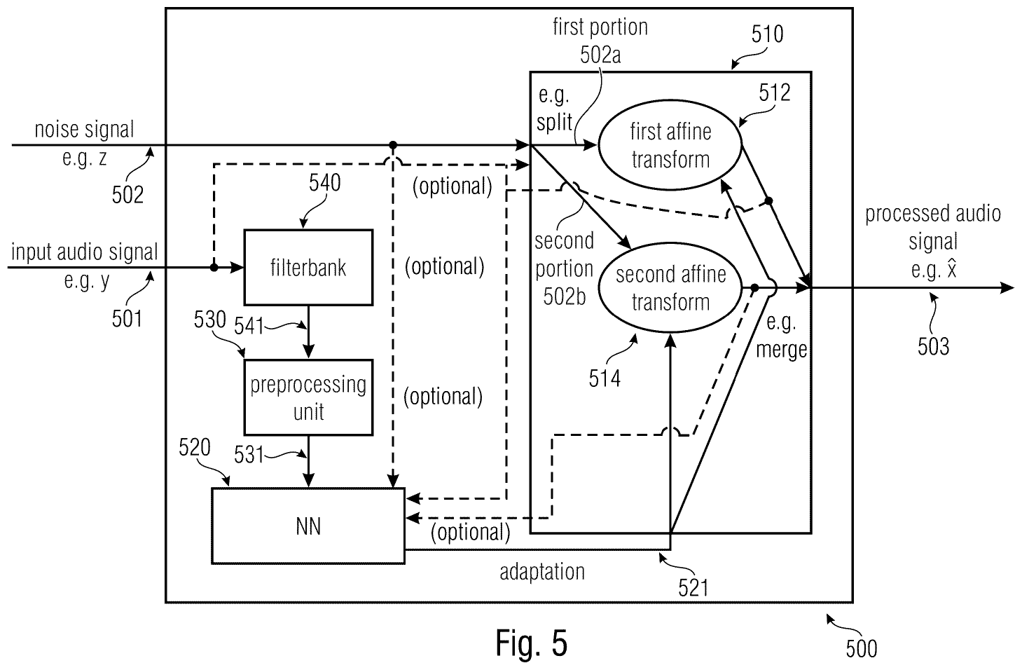

FIG. 5 shows a schematic view of an apparatus according to embodiments of the second aspect of the invention with an optional double coupling flow block. FIG. 5 shows apparatus 500 comprising a flow block 510, a neural network 520 and a preprocessing unit 530, having respective functionalities as explained in the context of FIG. 3 at least with regard to the non-optional features and functionalities. However, it is to be noted that apparatus 500 may comprise optional features and functionalities as disclosed in the context of FIGS. 1, 2, 3 and 4.

Apparatus 500 is provided with a noise signal 502 (which is optionally a signal derived from the noise signal) and with an input audio signal 501 and provides a processed audio signal 503. As shown in FIG. 5, optionally, the neural network 520 may be provided with the noise signal 502 (or a signal derived thereof), for the provision of the adaptation information 521.

As such an optional feature, apparatus 500 comprises a filterbank 540. As an optional feature, the apparatus 500 is configured to obtain a preprocessed representation of the input audio signal 501 using the filterbank 540 comprising time resolutions and/or frequency resolutions which are adapted to time resolutions and/or frequency resolutions of a human auditory. As shown, optionally, the neural network is configured to receive the preprocessed representation of the input audio signal. The neural network 520 may be configured to be provided directly with the preprocessed representation of the filterbank 540, however, as shown in the example of FIG. 5, the output of the filterbank 540 may be further processed, e.g. by the preprocessing unit 531 in order to provide the preprocessed representation 531 of the input audio signal for the neural network 520.

In addition, as another optional feature, the apparatus 500 is configured to obtain a preprocessed representation of the input audio signal using an All-Pole-Gammatone Filterbank and the neural network 520 is configured to receive the preprocessed representation of the input audio signal, as shown as optional feature, via preprocessing unit 530. In other words, in the example of FIG. 5, the filterbank 540 is an All-Pole-Gammatone Filterbank. Optionally, the All-Pole-Gammatone Filterbank may comprise any or all of the features as disclosed in the context of FIGS. 1 to 2.

Furthermore, as another optional feature, neural network 520 is provided with the noise signal 502, or optionally an information about the noise signal. It is to be noted that a provision of a respective noise signal may be implemented as an optional feature, in any of the embodiments as disclosed in the context of FIGS. 1 to 3.

As another optional feature, the flow block 510 is, as mentioned before, a double coupling flow block, configured to apply a first affine transform 512 to a first portion 502a, e.g. z₁, of input signals to be modified by the double coupling flow block, and to apply a second affine transform 514 to a second portion 502b, e.g. z₂. of the input signals to be modified by the double coupling flow block. In the example as shown, the input signal to be modified is the noise signal 502. As shown, optionally, noise signal 502 may be split into the first and second portion before the respective portion is provided to the respective transform. As shown, results of the transforms may optionally be merged or for example concatenated in order to provide the processed audio signal 503, e.g. \hat{x}.

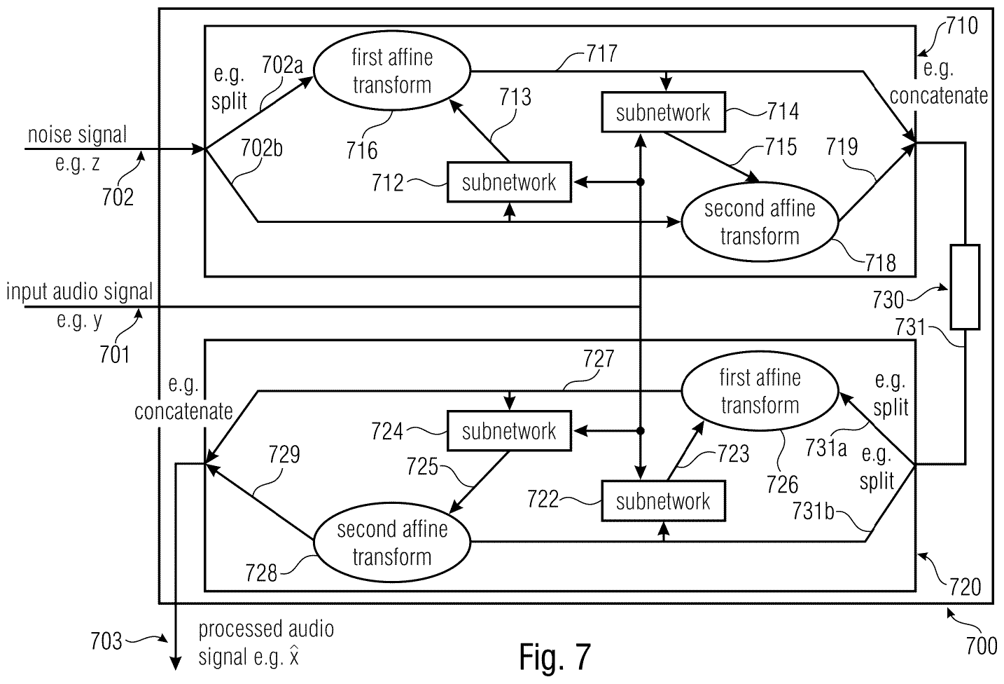

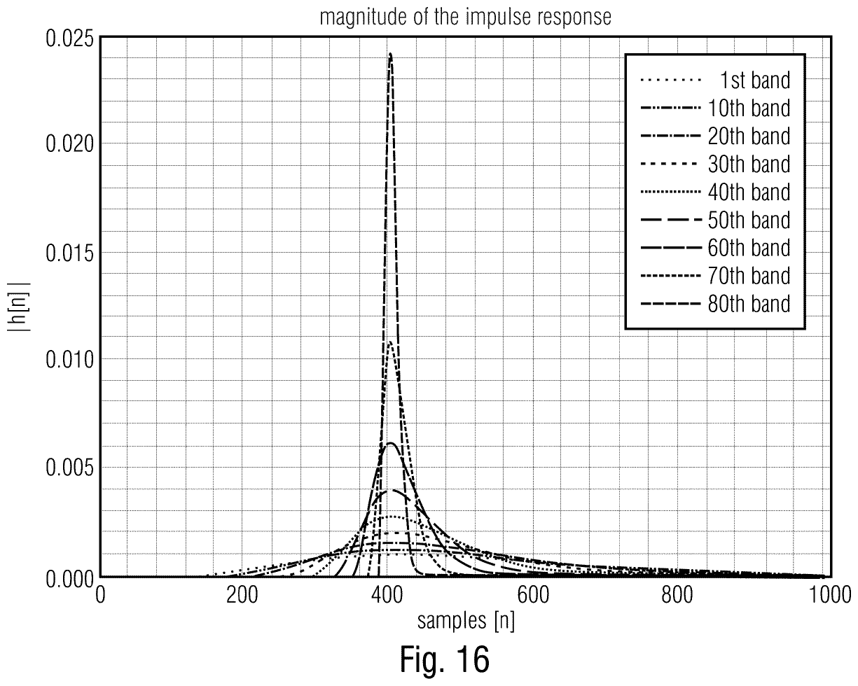

In addition, as optionally shown, results of the respective affine transformation 512, 521 may optionally be provided to the neural network 520. Hence, already transformed portions, e.g. 91, e.g. \hat{x}₂ may be used for the determination of affine transformation parameters. In particular, an output, e.g. \hat{x}₁, of the first affine transformation 512 may be used to determine parameters or parameter adaptations for the second affine transform 514 and vice versa, an output, e.g. \hat{x}₂, of the second affine transformation 514 may be used to determine parameters or parameter adaptations for the second affine transform 512, e.g. as shown and discussed in the context of FIGS. 7, 15 and/or 22.

Hence, according to some embodiments, an important aspect may be that an already transformed first part, e.g. from the first affine transform, is used to determine, e.g. using the neural network, the affine parameters (or adaptations thereof) of the second affine transform (and, for example, vice versa). Such an approach may assure the invertibility of the respective transform and/or of the transformations as a whole. Hence, the double coupling scheme may, for example, be implemented as shown in and discussed with regard to FIG. 15.

In addition, as explained before, the neural network optionally provides parameters for the transforms 512, 514, via information 521, in order to adapt the transforms with regard to a respective input signal 501, of which an enhancement in the form of signal 503 may be desired.

As an optional feature, the depth-wise separable convolutions are configured to perform temporal convolutions and convolutions in a frequency direction. As an example, the preprocessing unit 530 may be configured to apply the depth-wise separable convolutions, so to perform temporal convolutions and convolutions in a frequency direction.

Accordingly, as an optional feature, the apparatus 500 is configured to obtain a representation 541 of the input audio signal using the All-Pole-Gammatone Filterbank 540, and to apply the depth-wise separate convolutions to the representation of the input audio signal obtained using the All-Pole-Gammatone Filterbank. This is performed, as an optional feature, via preprocessing unit 530.

As an optional feature the apparatus is configured to apply different convolutions to the plurality of subband signals, in order to obtain input signals 531 for the neural network. The representation 541 of the input audio signal obtained using the All-Pole Gammatone Filterbank 540 may comprise the plurality of subband signals.

Furthermore, as an optional feature, the apparatus 500 is configured to apply separate temporal convolutions to a plurality of signals representing the input audio signal in order to obtain a plurality of temporally convolved signal values and to apply a plurality of convolutions over frequency to a given set of temporally convolved signal values order to obtain a plurality of input values 531 of the neural network.

As an example, preprocessing unit 530 may be configured to perform the steps (407) to (408) as shown in FIG. 4.

As another optional feature, the apparatus 500 is configured to apply the depth-wise separable convolutions, e.g. using preprocessing unit 531, to a representation, e.g. 541, of the input audio signal, in order to map an input space to a higher dimension. Referring to FIGS. 4 and 5, preprocessing unit 531 may be configured to map the input space, e.g. the dimension of the frequency bands (401), to a higher dimension, e.g. as defined in the output dimension (405).

As another optional feature, the apparatus 500 is configured perform, using preprocessing unit 530, a plurality of convolutions over frequency on the basis of a same set of result values of separate temporal convolutions, wherein the separate temporal convolutions are performed separately on the basis of signals of a frequency-domain representation 541 of the input audio signal 501.

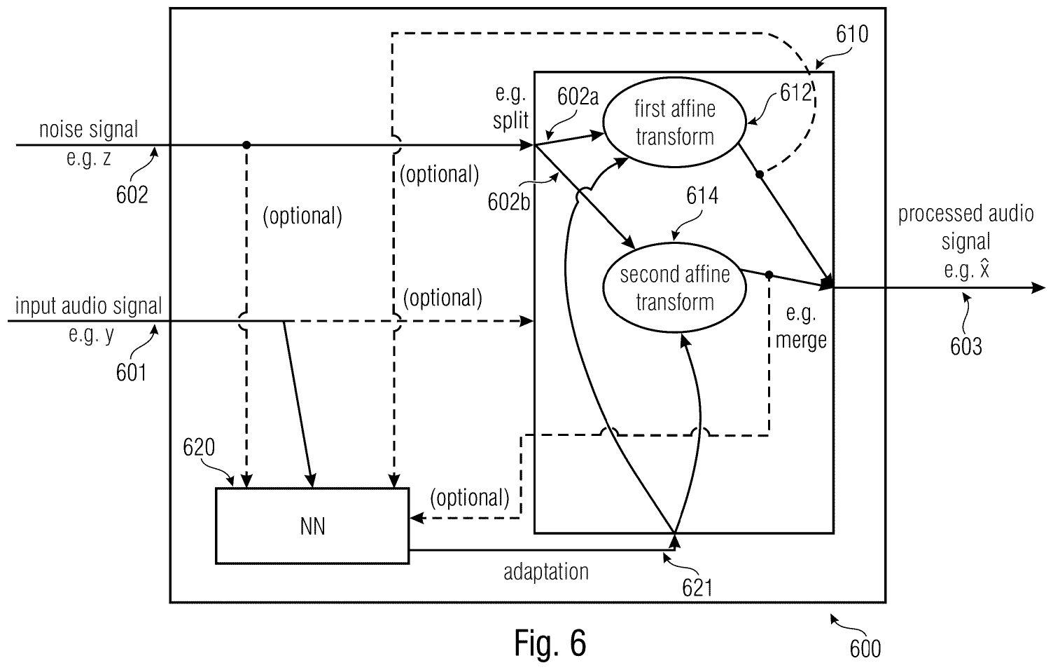

FIG. 6 shows a schematic view of an apparatus for providing a processed audio signal according to embodiments of the third aspect of the invention. FIG. 6 shows an apparatus 600 which is provided with an input audio signal 601, e.g. y, and a noise signal 602, e.g. z. It is to be noted that the noise signal 602 may, for example, be a signal derived from the noise signal. Apparatus 600 is configured to provide the processed audio signal 603, e.g. \hat{x}, which may optionally be an enhanced signal, e.g. an enhanced audio signal, for example, an enhanced version of the input audio signal 601.

Apparatus 600 comprises a flow block 610 and a neural network 620. Flow block 610 is provided with the noise signal 602. Using the flow block 610, the apparatus 600 is configured to provide the processed audio signal 603 based on a processing of said noise signal 602 (or a respective signal derived from the noise signal).

Furthermore, the apparatus 600 is configured to adapt a processing performed using the flow block 610 in dependence on the input audio signal 601 and using the neural network 620. As shown, optionally, the neural network 620 may be configured to provide an information 621 for adapting a processing performed using flow block 610. Hence, apparatus 600 may adapt the processing in dependence on the input audio signal via the neural network 620, and/or, as optionally, shown the input audio signal 601 may be provided directly to the flow block 610, in order to adapt the processing, e.g. in order to adapt affine transformations performed in flow block 610.

The flow block 610 is a double coupling flow block, configured to apply a first affine transform 612 to a first portion 602a, e.g. z₁, of input signals to be modified by the double coupling flow block, and to apply a second affine transform 614 to a second portion 602b, e.g. z₂, of the input signals to be modified by the double coupling flow block. In the example as shown, the input signal to be modified is the noise signal 602. As shown, optionally, noise signal 602 may be split into the first and second portion before the respective portion is provided to the respective transform. As shown, results of the transforms may optionally be concatenated or for example merged in order to provide the processed audio signal 603, e.g. \hat{x}.

In addition, as explained before, the neural network optionally provides parameters for the transforms 612, 614, via information 621, in order to adapt the transforms with regard to a respective input signal 601, of which an enhancement in the form of signal 603 may be desired.

As shown in FIG. 6, optionally, the neural network 620 may be provided with the noise signal 602 (or a signal derived thereof), for the provision of the adaptation information 621.

In addition, as optionally shown and as discussed with regard to FIG. 5, results of the respective affine transformation 612, 621 may optionally be provided to the neural network 620. Hence, already transformed portions, e.g. \hat{x}₁, e.g. \hat{x}₂ may be used for the determination of affine transformation parameters. In particular, an output of the first affine transformation 612 may be used to determine parameters or parameter adaptations for the second affine transformation 614 and vice versa, an output of the second affine transformation 614 may be used to determine parameters or parameter adaptations for the second affine transform 612, e.g. as shown an discussed with FIGS. 7, 15 and/or 22.

FIG. 7 shows a schematic view of an apparatus according to embodiments of the third aspect of the invention with additional, optional features. FIG. 7 shows apparatus 700 for providing a processed audio signal 703 on the basis of an input audio signal 701, e.g. y=x+n. The apparatus 700 is configured to process a noise signal 702, e.g. z, or a signal derived from the noise signal, using one or more flow blocks in order to obtain the processed audio signal 703, e.g. 9.

In the example, shown in FIG. 7, the apparatus 700 optionally comprises a first and a second flow block 710, 720. Furthermore, the apparatus 700 is configured to adapt a processing performed using the one or more flow blocks 710, 720 in dependence on the input audio signal 701 and using a neural network.

According to the example, of FIG. 7 the adaptation using the input signal 701 is performed via the neural network, in the form of a plurality of subnetworks 712, 714, 722, 724. However, as explained before, the incorporation of information extracted from the input audio signal 701 may be performed in addition or alternatively separate to the processing via the neural network.

As shown in FIG. 7, optionally the one or more flow blocks 710, 720 comprise at least one double coupling flow block. In the case of apparatus 700, as an example, both flow blocks 710, 720 are double coupling flow blocks.

The double coupling flow blocks are respectively configured to apply a first affine transform to a first portion of input signals to be modified by the double coupling flow block, and to apply a second affine transform to a second portion of the input signals to be modified by the double coupling flow block.

As shown in FIG. 7, the noise signal 702 is provided to the first flow block 710, where it is split in a first portion 702a, e.g. z₁ and a second portion 702b, e.g. z₂. The first portion 702a is processed via a first affine transform 716 and the second portion 702b is processed via a second affine transform 718.

The respective subnetworks 712, 714 are provided with the input audio signal 701 in order to adapt parameters of the respective affine transform.

As explained before, as an optional feature, respective double-coupling flow blocks 710, 720 are configured to split up the respective input signals 702, 731 of the respective double-coupling flow block, in order to obtain the first portion 702a, 731a, of the input signals, and to apply separate affine transforms to the first portion of the input signal and to the second portion 702b, 731b of the input signal.

As explained before, as another optional feature, the apparatus 700 is configured to concatenate output signals of the first affine transform 716, 726 and of the second affine transform 718, 728, in order to obtain the output signals of the respective double-coupling flow block.

As an optional feature, the apparatus 700 is configured to adapt a processing to be performed by the first affine transform 716 of the double coupling flow block 710 using a neural network 712 in dependence on input signals 702b of the second affine transform, and the apparatus 700 is configured to adapt a processing to be performed by the second affine transform 718 of the double coupling flow block using a neural network 714 in dependence on the first portion 702a of the input signals to be modified by the double coupling flow block.

Therefore, the subnetwork 712 is provided with portion 702b and subnetwork 714 is provided with a result of the first affine transform 716. Optionally, subnetwork 714 may be provided in addition or alternatively with portion 702a and subnetwork 712 may be provided in addition or alternatively with a result of the second affine transform 718.

In other words, the apparatus 700 is configured to use the second portion 702b, 731b of the input signals as input signals of a neural network 712, 722 for determining transform parameters 713, 723 of the of the first affine transform 716, 726 and as input signals of the second affine transform 718, 728

Furthermore, the apparatus 700 is configured to use output signals of the first affine transform 717, 727 as input signals of a neural network 714, 724 for determining transform parameters 715, 725 of the second affine transform 718, 728.

Hence, as an optional feature, the double-coupling flow block 710, 720 is configured to separate the input signals 702, 731 to be modified by the double coupling flow block into two halves and to use a second half of the input signals to be modified by the double coupling flow block for estimating parameters of an affine transform to be applied to a first half of the input signals to be modified by the double coupling flow block.

As an optional feature, flow block 720 is a corresponding double-coupling flow block. Hence, an, for example, concatenated or merged result of the affine transforms 716, 718 of the first flow block 710 are provided as an input signal to the second flow block 720.

As an optional feature, therefore, apparatus 700 comprises a convolution unit 730. In other words, as an optional feature, the apparatus 700 is configured to apply a processing using a sequence of a plurality of double-coupling flow blocks 710, 720, wherein the apparatus is configured to apply an invertible convolution, using convolution unit 730, in order to obtain input signals 731 for a second double-coupling flow block 720 on the basis of output signals of a preceding first double coupling flow block.

In the example of FIG. 7, as another optional feature, the double-coupling flow block 710, 720 is configured to only modify signals of the first portion 702a, 731a of input signals to be modified by the double coupling flow block in a first affine transform 716, 726, and to only modify signals of the second portion 702b, 731b of input signals to be modified by the double coupling flow block in a second affine transform 718, 728.

It is to be noted that embodiments according to FIG. 6 or 7 may optionally comprise any or all of the features, for example in particular with regard to a filterbank and/or a preprocessing unit as disclosed in the context of FIGS. 1 to 5. A respective preprocessing and/or filtering may be implemented for any of the input audio signals.

In the following additional optional features are discussed with regard to the apparatuses 100, 200, 300, 500, 600 and 700. The apparatuses may comprise any or all of the following optional features, individually or in combination.

First of all, it is to be noted that an input audio signal, e.g. 101, 201, 301, 501, 601, 701 may optionally be represented by a set of time domain audio samples. Furthermore, as explained before, a neural network e.g. comprising a plurality of subnetworks, or subnetwork, e.g. 120, 220, 320, 520, 620, 712, 714, 722, 724, 820, associated with a given flow block of the one or more flow blocks is optionally configured to determine one or more processing parameters for the given flow block in dependence on the noise signal, e.g. 102, 202, 302, 502, 602, 702, (e.g. z), or a signal derived from the noise signal, and in dependence on the input audio signal 101, 201, 301, 501, 601, 701 (e.g. y).

In general, according to embodiments, optionally a neural network, e.g. comprising a plurality of subnetworks, or subnetwork, e.g. 120, 220, 320, 520, 620, 712, 714, 722, 724, 820, associated with a given flow block may be configured to provide one or more parameters of an affine processing, which is applied to the noise signal, e.g. 102, 202, 302, 502, 602, 702, or to a processed version of the noise signal, or to a portion of the noise signal, or to a portion of a processed version of the noise signal during the processing.

In this case, optionally, the neural network associated with the given flow block may be configured to determine one or more parameters, e.g. 715, e.g. 725, of the affine processing, in dependence on a first part or first portion, e.g. 702a, 731a, (e.g. z1) of a flow block input signal, e.g. 702, 731 (e.g. z) and in dependence on the input audio signal, e.g. 701 (e.g. y). Furthermore, in this case, an affine processing associated with the given flow block may be configured to apply the determined parameters to a second part or second portion, e.g. 702b, 731b, (e.g. z2) of the flow block input signal (e.g. z), to obtain an affinely processed signal (e.g. z2\hat{ }). Moreover, optionally, the first part, e.g. 717, 727, (e.g. z1) of the flow block input signal (z) and the affinely processed signal, e.g. 719, 729, (e.g. z2\hat{ }) may form a flow block output signal of the given flow block.

As another optional feature, an apparatus 100, 200, 300, 500, 600, 700 according to embodiments may be configured to apply an invertible convolution, e.g. 730 to a flow block output signal (z_{new}) of the given flow block, to obtain a processed flow block output signal (z′_{new}).

It is the be noted that the examples of FIGS. 1, 2, 3, 5, 6 show, for the sake of simplicity only one flow block. However, as discussed before, apparatuses according to embodiments may comprise a plurality of flow blocks, e.g. as shown in FIG. 7, with or without double-coupling architecture. Hence, such flow blocks may be coupled via a convolution unit 730.

Furthermore, optionally, apparatuses according to embodiments, e.g. 100, 200, 300, 500, 600, 700 may be configured to apply a nonlinear expansion to the processed audio signal, e.g. 103, 203, 303, 503, 603, 703, e.g. using a respective flow block (not shown).

In particular, as an optional feature, a respective apparatus may be configured to apply an inverse μ-law transformation as the nonlinear expansion to the processed audio signal (e.g. x\hat{ }). As an example, a transformation according to

$${g}^{- 1} ( x \hat{} ) = sgn ( x \hat{} ) \cdot ( \frac{{( 1 + μ )}^{x \hat{}} - 1}{μ} ) ;$$

may be performed to the processed audio signal (x\hat{ }), wherein sgn( ) is a sign function and wherein μ is a parameter defining a level of expansion.

In general, it is to be noted that according to embodiments, as an optional feature, neural network parameters of the neural network, e.g. 120, 220, 320, 520, 620, 712, 714, 722, 724, 820, for processing the noise signal, e.g. 102, 202, 302, 502, 602, 702, or the signal derived from the noise signal, may be obtained using a processing of a training audio signal or a processed version thereof, in one or more training flow blocks in order to obtain a training result signal. The processing of the training audio signal or of the processed version thereof using the one or more training flow blocks may optionally, be adapted in dependence on a distorted version of the training audio signal and using the neural network. In addition, the neural network parameters of the neural networks may be determined, such that a characteristic of the training result audio signal approximates or comprises a predetermined characteristic.

Furthermore, it is to be noted that any of the apparatuses 100, 200, 300, 500, 600, 700 may be configured to provide neural network parameters of the neural network for processing the noise signal, or the signal derived from the noise signal. Therefore, the respective apparatus may be configured to process a training audio signal or a processed version thereof, using the one or more flow blocks in order to obtain a training result signal to adapt a processing of the training audio signal or of the processed version thereof which is performed using the one or more flow blocks in dependence on a distorted version of the training audio signal and using the neural network. Furthermore, the respective apparatus may be configured to determine neural network parameters of the neural networks, such that a characteristic of the training result audio signal approximates or comprises a predetermined characteristic.

Furthermore, it is to be noted that any of the apparatuses 100, 200, 300, 500, 600, 700 may comprise an apparatus for providing neural network parameters, wherein the apparatus for providing neural network parameters is configured to provide neural network parameters of the neural network for processing the noise signal, or the signal derived from the noise signal, wherein the apparatus for providing neural network parameters is configured to process a training audio signal or a processed version thereof, using one or more training flow blocks in order to obtain a training result signal, and wherein the apparatus for providing neural network parameters is configured to adapt a processing of the training audio signal or the processed version thereof which is performed using the one or more flow blocks in dependence on a distorted version of the training audio signal and using the neural network. Furthermore, the apparatus is configured to determine neural network parameters of the neural networks, such that a characteristic of the training result audio signal approximates or comprises a predetermined characteristic.

Furthermore, optionally, the one or more flow blocks, e.g. 110, 210, 310, 510, 610, 710, 720, are configured to synthesize the processed audio signal, e.g. 103, 203, 303, 503, 603, 703, on the basis of the noise signal, e.g. 102, 202, 302, 502, 602, 702, under the guidance of the input audio signal, e.g. 101, 201, 301, 501, 601, 701.

Optionally, the synthetization may be performed using the affine processing of sample values of the noise signal, or of a signal derived from the noise signal, wherein processing parameters (e.g. s,t) of the affine processing are determined on the basis of sample values of the input audio signal using the neural network.

Furthermore, as an optional feature, an apparatus, e.g. 100, 200, 300, 500, 600, 700, is configured to perform a normalizing flow processing, in order to derive the processing audio signal from the noise signal.

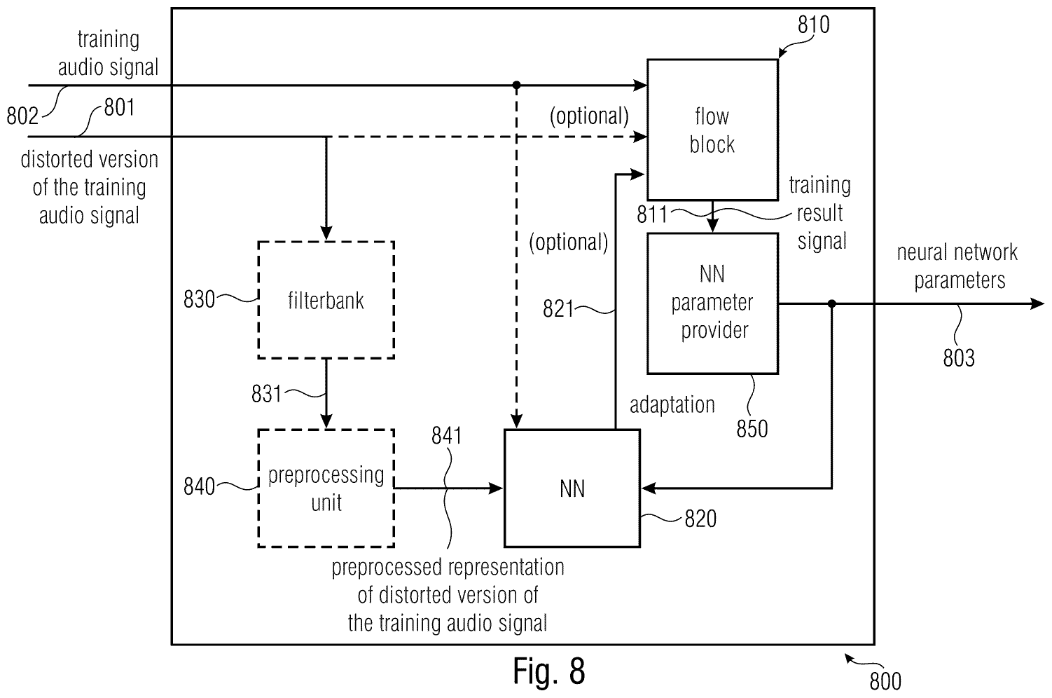

FIG. 8 shows a schematic view of an apparatus for providing neural network parameters for an audio processing according to embodiments of the invention. Apparatus 800 comprises a flow block 810 and a neural network 820.

The apparatus 800 is configured to process a training audio signal 802, e.g. x (e.g. clean speech), or a processed version thereof, using the flow block 810 in order to obtain a training result signal 811.

The apparatus 800 is configured to adapt a processing performed using the flow block 810 in dependence on a distorted version 801 (e.g. y, e.g. y=x+n) of the training audio signal and using the neural network 820, e.g. by providing parameters for affine transformations performed in the flow block 810 via adaptation information 821.

The apparatus is configured to determine neural network parameters 803 of the neural network 820, such that a characteristic of the training result audio signal 811 approximates or comprises a predetermined characteristic (e.g. of noise signal z).

Therefore, the apparatus 800 comprises the neural network parameter provider 850.

Furthermore, apparatus 800 comprises one or more of the following features, according to the first, second and/or third aspect of the invention.

The apparatus 800 may be configured to obtain a preprocessed representation 831 of the distorted version 801 of the training audio signal using an optional filterbank 830 comprising time resolutions and/or frequency resolutions which are adapted to time resolutions and/or frequency resolutions of a human auditory system.

In addition or alternatively, apparatus 800 may be configured to apply depth-wise separable convolutions to a representation 801 or 831 of the distorted version of the training audio signal, in order to derive a preprocessed representation 841 of the distorted version of the training audio signal. Therefore, apparatus may comprise the optional preprocessing unit 840.

Hence, the neural network 820 is configured to receive an respective preprocessed representation 831, 841 of the distorted version of the training audio signal.

In addition or alternatively, the flow block 810 may comprise at least one double coupling flow block, wherein the double coupling flow block is configured to apply a first affine transform to a first portion of input signals to be modified by the double coupling flow block, and wherein the double coupling flow block is configured to apply a second affine transform to a second portion of the input signals to be modified by the double coupling flow block.

In general, it is to be noted that a structure of an inventive apparatus for obtaining a training result signal may be similar or even identical to an inventive apparatus for obtaining a processed signal. According to some embodiments the apparatuses may be identical, e.g. excluding a distinct unit for determining neural network parameters. Hence, embodiments as shown in FIG. 8 may comprise, e.g. with regard to filterbank 830, preprocessing unit 840, flow block 810 and neural network 820 any of the features as disclosed in the context of FIGS. 1 to 7.

In comparison, instead of a noise signal, e.g. z, a training audio signal 802 may be provided which may be a clean speech signal. This signal 802 may be processed via flow block 810 to a training result signal 811 with the goal to have specific characteristics, approximating a noise signal. This processing is guided via distorted signal 801. Vice versa, for obtaining a processed, e.g. enhanced signal, the flow block transformation may be inverted, to transform a noise signal under the guidance of an audio input signal, e.g. a distorted signal of clean speech to the processed signal, as an enhanced version of the distorted signal, e.g. approximating the clean speech. Therefore, a same neural network may be used, e.g. a neural network having same parameters and topology.

As an optional feature, the apparatus 800 is configured to evaluate, e.g. using NN parameter provider 850, a cost function in dependence on characteristics of the obtained training result signal 811, and to determine neural network parameters 803 to reduce or minimize a cost defined by the cost function. This may allow an efficient determination of the neural network parameters.

In addition, optionally, the training audio signal 802 and/or the distorted version 801 of the training audio signal may be represented by a set of time domain audio samples.

Furthermore, as another optional feature, a neural network associated with a given flow block of the one or more flow blocks, e.g. as shown in FIG. 8 neural network 820 for flow block 810, is configured to determine one or more processing parameters (e.g. s, t), e.g. provided in adaptation information 821, for the given flow block in dependence on the training audio signal 802, or a signal derived from the training audio signal, and in dependence on the distorted version 801 of the training audio signal.

As another optional feature, a neural network associated with a given flow block, e.g. as shown in FIG. 8 neural network 820 for flow block 810, is configured to provide one or more parameters of an affine processing, which is applied to the training audio signal, or to a processed version of the training audio signal, or to a portion of the training audio signal, or to a portion of a processed version of the training audio signal during the processing. Therefore, neural network 820 provides information 821 to flow block 810.

Optionally, the neural network associated with the given flow block may be configured to determine one or more parameters (s, t) of the affine processing, in dependence on a first part (x1) of a flow block input signal (x) or in dependence on a first part of a pre-processed flow block input signal (x′) and in dependence on the distorted version of the training audio signal. Furthermore, optionally, an affine processing associated with the given flow block may be configured to apply the determined parameters to a second part (x2) of the flow block input signal (x) or to a second part of the pre-processed flow block input signal (x′), to obtain an affinely processed signal(x2\hat{ }). In addition, optionally, the first part (x1) of the flow block input signal (x) or of the pre-processed flow block input signal (x′) and the affinely processed signal (x2\hat{ }) may form a flow block output signal of the given flow block.

As an optional feature, the apparatus 800 is configured to apply an invertible convolution to the flow block input signal (x) of the given flow block, to obtain the pre-processed flow block input signal (x′). This may be performed by the flow block 810, e.g. before splitting the input signal in several portions.

As an optional feature, the apparatus 800, e.g. flow block 810 is configured to apply a nonlinear input companding to the training audio signal (x) prior to processing the training audio signal (x). Therefore, the apparatus is, as an optional feature, configured to apply a μ-law transformation as the nonlinear input companding to the training audio signal (x).

A transformation according to

$$g ( x ) = sgn ( x ) \cdot \frac{ln ( 1 + μ \vert x \vert )}{ln ( 1 + μ )} ;$$

to the training audio signal (x), may be performed, wherein sgn( ) is a sign function and wherein μ is a parameter defining a level of compression.

In general, as explained before, it is to be noted that optionally, the one or more flow blocks, hence, flow block 810 of FIG. 8, are configured to convert the training audio signal into the training result signal.

Optionally, the one or more flow blocks are adjusted to convert the training audio signal into the training result signal under the guidance of the distorted version of the training audio signal signal, using the affine processing of sample values of the training audio signal, or of a signal derived from the training audio signal, wherein processing parameters (e.g. s,t) of the affine processing are determined on the basis of sample values of the distorted version of the training audio signal using the neural network.

In particular, flow block 810 is, as an optional feature, configured to perform a normalizing flow processing, in order to derive the training result signal from the training audio signal.

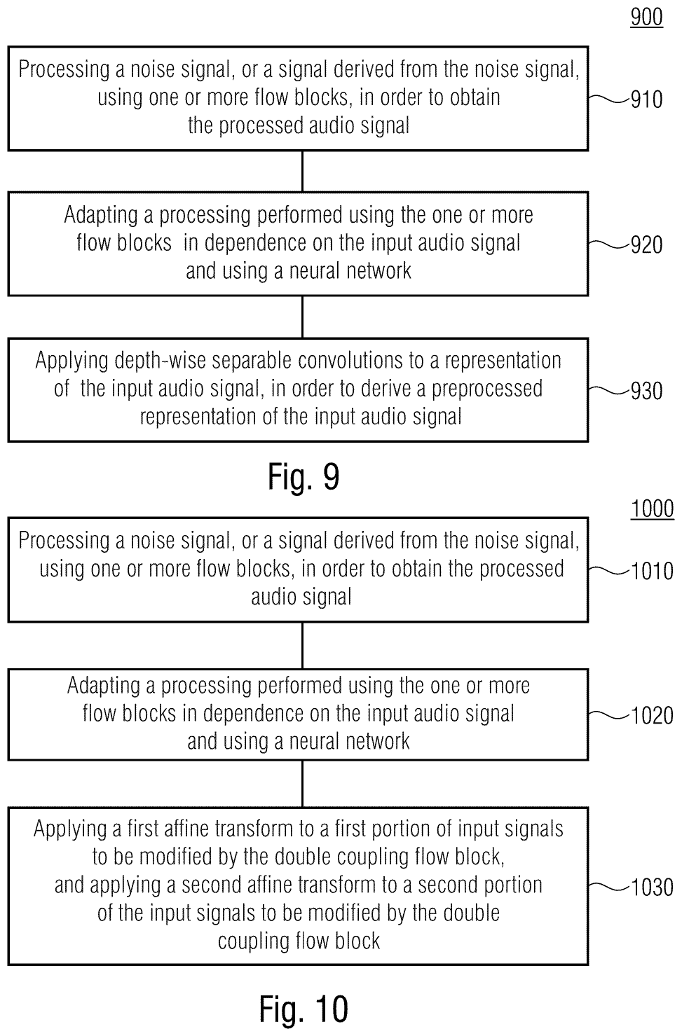

FIG. 9 shows a schematic block diagram of a method for providing a processed audio signal on the basis of an input audio signal, according to embodiments of the second aspect of the invention. Method 900 comprises processing, 910, a noise signal, or a signal derived from the noise signal, using one or more flow blocks, in order to obtain the processed audio signal, adapting, 920, a processing performed using the one or more flow blocks in dependence on the input audio signal and using a neural network and applying, 930, depth-wise separable convolutions to a representation of the input audio signal, in order to derive a preprocessed representation of the input audio signal. Furthermore, the neural network receives the preprocessed representation of the input audio signal.

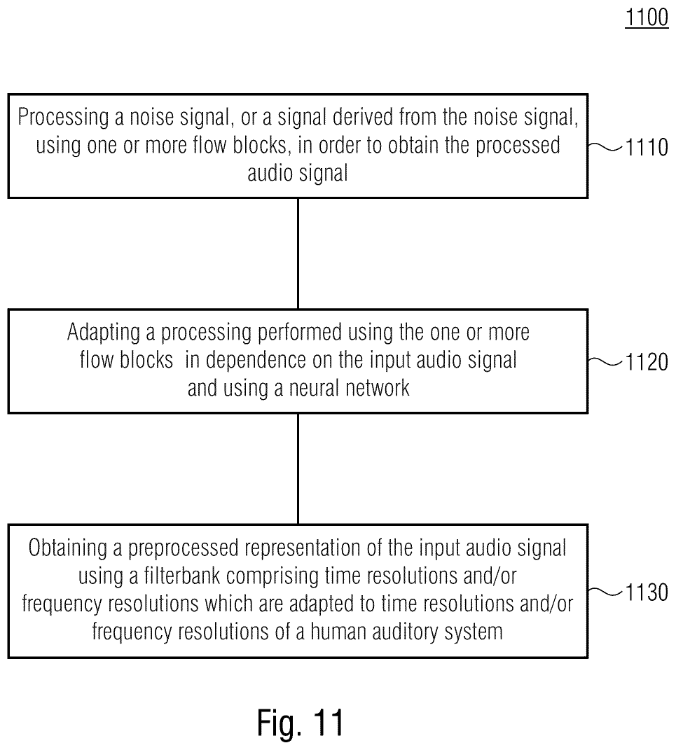

FIG. 10 shows a schematic block diagram of a method for providing a processed audio signal on the basis of an input audio signal, according to embodiments of the third aspect of the invention. Method 1000 comprises processing, 1010, a noise signal, or a signal derived from the noise signal, using one or more flow blocks, in order to obtain the processed audio signal and adapting, 1020, a processing performed using the one or more flow blocks in dependence on the input audio signal and using a neural network. In addition, the one or more flow blocks comprise at least one double coupling flow block, wherein the double coupling flow block applies, 1030, a first affine transform to a first portion of input signals to be modified by the double coupling flow block and wherein the double coupling flow block applies a second affine transform to a second portion of the input signals to be modified by the double coupling flow block.

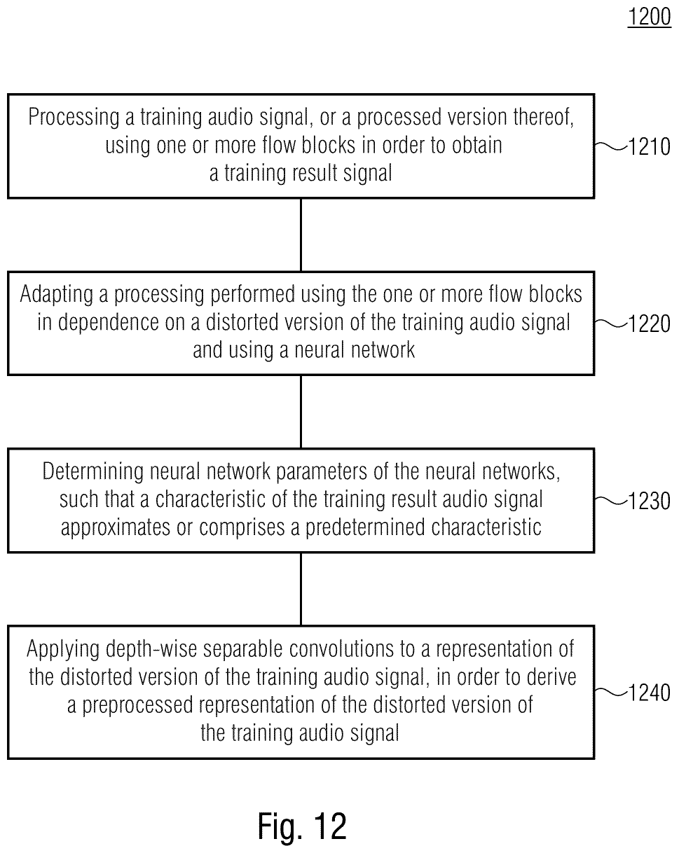

FIG. 11 shows a schematic block diagram of a method for providing a processed audio signal on the basis of an input audio signal, according to embodiments of the first aspect of the invention. Method 1000 comprises processing, 1110, a noise signal, or a signal derived from the noise signal, using one or more flow blocks, in order to obtain the processed audio signal, adapting, 1020, a processing performed using the one or more flow blocks in dependence on the input audio signal and using a neural network and obtaining, 1030 a preprocessed representation of the input audio signal using a filterbank comprising time resolutions and/or frequency resolutions which are adapted to time resolutions and/or frequency resolutions of a human auditory system. Furthermore, the neural network receives the preprocessed representation of the input audio signal.

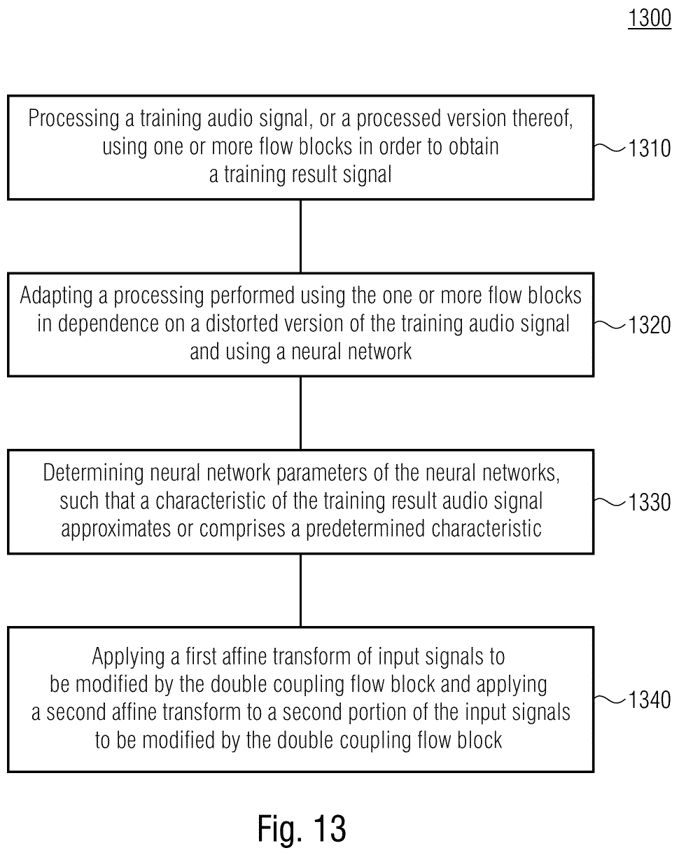

FIG. 12 shows a schematic block diagram of a method for providing neural network parameters for an audio processing, according to embodiments of the second aspect of the invention. Method 1200 comprises processing, 1210, a training audio signal, or a processed version thereof, using one or more flow blocks in order to obtain a training result signal, adapting, 1220, a processing performed using the one or more flow blocks in dependence on a distorted version of the training audio signal and using a neural network, determining, 1230, neural network parameters of the neural networks, such that a characteristic of the training result audio signal approximates or comprises a predetermined characteristic and applying, 1240, depth-wise separable convolutions to a representation of the distorted version of the training audio signal, in order to derive a preprocessed representation of the distorted version of the training audio signal. Furthermore, the neural network receives the preprocessed representation of the distorted version of the training audio signal.

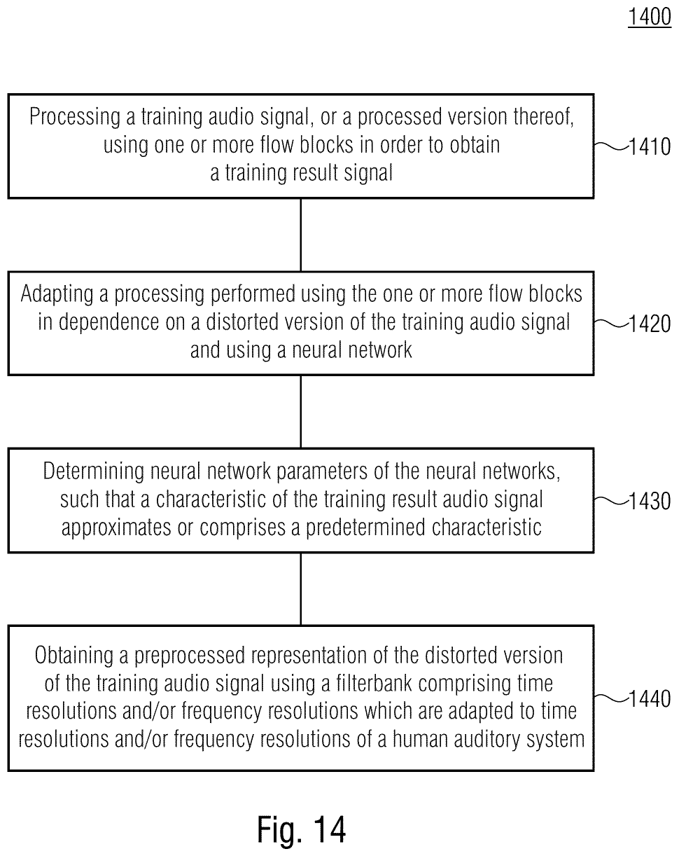

FIG. 13 shows a schematic block diagram of a method for providing neural network parameters for an audio processing, according to embodiments of the third aspect of the invention. Method 1300 comprises processing, 1310, a training audio signal, or a processed version thereof, using one or more flow blocks in order to obtain a training result signal, adapting a processing performed using the one or more flow blocks in dependence on a distorted version of the training audio signal and using a neural network and determining, 1320, neural network parameters of the neural networks, such that a characteristic of the training result audio signal approximates or comprises a predetermined characteristic.

Furthermore, the one or more flow blocks comprise at least one double coupling flow block; wherein the double coupling flow block applies, 1340, a first affine transform to a first portion of input signals to be modified by the double coupling flow block, and wherein the double coupling flow block applies a second affine transform to a second portion of the input signals to be modified by the double coupling flow block.

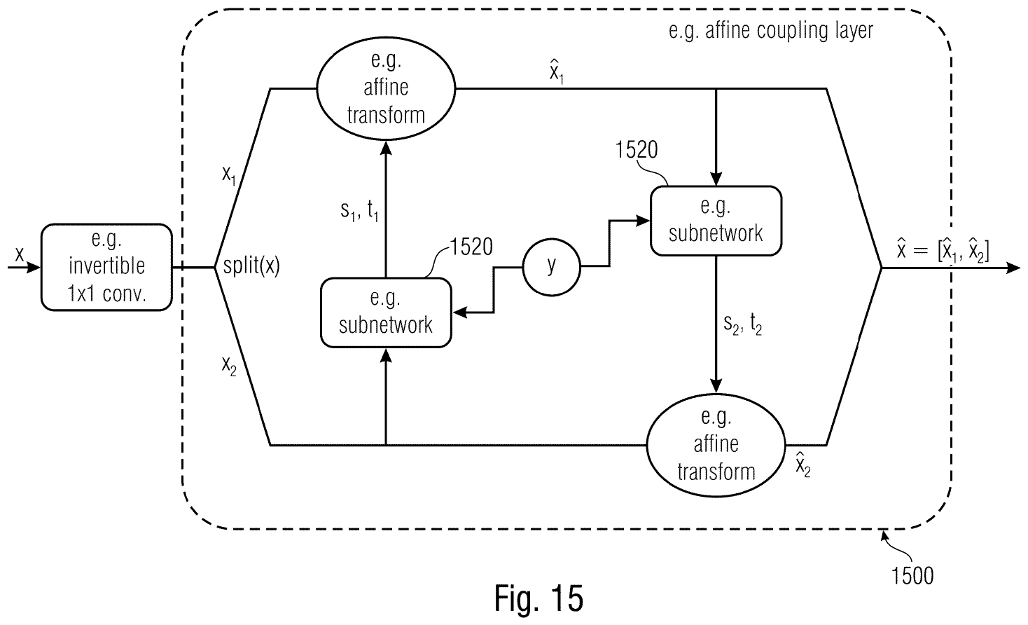

FIG. 14 shows a schematic block diagram of a method for providing neural network parameters for an audio processing, according to embodiments of the first aspect of the invention. Method 1400 comprises processing, 1410, a training audio signal, or a processed version thereof, using one or more flow blocks in order to obtain a training result signal, adapting, 1420, a processing performed using the one or more flow blocks in dependence on a distorted version of the training audio signal and using a neural network; determining 1430, neural network parameters of the neural networks, such that a characteristic of the training result audio signal approximates or comprises a predetermined characteristic, and obtaining, 1440, a preprocessed representation of the distorted version of the training audio signal using a filterbank comprising time resolutions and/or frequency resolutions which are adapted to time resolutions and/or frequency resolutions of a human auditory system. Furthermore, the neural network receives the preprocessed representation of the distorted version of the training audio signal.

### Further Embodiments and Aspects

In the following, further aspects and embodiments according to the invention will be described, which can be used individually or in combination with any other embodiments disclosed herein.

Moreover, the embodiments disclosed in this section may optionally be supplemented by any other features, functionalities and details disclosed herein, both individually and taken in combination.

In the following, a concept of an improved normalizing flow-based speech enhancement using an All-Pole Gammatone Filterbank for conditional input representation will be described.

In the following an overview will be provided.

Deep generative models for Speech Enhancement (SE) receive increasing attention in recent years. The goal is to recover clean speech from signals degraded by background noise. Generative Adversarial Networks (GANs) are the most prominent example, while normalizing flows for SE received less attention despite their untapped potential. One aim of embodiments according to the invention is to shed further light on flow-based SE. Building on previous work, architectural modifications according to embodiments are proposed and disclosed, which may allow to increase its performance and the efficiency of the training process, along with an investigation of different conditional input representations according to embodiments of the invention. Despite being a common choice in related works, Melspectrograms demonstrate to be inadequate for the given scenario. Alternatively, a novel All-Pole Gammatone filtebank (APG), for example, with high temporal resolution is proposed. Hence, embodiments according to the invention may comprise All-Pole Grammatone filterbanks. Experimental evaluation on the VoiceBank-DEMAND dataset is carried out and disclosed. Although computational evaluation metric results would suggest that, in some cases, state-of-the-art GAN-based methods perform best, a perceptual evaluation via a listening test indicates that the presented normalizing flow approach according to embodiments of the invention (for example, based on time domain and APG) performs best, especially at lower SNRs. On average, APG outputs are rated as having good quality, which is unmatched by the other methods, including GAN.

Index Terms: speech enhancement, normalizing flows.

In the following (e.g. as a first section for the concept of an improved normalizing flow-based speech enhancement) an introduction will be provided

Speech Enhancement (SE) aims to improve the quality of speech degraded by disturbing background noise [1]. It has a variety of applications, including automatic speech recognition [2], speech coding [3], hearing aids [4], and broadcasting [5]. SE was investigated extensively and approaches based on Deep Neural Network (DNN) largely overtook traditional techniques like spectral subtraction [6], Wiener filter [7] or subspace methods [8]. Most commonly, a separation mask is estimated by minimizing a distance metric to extract the clean speech components in Time-Frequency (TF) domain [9, 10] or a learned subspace [11]. Still, in recent years, there has been an increasing interest in generative approaches trying to outline the probability distribution of speech signals. The most prominent examples include Generative Adversarial Networks (GANs) [12, 13], Variational Autoencoders (VAE) [14], autoregressive models [15] and diffusion probabilistic models [16]. GAN-based architectures stand out in their performance. For instance, MetricGAN+[12] and HiFi-GAN-2 [13] are the respective successors of adversarialy trained DNNs for SE. MetricGAN+ is directly optimized on PESQ [17] or STOI [18], reporting high values in the corresponding metrics at the output, HiFi-GAN-2 is pretrained in a discriminative way, followed by adversarial optimization to improve perceptual quality. Although the presented results are genuinely impressive, GANs in general are known to be difficult to train in a stable manner and tend to suffer from mode collapse [19].

Diffusion probabilistic models are a recent example of generative models where the transformation from Gaussian noise to clean input is learned by a diffusion process. Lu et al. [16] are the first to apply this approach to SE, restoring clean speech by conditioning the process on noisy speech. They show a leading performance in time-domain generative models and promising generalization in mismatched conditions. Still, sampling from a diffusion process is rather slow and computationally expensive [20]. Normalizing Flows (NFs) [21] are another generative modelling technique. They are trained by maximizing the likelihood of the data directly, making them easy and stable to train. Despite increasing success in fields like computer vision [22] or speech synthesis [23], their application in SE has received less attention. Nugraha et al. [24] applied NFs in combination with a VAE to learn a deep speech prior to be combined with a SE algorithm of choice. In contrast, Strauss et al. [25] used NFs to learn the mapping from Gaussian noise to clean speech conditions on a noisy speech sample entirely in time domain. While outperforming the results of other time-domain GAN-based methods, the overall performance evaluated on computational metrics lag behind comparable TF domain approaches.

For example building on previous work, one aim of this disclosure is to give further insights on NF-based SE, for example, in order to provide better understanding of embodiments according to the invention comprising and/or improving NF-based SE. Embodiments according to the invention improve the original architecture, for example, inter alia, by a low complexity or, for example, even a simple double coupling scheme, for example, to ensure that the, e.g., entire, input signal is processed in one flow block. Further, different input representations for the conditional noisy input signal are considered. Hence, embodiments may comprise different input representations for conditional noisy input signals, and may not be limited by a specific input representation. Our experiments show that despite the fact that Mel-spectrograms are a common choice for conditional signal representation in related fields, like neural vocoders [23, 26], it is inadequate for our scenario. Alternatively, the usage of a Bark-spaced All-Pole Gammatone filterbank (APG) [27] is proposed. Hence, embodiments may comprise Bark-spaced All-Pole Gammatone filterbanks. Similar to Mel this design may, for example, make use of a perceptually motivated filterbank, for example, to mimic the human auditory system and/or reduce the dimensionality of the filter output, e.g., compared to a standard Short-Time Fourier Transform (STFT). At the same time temporal resolution with the design of this filterbank according to embodiments may, for example, be increased, which may optionally overcome the limitations of a standard Mel-spectrogram. Perceptual evaluation via a listening test indicates that the present NF approach according to embodiments (for example) based on time domain and APG may perform better than state-of-the-art GAN-based methods, for example, especially at lower SNRs, even though this is not reflected by computational evaluation metrics.

In the following (e.g. as a second section for the concept of an improved normalizing flow-based speech enhancement), normalizing flow-based speech enhancement will be discussed

Let's define random variables xϵ [symbol] and zϵ [symbol] . A NF is defined by a differentiable function ƒ with differentiable inverse allowing a bijective transformation between the two random variables [21], i.e.,

$$x = f ( z ) , \qquad ( 1 )$$

$$z = {f}^{- 1} ( x ) .$$

The invertability of ƒ ensures that the random variable x is defined by a given probability distribution and can be computed by a change of variables, i.e.,

$${p}_{x} ( x ) = {p}_{z} ( z ) \vert det ( J ( x ) ) \vert , \qquad ( 2 )$$

where J=(x)=∂z/∂x is the Jacobian containing all first order derivatives. Since ƒ is invertible, this holds true also for a sequence of functions ƒ_{1:T}, i.e.,

$$x = {f}_{1} ∘ {f}_{2} ∘ … ∘ {f}_{T} ( z ) . \qquad ( 3 )$$

Let us now introduce a single channel noisy speech signal yϵ [symbol] with sequence length N, obtained by the summation of a clean speech utterance xϵ [symbol] and background noise nϵ [symbol] i.e.,

$$y = x + n . \qquad ( 4 )$$

Moreover, z is defined to be sampled from a Gaussian distribution with zero mean and unit variance, i.e.,

$$z ∼ 𝒩 ( z \vert 0 , I ) . \qquad ( 5 )$$

The aim of NF-based SE may now be to outline the conditional probability distribution pₓ(x|y) by a DNN with parameters θ. Hence, the overall training objective may, for example, be described by a maximization of the log-likelihood, i.e., or for example

$$log {p}_{x} ( x \vert y ; θ ) = log {p}_{z} ( {f}_{θ}^{- 1} ( x ) \vert y ) + log \vert det ( J ( x ) ) \vert . \qquad ( 6 )$$

Inverting the learned network, a noise example sampled from p_{z}(z) may, for example, be conditioned on a noisy speech utterance and mapped back to the distribution of clean speech utterances, for example, resulting in an enhanced speech output.

In the following, (e.g. as a third section for the concept of an improved normalizing flow-based speech enhancement) proposed methods according to embodiments of the invention are discussed.

First, (e.g. as a first subsection of the third section) a model architecture according to embodiments is discussed.

The model used in the experiments builds upon [25]. Embodiments according to the invention may comprise any or all of the features as disclosed in [25], individually or taken in combination. One flow block comprises or for example, (see e.g., FIG. 1) consists of a combination of an invertible 1×1 convolutional layer [28] and an affine coupling layer [22]. In a first step, the input signal may, for example, be subsampled by, for example, a factor group size, for example, to create a multichannel input. For example, the invertible convolution layer, the input may, for example, be separated into, for example, two halves, for example, with one part being provided to the subnetwork, for example, inside the coupling layer, for example, to learn affine transformation parameters for the second half. The transformed signal may, for example, be concatenated with the unchanged second part and may, for example, serve as an input for the next block. This operation may, for example, be invertible, ensuring that the network is invertible overall, for example, although the subnetwork inside the coupling layer estimating the affine parameters does not need to be invertible. Similar to Waveglow [123] the subnetwork used in embodiments of the invention may, for example, be a stack of dilated convolutions, for example, with skip connections applied to the input signal, for example, with the conditional information being introduced by a gated activation, for example, as proposed for WaveNet [29].

For example, to increase the capacity of each block, a double coupling scheme, e.g., being an improved version of, or for example, inspired by [30] may, for example, be implemented (or in other words, embodiments according to the invention may comprise a double coupling scheme), for example, where the output of the affine transformation is reused as an input to calculate the affine parameters for the second part, i.e., as an example.

$${\hat{x}}_{1} = {s}_{1} ( {x}_{2} ) ⊙ {x}_{1} + {t}_{1} ( {x}_{2} ) , \qquad ( 7 )$$

$${\hat{x}}_{2} = {s}_{2} ( {\hat{x}}_{1} ) ⊙ {x}_{2} + {t}_{2} ( {\hat{x}}_{1} ) ,$$

where, as an example, the input x is separated into x₁ and x₂ and s₁, t₁, as well as s₂ and t₂, may, for example, be estimated by respective subnetworks. The output may, for example, be concatenated, i.e., \hat{x}=[\hat{x}₁, \hat{x}₂] and, for example, passed to the next flow block. If order is preserved, this scheme may optionally remain invertible, e.g., also when inverting the network.

FIG. 15 shows a schematic view of a double coupling scheme according to an embodiment of the invention. For example, before entering the affine coupling layer, the subsampled input x, may for example, pass through the invertible 1×1 convolution. The conditional input y may, for example, serve as input to both subnetworks. For example, a flow block, e.g. 110, 210, 310, 510, 610, 710, 720, may comprise the shown structure 1500. Accordingly, x may be a noise signal, e.g. 102, 202, 302, 502, 602, 702, y may be an input audio signal, e.g. 101, 201, 301, 501, 601, 701 and a neural network such as e.g. 120, 220, 320, 520, 620, 712, 714, 722, 724, 820 may comprise or be the subnetworks 1520.

Second, (e.g. as a second subsection of the third section) Conditional Input Representations according to embodiments are discussed

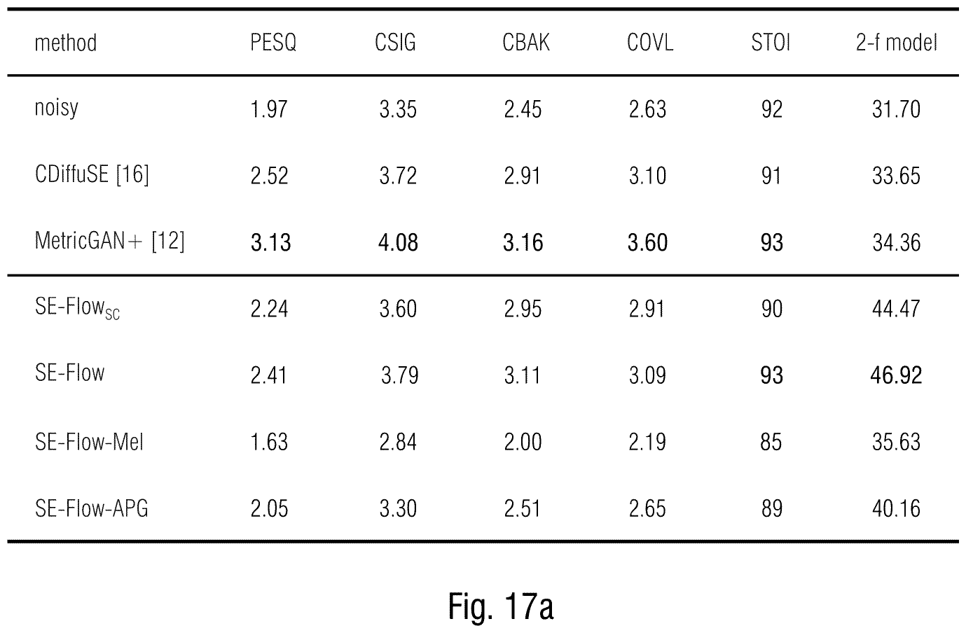

Next to the original time domain as representation of the conditional signal, experiments with additional variations are conducted. The Mel-spectrogram is a common choice for conditional representation and works well, e.g., in neural vocoders [23, 26]. Embodiments according to the invention may, optionally, comprise a Mel spectrogram, e.g., as disclosed in [23, 26]. The time frames may, for example, be up-sampled to a map the time input dimension, for example, using a transposed convolution layer as in [23]. Hence, embodiments according to the invention may comprise a time frame upsampling and mapping, e.g., as disclosed in [23]. As an alternative, a specifically designed complex valued All-Pole Gammatone filterbank (APG) is proposed. Hence, embodiments according to the invention may compromise a APG, e.g., as explained in the following. Motivated by human hearing, the center frequencies of the IIR-filters may optionally have constant distances on the Bark scale, e.g., with increasing bandwidth at increasing frequencies may, for example, proportional to the Bark bandwidths. Wider filters usually have shorter impulse responses which lead to increased time resolution. To compensate for possible time differences in the filter outputs a lookahead for each filter, for example, may be implemented depending on its group delay at center frequency, for example, scaled with a common factor for all bands. For example, only the magnitude of the filterbank outcome may, optionally, processed further with the network. An example, of a magnitude of the impulse response of the chosen filter design, e.g., a filter design according to the embodiments of the invention is displayed in FIG. 16.

FIG. 16: shows a schematic plot of an example of magnitude of the filter response of the All-Pole Gammatone filterbank (APG), e.g. a filterbank 130, 230, 540, according to embodiments of the invention. The filter outputs may, for example, be delay compensated. For better visibility, only every 10^{th} band is displayed (Best viewed in colors)

In the following (e.g. as a fourth section for the concept of an improved normalizing flow-based speech enhancement), an Experimental Setup according to embodiments is discussed.

First, (e.g. as a first subsection of the fourth section) a Dataset considered for embodiments is discussed.

For the experiments we consider the commonly used VoiceBank-DEMAND dataset [31]. It includes 30 speakers separated into 28 for training and 2 for testing. The dataset items consist of speech samples from the VoiceBank corpus [32] corrupted with noise items from the DEMAND database [33] and artificially generated speech shaped and babble noise. The items are mixed together with Signal-to-noise-Ratios (SNRs) of 0, 5, 10 and 15 dB for training. For testing, SNRs of 2.5, 7.5, 12.5, 17.5 dB are used. In our experiments, SNRs of 2.5, 7.5, 12.5 and 17.5 dB are used. In our experiments, one make and one female speaker are taken out of the training set to build a development set. All items are re-sampled to 16 kHz.

Second, (e.g. as a second subsection of the fourth section) Model Configurations according to embodiments are discussed.

The models are connected with 16 flow blocks and group-size=12. The subnetwork has 8 layers of diluted convolutions implemented as depthwise separable convolutions. In contrast to [25], the output channels of the dilated convolutions are set to 128 and the conditional input layer is replaced by a depthwise separable convolution. This configuration of the model using the time domain input has a total of 8.8 M parameters, which is significantly lower than the one in [25]. Using the double coupling scheme may, for example, be approximately double the amount of the parameters, for example, since two subnetworks may optionally have to be learned for each block. From each training audio file, 1 s long chunks are randomly extracted and given as inputs to the network. The models are trained with a batch size of 4 and Adam optimizer (leaning rate=0.001). the leaning rate is decayed by a factor of 0.5 if the validation loss did not decrease for 10 consecutive epochs. All models are trained for 200 epochs. Similar to previous works [23, 25], using a lower standard deviation for the sampling distribution in inference showed a slightly better performance experimentally. Hence, the standard deviation was lowered from σ=1.0 in training to σ=0.9 in enhancement.

From the Mel-spectrogram the FFT parameters are chosen to be 512 samples for the input and window size, with Hann window and 75% overlap. The spectrogram includes 80 frequency bands. The APG is implemented with a filter order of 4 and a lookahead factor for group delay compensation of 0.7. The minimum center frequency is set to 40 Hz with a total of 80 frequency bands and the maximum center frequency just below Nyquist frequency. Hence, as an example, embodiments according to the invention may comprise the beforementioned parameters e.g., with a tolerance of +/−5% or with a tolerance of +/−10% or with a tolerance of +/−50% or with a tolerance of +/−100%.

In the following (e.g. as a fifth section for the concept of an improved normalizing flow-based speech enhancement) embodiments are evaluated.

We compare the following flow-based systems. The original model with single coupling time domain conditional input [25] is denoted as SE-Flowₛₑ, while the proposed double coupling version is referred to with SE-Flow. The varied input conditions are characterized by the suffix -Mel and -APG. Two state-of-the-art generative models are also considered, namely the MetricGAN+[12] and CDiffuSE [16]. The samples enhanced by MetricGAN+ are obtained from the model in the speechbrain project. For CDiffuSE, the outputs were kindly provided by the authors of the corresponding paper.

First, (e.g. as a first subsection of the fifth section) Computational Evaluation Metrics are discussed.

The methods are first evaluated with computational metrics. PESQ [17] (worst: −0.5; best 4.5) and the mean opinion score estimating composite measures [34] (worst: 1; best: 5) are commonly reported on this dataset. For further insight, STOI [18] (in %; best: 100) and the 2f-model score [35, 26] (worst: 0; best: 100) are also reported.

Second, (e.g. as a second subsection of the fifth section) a Listening Test is discussed.

The considered methods are also compared via a listening test following the MUSHRA methodology [37] with a reference condition and a 3.5 KHz low-pass anchor. The participants were instructed to rate the overall sound quality of the presented items with regards to the reference. The test conditions were selected to be from the BUS and CAFE noise settings and only the most difficult SNR conditions of the test set i.e., 2.5 and 7.5 dB SNR. Per test speaker, one item of at least 3 s was randomly selected for a total of 8 test items. Repeating the computational evaluation on the test items confirmed that the selection was not biased towards a particular model. The samples used for this test along with the input unprocessed signals can be found online².

The raw outputs from the different systems differ greatly in overall energy. For one example item, output integrated loudness [38] can range from −17 to −24 LUFS, while both noisy input and reference clean speech are −22.8 LUFS. Moreover, different levels of leaking noise are observed after processing. This can make it very difficult to assign an overall quality score to the compared systems, as noise suppression and speech quality are often inversely proportional. In order to ensure that a fair comparison of the different systems is possible, leaking noise level matching and loudness normalization are carried out, similarly to [39]. First background components are obtained by subtracting the enhanced output and the clean reference from the input mixture. Then:
1. The reference condition is created by mixing the reference clean speech with the corresponding background component, with an attenuation factor of 30 dB.
2. Speech activity information is determined by thresholding the envelope of the clean reference.
3. The integral loudness of the non-speech parts of the reference condition are determined (gating deactivated).
4. For each test condition, the noise attenuation level is obtained iteratively, until the same loudness of the non-speech parts is reached as in the reference condition. The same speech activity information gathered for the reference condition is used.
5. Each condition is normalized to −23 LUFS (integrated loudness, gating deactivated).

The test was conducted online using the webMUSHRA API with each participant using their own PC and headphones. The participants were 20 fellow colleagues with various level of experience in audio research. No results had to be removed in accordance to the MUSHRA post-screening procedure. Note that, the test items for CDiffuSE are generated from the raw network output, while the numbers reported in the paper include a recombination with the original noisy signal. This, however, leads to a significant introduction of original noise in enhanced speech parts, which would give this method an unfair disadvantage.

In the following (e.g. as a sixth section for the concept of an improved normalizing flow-based speech enhancement) Results and Discussion are provided.

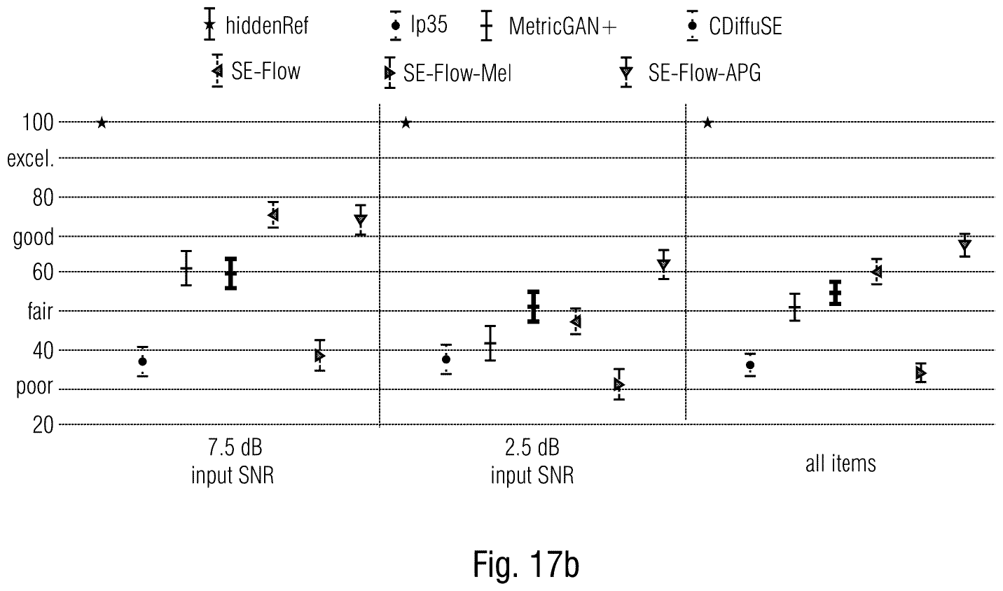

FIG. 17a shows a table showing examples for experimental results obtained from the VoiceBank-DEMAND test set according to embodiments of the invention. Mean values with the best results in bold.

First, (e.g. as a first subsection of the sixth section) Computational Metric Results are discussed

FIG. 17a (e.g. table 1) shows the results of the computational evaluation.

SE-Flow outperforms the corresponding single coupling version, confirming the benefits of the proposed double coupling architecture at the cost of a more complex network. SE-Flow with time domain conditional input shows the best performance among the flow-based models. SE-Flow-Mel shows the lowest performance with even some metrics worse than the noisy baseline. One possible explanation is that the Mel-representation of the noisy speech utterance is sub-optimal for the application at hand, since it does not provide phase information about the input. Comparing SE-Flow-APG with other methods, it can be seen that, while the model has lower results in PESQ and the composite measures, the 2f model results only lay behind the time domain flow model. MetricGAN+ shows the best results in PESQ and the composite measures. These results are somewhat to be expected since MetricGAN+ directly optimizes the PESQ. In terms of STOI, MetricGAN+ shows the best performance together with SE-Flow. CDiffuSE outperforms all flow-based models in terms of PESQ, CSIG, CBAK and COVL, only staying behind MetricGAN+. This confirms the results reported in their publication with regards to other time-domain generative models. With regards to the 2-f model, the time domain SE-Flow shows the best performance among all methods.

The computational metrics were also evaluated separately for the 7.5 and 2.5 dB SNR conditions. While the absolute values are significantly different, the main trends and the ranking of the methods remain the same as in FIG. 17a.

Second, (e.g. as a second subsection of the sixth section) Listening Test Results are discussed.

FIG. 17b: shows a schematic plot of an example of listening test results (20 listeners). Means and 95% confidence intervals (student's t-distribution). The results are shown for the different input conditions (7.5 dB and 2.5 dB SNR) and over all items (Best viewed in colors) The results of the listening experiment are depicted in FIG. 17b. The average results over all items show that SE-Flow-APG performs best among all methods being rated as having good quality on average, and with the confidence intervals not overlapping with the other methods. SE-Flow follows. Despite the high values in the computational evaluation metrics, MetricGAN+ performs worse than SE-Flow, SE-Flow-APG and CDiffuSE. Inspecting some of the enhanced samples reveal artefacts in the voice timer which could explain the low results in part. CDiffuSE takes the third place behind both suggested flow-based approaches. Examining the respective samples reveals a low-pass-filter-like characteristic of the output samples, which could explain the results to some extent. As indicated also by the computational evaluation, SE-Flow-Mel has the worst performance with scores similar to the low-pass anchor.

Considering the results grouped by input SNR condition, SE-Flow-APG performs best at the lowest SNR condition, while being on par with SE-Flow at 7.5 dB SNR. In fact, the performance of SE-Flow drops dramatically going from 7.5 dB to 2.5 dB SNR, where the superiority of SE-Flow-APG is evident. Also, MetricGAN+ is close to the good quality range for the higher SNR condition but it drops 15 MUSHRA points when tested at 2.5 dB SNR. CDiffuSe shows more robustness across SNRs but overall lower quality than SE-Flow-APG.

It is worth highlighting that the results from the listening test are in disagreement with the results from the computational metrics. In fact, even if the computational metrics can be extremely useful for their convenience and reproducibility, their correlation with perceived audio quality is often low [36]. For this reason, conclusions drawn exclusively from computational metrics should be taken with extreme care, as they can be misleading in terms of perceived quality, as in the reported experiments.

In the following (e.g. as a seventh section for the concept of an improved normalizing flow-based speech enhancement) a Conclusion is provided.

In this disclosure, several improvements according to embodiments to a flow-based SE model are introduced and disclosed. With the presented double coupling scheme according to embodiments, the model may optionally process the e.g., entire input signal for example in each coupling layer for example leading to higher capacity and performance. Additional experiments consider different representations for the conditional input. Despite being a common choice in related fields, Mel-spectrograms prove not to be a suitable choice for flow-based SE. As an alternative, a proposed Bark spaced All-Pole Gammatone filterbank-based pre-processing with increased time resolution overcomes the Mel induced problems. Hence, embodiments comprising All-Pole Gammatone filterbanks and/or pre-processing based on such filterbanks may overcome Mel-induced problems. While the results of popular computational metrics may, in some cases, be behind state-of-the-art generative models, the outcome of a listening test indicates that flow-based SE using a time-domain or gammatone-filtered conditional signal according to embodiments may have favourable perceptual performance. Hereby, it was shown that the proposed method according to embodiments not only outperforms the compared generative models, but the performance also remains strong throughout different SNR conditions.

In the following, further aspects and embodiments according to the invention will be described, which can be used individually or in combination with any other embodiments disclosed herein.

Moreover, the embodiments disclosed in this section may optionally be supplemented by any other features, functionalities and details disclosed herein, both individually and taken in combination.

In the following, a concept of Improved Normalizing Flow-Based Speech Enhancement with Varied Input Conditions will be described.

The presented work is based on the previous publications and embodiments comprise methods for normalizing flow-based speech enhancement.

The presented work is based on the previous publication and filed patent (PCT/EP2021/062076) for normalized flow-based speech enhancement.

1. Aspects of the invention (features thereof may be used individually or in combination with any or all embodiments disclosed herein): Usage of depthwise separable convolutions as conditional layer.

To introduce the conditional noisy signal to the network an initial convolution layer may, for example, be used to map the input space to a higher dimension. Originally, this was a standard 1d-convolutional layer. According to embodiments of this invention, the usage of a depthwise separable convolution is performed or for example proposed, for example, to reduce the complexity and/or amount of parameters of this step.

2. Aspect of the invention (features thereof may be used individually or in combination with any or all embodiments disclosed herein): Usage of a “double-coupling” scheme inside the affine coupling layer.

For example, to ensure invertibility of the given DNN, affine coupling layers are used according to embodiments of the invention. In this layer the signal may, for example, be separated into two halves, where one half may, for example, be used to estimate the affine transformation parameters for the second half. At the output, the original first half and the transformed second half may, for example, be concatenated and forwarded to the next block. The structure of those layers may, for example, leave, e.g., one part of the signal unchanged. To overcome this, one can, for example and according to embodiments, reuse the output of the affine transformation and compute the affine parameters of the previously unchanged part. This may, for example, increase the expressibility, e.g. expressiveness, of the network for example at cost of higher complexity.

This “double coupling” scheme is inspired by:
a. Ardizzone et al., “Analysing inverse problems with invertible neural networks,” ICLR, 2019.

However, the inventive double coupling scheme, for example, as an improved version, is new for audio applications.

3. Aspect of the invention (features thereof may be used individually or in combination with any or all embodiments disclosed herein): Usage of an all-pole gammatone filterbank as preprocessing step for the conditional input signal.

In the original work, for example in preceding approaches, the conditional input signal was in time domain. Although it was shown to have a decent performance in the previous work, overall results were somewhat limited. In other fields the conditional signal is often given by another representation, e.g., Mel spectrogram. As an alternative, according to embodiments of the invention, a specifically designed complex-valued all-pole gammatone filterbank (APGT) is proposed and/or used. Motivated by human hearing, the center frequencies of the IIR-filters may, for example, have constant distances on the Bark scale for example, with increasing bandwidth at increasing frequencies optionally proportional to the Bark bandwidths. Wider filters usually have shorter impulse responses which may, for example, lead to increased time resolution. For example, to compensate for possible time differences in the filter outputs a lookahead for each filter may, for example, be implemented according to embodiments, for example depending on its group delay at center frequency e.g., scaled with a common factor for all bands. For example, only the magnitude of the filterbank outcome may, for example, be processed further with the network according to embodiments of the invention.

In the following, further aspects and embodiments according to the invention will be described, which can be used individually or in combination with any other embodiments disclosed herein.

Moreover, the embodiments disclosed in this section may optionally be supplemented by any other features, functionalities and details disclosed herein, both individually and taken in combination.

In the following, a concept of Improved normalizing flow-based speech enhancement with varied input conditions will be further discussed.

A background for embodiments according to the invention may comprise normalizing flow based speech enhancement. However, it is to be noted that embodiments according to the invention may comprise approaches, e.g. methods, for normalizing flow based speech enhancement. Background: PCT/EP2021/062076. In particular, embodiments comprise improved flow-based speech enhancement.

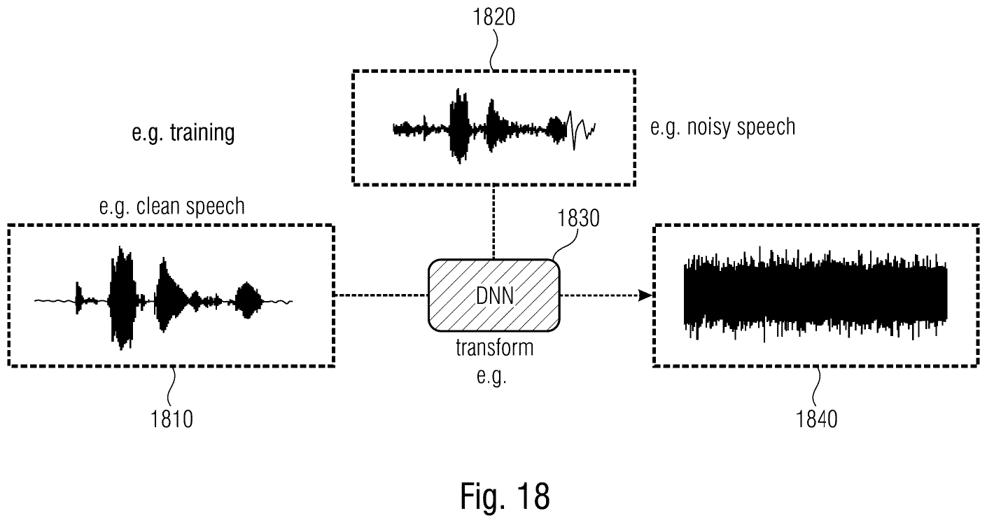

FIG. 18 shows a schematic visualization of a basic principle for a training process according to embodiments of the invention. As shown, a clean speech signal, a training audio signal, may be provided to an apparatus according to embodiments, e.g. comprising a flow block and a neural network, for example, a flow block comprising a neural network. The processing performed using the one or more flow blocks may be adapted in dependence on a distorted version 1820 of the training audio signal 1810 and using a neural network 1830, e.g. a deep neural network (DNN). Based on the flow block a training result audio signal 1840 may be provided. The neural network may be trained to comprise neural network parameters to best adapt the processing performed using the flow blocks, so that the training result audio signal approximates or comprises a predetermined characteristic, e.g. a noise characteristics.

Embodiments may comprise any or all of the following features:

Learn mapping form clean speech to white noise conditioned on noisy counterparts; Adapted model from speech synthesis; Works in time domain.

As an example, embodiments may hence be performed in time domain.

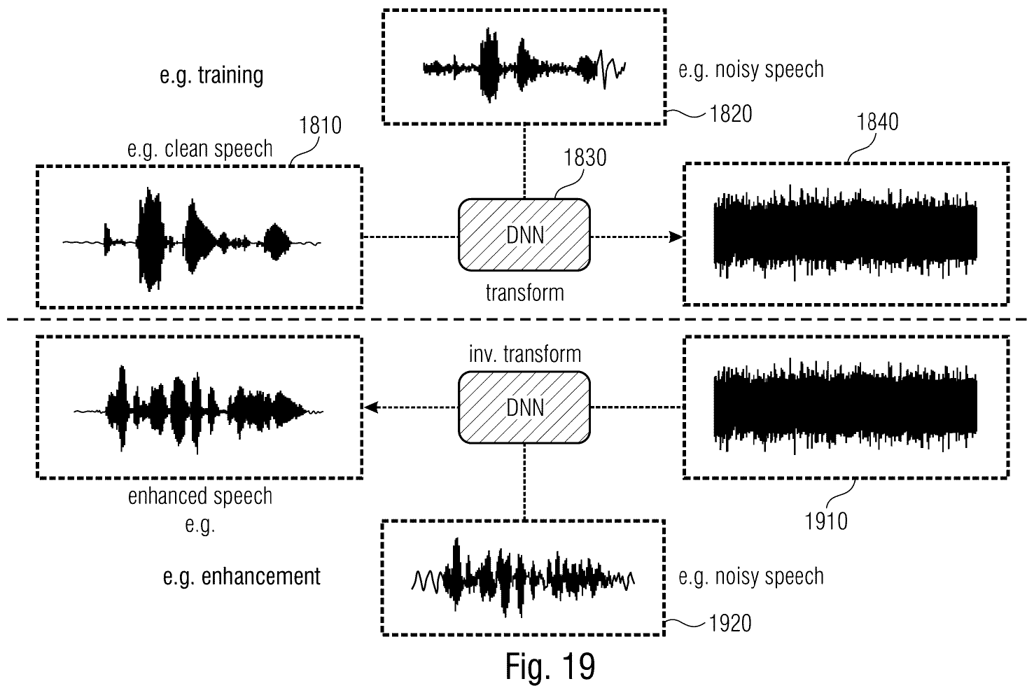

FIG. 19 shows a schematic visualization of a basic principle for a training process together with an enhancement process according to embodiments of the invention. Based on the training, the transformation performed in a respective flow block may be inverted, so as to transform a noise signal 1910, to a processed audio signal (enhanced speech signal), based on an adaptation of the processing in a respective flow block using the neural network and an input audio signal 1920.

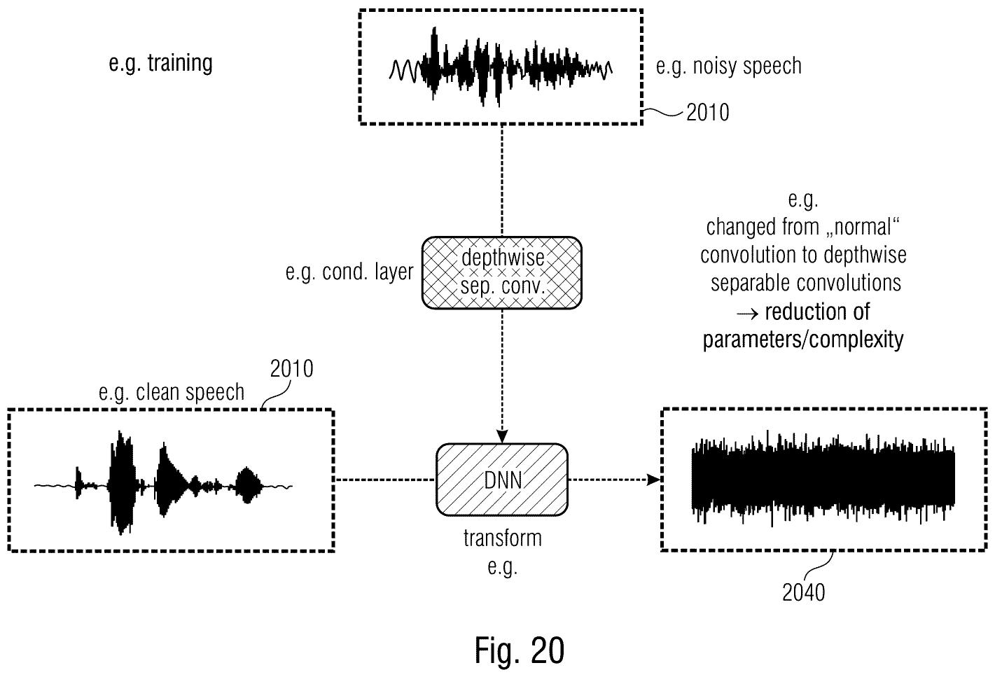

FIG. 20 shows a schematic visualization of an improvement, for example a first improvement, according to aspects of the invention. Features as shown in FIG. 20 may be used individually or taken in combination. As shown in FIG. 20 a preprocessing comprising a depthwise separable convolution may be performed based on a distorted version 2020 of the training audio signal 2010. In FIG. 20 a respective training process is shown, with training result audio signal 2040. Again, it is to be noted that features shown in FIG. 20 may be used individually or taken in combination.

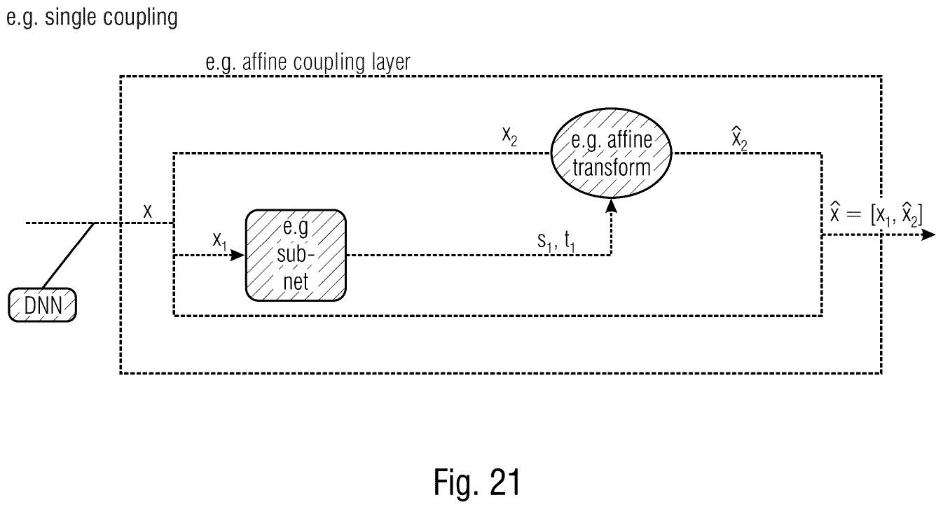

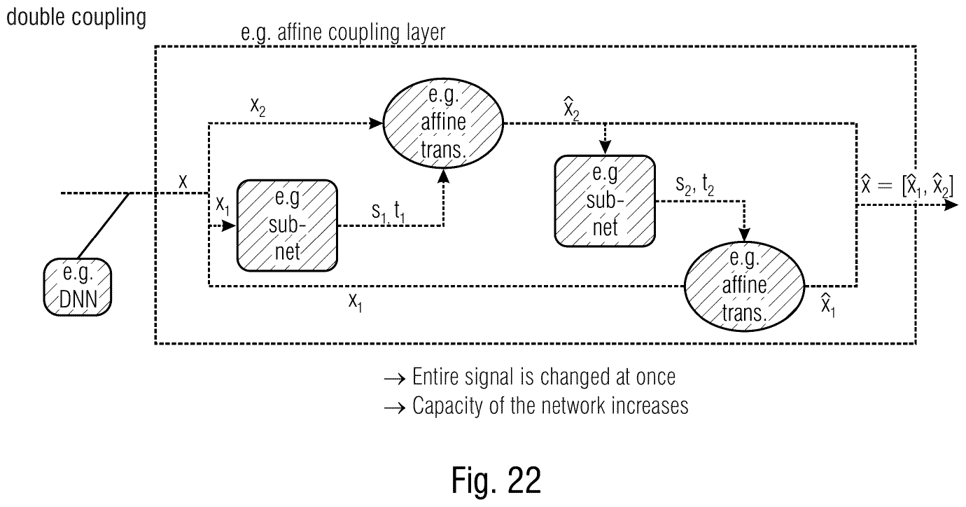

FIGS. 21 and 22 show a schematic visualization of an improvement, for example a second improvement, according to aspects of the invention.

Embodiments may comprise, as shown in FIG. 21 a single coupling approach. An input signal of a flow block, e.g. x may be split, wherein a first portion is provided to a neural network or a subnetwork, based on which parameters for an affine transform may be provided, which processes the second portion of the input signal. The processed second portion as well as the first portion may hence be concatenated to a resulting signal.

Accordingly, one part of the input signal may remain, e.g. substantially, unchanged. Again, with regard to FIG. 21 it is to be noted that features may be used individually or in combination.

In comparison, FIG. 22 shows a schematic visualization of a double coupling concept according to embodiments of the invention. As explained before, the entire signal may, for example, be changed at once. Hence, a capacity of the network may be increased.

Inspired by: L. Ardizzone et al., “Analyzing inverse problems with invertible neural networks,” ICLR, 2019; But no audio application.

Again, with regard to FIG. 22 it is to be noted that features may be used individually or in combination.

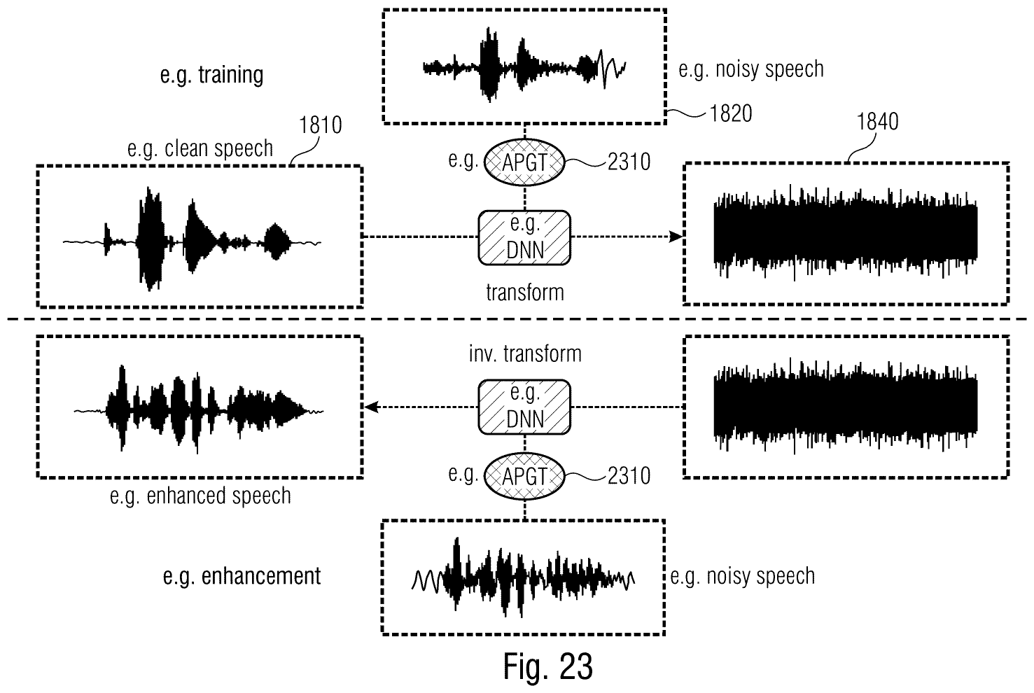

FIG. 23 shows a schematic visualization of an improved principle for a training process together with an enhancement process according to embodiments of the invention. As shown in FIG. 23, in comparison to FIG. 19, as an improvement, e.g. third improvement, filterbanks 2310, for example All-Pole-Gammatone-Filterbanks, may be implemented. Again, with regard to FIG. 23 it is to be noted that features may be used individually or in combination.

Hence, in summary, e.g. summary of improvements according to embodiments, embodiments may comprise filterbanks, e.g. in the form of All-Pole-Gammatone-Filterbanks, double coupling schemes and/or conditional layers, using depthwise separable convolutions.

Embodiments may comprise any or all of the above features.

With regard to computational metrics, reference is made to FIG. 17a. With regard to CDiffuSE reference is made to [15] and with regard to MetricGAN+ reference is made to [16].

MetricGAN+: Research Center for Information Technology Innovation, Taiwan Ohio State, USA
MILA Quebec AI institute, Canada

CDiffuSE: Carnegie Mellon University, USA
Research Center for Information Technology Innovation, Taiwan→State of the art in generative speech enhancement

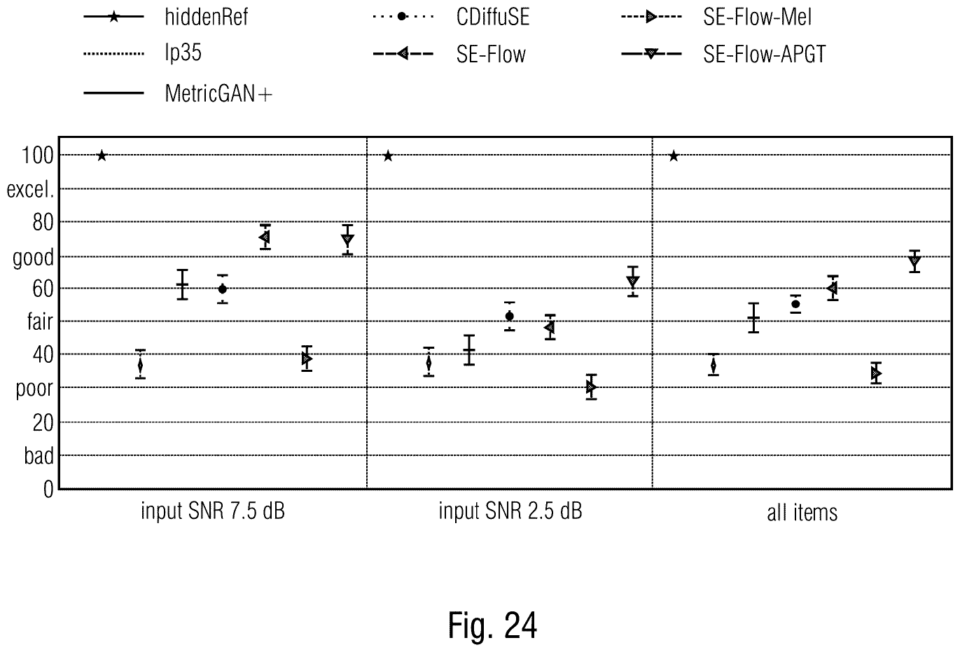

For an example regarding a listening test, reference is made to FIG. 24

Furthermore, possible applications of embodiments comprise: Individual audio objects for MPEG H (Application to separate legacy content into individual components), Dialog enhancement.

Inventions or improvements to previous version (e.g. advantages of embodiments) comprise, inter alia: APGT filterbank as conditional signal representation, Double coupling scheme for increased expressibility in normalizing flow based speech enhancement, Conditional layer as depthwise separable convolutions.

In other words, embodiments comprise improvements with regard to approaches related to flow-based neural networks for speech enhancement in time domain: First, usage of a double-coupling approach, such that all portions can be processed in one step. Second, usage of all-pole-gammatone-filterbanks, for a transformation of a conditionally noisy signal while maintaining the time resolution. Third, usage of depthwise separable convolutional network layers, as step between filterbank transformation and the introduction to the neural net with the goal of a reduction of complexity.

An improvement in quality in comparison to similar methods was proven via listening tests.

It is to be noted that embodiments may comprise any or all of these features.

In general, it is to be noted that embodiments comprise or are related to Normalizing flow-based speech enhancement using improved input conditions.

### Implementation Alternatives:

Although some aspects are described herein in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] P. Loizou, Speech Enhancement: Theory and Practice, 2nd ed. CRC Press, 2013.
[2] A. Pandey, C. Liu, Y. Wang, and Y. Saraf, “Dual Application of Speech Enhancement for Automatic Speech Recognition,” in 2021 IEEE Spoken Language Technology Workshop (SLT), 2021, pp. 223-228.
[3] Z. Zhao, H. Liu, and T. Fingscheidt, “Convolutional Neural Networks to Enhance Coded Speech,” IEEE Trans. Audio, Speech, Lang. Process., vol. 27, no. 4, pp. 663-678, 2019.
[4] G. Park, W. Cho, K.-S. Kim, and S. Lee, “Speech Enhancement for Hearing Aids with Deep Learning on Environmental Noises,” Applied Sciences, vol. 10, no. 17, 2020.
[5] M. Torcoli, C. Simon, J. Paulus et al., “Dialog+ in Broadcasting: First Field Tests using Deep-Learning Based Dialogue Enhancement,” in Int. Broadcast. Conv. (IBC) Technical Papers, 2021.
[6] H. Gustafsson, S. Nordholm, and I. Claesson, “Spectral Subtraction Using Reduced Delay Convolution and Adaptive Averaging,” IEEE Trans. Speech Audio Process., vol. 9, no. 8, pp. 799-807, 2001.
[7] J. C., J. Benesty, Y. H., and S. Doclo, “New Insights into the Noise Reduction Wiener Filter,” IEEE Trans. Audio, Speech, Lang. Process., vol. 14, no. 4, pp. 1218-1234, 2006.
[8] M. Klein and P. Kabal, “Signal Subspace Speech Enhancement with Perceptual Post-Filtering,” in Proc. IEEE Intl. Conf. on Acoustics, Speech and Signal Processing (ICASSP), 2002, pp. 537-540.
[9] Y. Koizumi, S. Karita, S. Wisdom et al., “DF-Conformer: Integrated architecture of Conv-TasNet and Conformer using linear complexity self-attention for speech enhancement.”
[10] D. Wang and J. Chen, “Supervised Speech Separation Based on Deep Learning: An Overview,” IEEE Trans. Audio, Speech, Lang. Process., vol. 26, no. 10, pp. 1702-1726, 2018.
[11] Y. Yi Luo and N. Mesgarani, “Conv-TasNet: Surpassing Ideal Time-Frequency Magnitude Masking for Speech Separation,” IEEE Trans. Audio, Speech, Lang. Process., vol. 27, pp. 1256-1266, 2019.
[12] S.-W. Fu, C. Yu, T.-A. Hsieh et al., “MetricGAN+: An Improved Version of MetricGAN for Speech Enhancement,” in Proc. Interspeech Conf., 2021, pp. 201-205.
[13] J. Su, Z. Jin, and A. Finkelstein, “HiFi-GAN-2: Studio-quality speech enhancement via generative adversarial networks conditioned on acoustic features,” in Proc. IEEE Workshop on Applications of Signal Processing to Audio and Acoustics, 2021, pp. 166-170.
[14] S. Leglaive, X. Alameda-Pineda, L. Girin, and R. Horaud, “A Recurrent Variational Autoencoder for Speech Enhancement,” in Proc. IEEE Intl. Conf. on Acoustics, Speech and Signal Processing (ICASSP), 2020, pp. 371-375.
[15] K. Qian, Y. Zhang, S. Chang et al., “Speech Enhancement Using Bayesian Wavenet,” in Proc. Interspeech Conf., 2017, pp. 2013-2017.
[16] Y.-J. Lu, Z.-Q. Wang, S. Watanabe, et al., “Conditional Diffusion Probabilistic Model for Speech Enhancement,” in Proc. IEEE Intl. Conf. on Acoustics, Speech and Signal Processing (ICASSP), 2022 (to appear).
[17] International Telecommunication Union, “Recommendation ITU-T P.862 Perceptual evaluation of speech quality (PESQ), and objective method for end-to-end speech quality assessment of narrowband telephone band and wideband digital codes,” 2000.
[18] C. H. Taal, R. C. Hendriks, R. Heusdens, and J. Jensen, “A Short-Time Objective Intelligibility Measure for Time-Frequency Weighted Noisy Speech,” in Proc. IEEE Intl. Conf. on Acoustics, Speech and Signal Processing (ICASSP), 2010, pp. 4214-4217.
[19] L. Metz, B. Poole, D. Pfau, and J. Sohl-Dickstein, “Unrolled Generative Adversarial Networks,” in 5th International Conference on Learning Representations, ICLR 2017, 2017.
[20] J. Song, C. Meng, and S. Ermon, “Denoising Diffusion Implicit Models,” in International Conference on Learning Representations, 2021.
[21] G. Papamakarios, E. Nalisnick, D. Rezende et al., “Normalizing Flows for Probabilistic Modeling and Inference,” Journal of Machine Learning Research, vol. 22, no. 57, pp. 1-64, 2021.
[22] L. Dinh, J. Sohl-Dickstein, and S. Bengio, “Density Estimation Using Real NVP,” in 5th Int. Conf. on Learning Representations, ICLR, 2017.
[23] R. Prenger, R. Valle, and B. Catanzaro, “Waveglow: A Flowbased Generative Network for Speech Synthesis,” in Proc. IEEE Intl. Conf. on Acoustics, Speech and Signal Processing (ICASSP), 2019, pp. 3617-3621.
[24] A. A. Nugraha, K. Sekiguchi, and K. Yoshii, “A Flow-Based Deep Latent Variable Model for Speech Spectrogram Modeling and Enhancement,” IEEE/ACM Transactions on Audio, Speech, and Language Processing, vol. 28, pp. 1104-1117, 2020.
[25] M. Strauss and B. Edler, “A Flow-Based Neural Network for Time Domain Speech Enhancement,” in Proc. IEEE Intl. Conf. on Acoustics, Speech and Signal Processing (ICASSP), 2021, pp. 5754-5758.
[26] A. Mustafa, N. Pia, and G. Fuchs, “Stylemelgan: An efficient high-fidelity adversarial vocoder with temporal adaptive normalization,” in Proc. IEEE Intl. Conf. on Acoustics, Speech and Signal Processing (ICASSP), 2021, pp. 6034-6038.
[27] R. F. Lyon, “All-pole models of auditory filtering,” in in Diversity in Auditory Mechanics, 1997, pp. 205-211.
[28] D. Kingma and P. Dhariwal, “Glow: Generative flow with invertible 1×1 convolutions,” in Advances in Neural Information Processing Systems 31, 2018, pp. 10 215-10 224.
[29] A. van den Oord, S. Dieleman, H. Zen et al., “Wavenet: A generative model for raw audio,” in arXiv, 2016. [Online]. Available: https://arxiv.org/abs/1609.03499
[30] L. Ardizzone, J. Kruse, C. Rother, and U. Kothe, “Analyzing Inverse Problems with Invertible Neural Networks,” in 7th Int. Conf. on Learning Representations, ICLR, 2019.
[31] C. Valentini Botinhao, X. Wang, S. Takaki, and J. Yamagishi, “Speech Enhancement for a Noise-Robust Text-to-Speech Synthesis System using Deep Recurrent Neural Networks,” in Proc. Interspeech Conf., 2016, pp. 352-356.
[32] C. Veaux, J. Yamagishi, and S. King, “The Voice Bank Corpus: Design, collection and data analysis of a large regional accent speech database,” in Int. Conf. Oriental COCOSDA held jointly with the Conf. on Asian Spoken Language Research and Evaluation (O-COCOSDA/CASLRE), 2013, pp. 1-4.
[33] J. Thiemann, N. Ito, and E. Vincent, “The Diverse Environments Multi-channel Acoustic Noise Database (DEMAND): A database of multichannel environmental noise recordings,” Proc. of Meetings on Acoustics, vol. 19, no. 1, p. 035081, 2013.
[34] Y. Hu and P. Loizou, “Evaluation of Objective Quality Measures for Speech Enhancement,” IEEE Transactions on Audio, Speech, and Language Processing, vol. 16, no. 1, pp. 229-238, 2008.
[35] T. Kastner and J. Herre, “An Efficient Model for Estimating Subjective Quality of Separated Audio Source Signals,” in Proc. IEEE Workshop on Applications of Signal Processing to Audio and Acoustics, 2019, pp. 95-99.
[36] M. Torcoli, T. Kastner, and J. Herre, “Objective Measures of Perceptual Audio Quality Reviewed: An Evaluation of their Application Domain Dependence,” IEEE Trans. Audio, Speech, Lang. Process., vol. 29, pp. 1530-1541, 2021.
[37] International Telecommunication Union, “Recommendation ITU-R BS.1534-3 Method for the subjective assessment of intermediate quality level of audio systems,” 2015.
[38] “Recommendation ITU-R BS.1770-4 Algorithms to measure audio programme loudness and true-peak audio level,” 2015.
[39] M. Strauss, J. Paulus, M. Torcoli, and B. Edler, “A Hands On Comparison of DNNs for Dialog Separation Using Transfer Learning from Music Source Separation,” in Proc. Interspeech Conf., 2021, pp. 3900-3904

1. An apparatus for providing a processed audio signal on the basis of an input audio signal,
wherein the apparatus is configured to process a noise signal, or a signal derived from the noise signal, using one or more flow blocks, in order to obtain the processed audio signal,
wherein the apparatus is configured to adapt a processing performed using the one or more flow blocks in dependence on the input audio signal and using a neural network;
wherein the apparatus is configured to obtain a preprocessed representation of the input audio signal using a filterbank comprising time resolutions and/or frequency resolutions which are adapted to time resolutions and/or frequency resolutions of a human auditory system; and
wherein the neural network is configured to receive the preprocessed representation of the input audio signal.

2. Apparatus according to claim 1,
wherein time resolutions of the filterbank and frequency resolutions of the filterbank approximate time resolutions and frequency resolutions of the human auditory system.

3. Apparatus according to claim 1,
wherein filters of the filterbank are infinite impulse response filters.

4. Apparatus according to claim 1,
wherein the filterbank is an All-Pole Gammatone Filterbank.

5. An apparatus for providing a processed audio signal on the basis of an input audio signal,
wherein the apparatus is configured to process a noise signal, or a signal derived from the noise signal, using one or more flow blocks, in order to obtain the processed audio signal,
wherein the apparatus is configured to adapt a processing performed using the one or more flow blocks in dependence on the input audio signal and using a neural network;
wherein the apparatus is configured to obtain a preprocessed representation of the input audio signal using an All-Pole-Gammatone Filterbank; and
wherein the neural network is configured to receive the preprocessed representation of the input audio signal.

6. Apparatus according to claim 1,
wherein the All-Pole-Gammatone Filterbank is configured to obtain a plurality of channel signals associated with a plurality of frequency bands;
wherein widths of the frequency bands increase monotonically with increasing center frequencies of the respective frequency bands, and/or
wherein widths of the frequency bands are adapted in accordance with a psychoacoustic model, and/or
wherein center frequencies of the frequency bands are adapted in accordance with a psychoacoustic model.

7. Apparatus according to claim 1,
wherein the All-Pole-Gammatone Filterbank comprises a plurality of filters; and
wherein center frequencies of the filters comprise constant distances on a Bark scale with increasing bandwidth at increasing frequencies.

8. Apparatus according to claim 1,
wherein the All-Pole-Gammatone Filterbank is configured to at least partially compensate different group delays between different filters.

9. Apparatus according to claim 1,
wherein a transfer function of the All-Pole-Gammatone Filterbank does not comprise any finite zero point.

10. Apparatus according to claim 1,
wherein imaginary parts of poles of a transfer function of the All-Pole-Gammatone Filterbank all comprise a same sign.

11. Apparatus according to claim 1,
wherein the All-Pole-Gammatone Filterbank is a Complex All-Pole-Gammatone-Filterbank.

12. Apparatus according to claim 1,
wherein the one or more poles of a transfer function of the All-Pole-Gammatone Filterbank coincide.

13. Apparatus according to claim 1,
wherein the apparatus is configured to obtain the preprocessed representation of the input audio signal on the basis of magnitudes of output signals of the All-Pole-Gammatone-Filterbank; and/or
wherein the apparatus is configured to neglect phase information of the output signals of the All-Pole-Gammatone-Filterbank.

14. Apparatus according to claim 1,
wherein the All-Pole-Gammatone-Filterbank is configured to provide between 20 and 100 output signals.

15. Apparatus according to claim 1,
wherein the apparatus is configured to apply a plurality of convolutions to a set of output values of the All-Pole-Gammatone Filterbank, or to a set of magnitude values derived from output values of the All-Pole-Gammatone Filterbank, in order to obtain input values of the neural network.

16. Apparatus according to claim 1,
wherein the apparatus is configured to apply depth-wise separable convolutions to a set of output values of the All-Pole-Gammatone Filterbank, or to a set of magnitude values derived from output values of the All-Pole-Gammatone Filterbank, in order to obtain input values of the neural network.

17. An apparatus for providing a processed audio signal on the basis of an input audio signal,
wherein the apparatus is configured to process a noise signal, or a signal derived from the noise signal, using one or more flow blocks, in order to obtain the processed audio signal,
wherein the apparatus is configured to adapt a processing performed using the one or more flow blocks in dependence on the input audio signal and using a neural network;
wherein the apparatus is configured to apply depth-wise separable convolutions to a representation of the input audio signal, in order to derive a preprocessed representation of the input audio signal;
wherein the neural network is configured to receive the preprocessed representation of the input audio signal.

18. Apparatus according to claim 17,
wherein the depth-wise separable convolutions are configured to perform temporal convolutions and convolutions in a frequency direction.

19. Apparatus according to claim 17,
wherein the apparatus is configured to obtain a representation of the input audio signal using an All-Pole-Gammatone Filterbank, and
wherein the apparatus is configured to apply the depth-wise separate convolutions to the representation of the input audio signal obtained using the All-Pole-Gammatone Filterbank.

20. Apparatus according to claim 19,
wherein the representation of the input audio signal obtained using the All-Pole Gammatone Filterbank comprises a plurality of subband signals.

21. Apparatus according to claim 20,
wherein the apparatus is configured to apply different convolutions to the plurality of subband signals, in order to obtain input signals for the neural network.

22. Apparatus according to claim 17,
wherein the apparatus is configured to apply separate temporal convolutions to a plurality of signals representing the input audio signal, in order to obtain a plurality of temporally convolved signal values; and
wherein the apparatus is configured to apply a plurality of convolutions over frequency to a given set of temporally convolved signal values, in order to obtain a plurality of input values of the neural network.

23. Apparatus according to claim 17,
wherein the apparatus is configured to apply the depth-wise separable convolutions to a representation of the input audio signal, in order to map an input space to a higher dimension.

24. Apparatus according to claim 17,
wherein the apparatus is configured perform a plurality of convolutions over frequency on the basis of a same set of result values of separate temporal convolutions, wherein the separate temporal convolutions are performed separately on the basis of signals of a frequency-domain representation of the input audio signal.

25. Apparatus according to claim 17,
wherein the one or more flow blocks comprise at least one double coupling flow block;
wherein the double coupling flow block is configured to apply a first affine transform to a first portion of input signals to be modified by the double coupling flow block, and
wherein the double coupling flow block is configured to apply a second affine transform to a second portion of the input signals to be modified by the double coupling flow block.

26. Apparatus according to claim 17,
wherein the apparatus is configured to obtain a preprocessed representation of the input audio signal using a filterbank comprising time resolutions and/or frequency resolutions which are adapted to time resolutions and/or frequency resolutions of a human auditory system; and
wherein the neural network is configured to receive the preprocessed representation of the input audio signal.

27. Apparatus according to claim 17, wherein the apparatus is configured to obtain a preprocessed representation of the input audio signal using an All-Pole-Gammatone Filterbank; and
wherein the neural network is configured to receive the preprocessed representation of the input audio signal.

28. An apparatus for providing a processed audio signal on the basis of an input audio signal,
wherein the apparatus is configured to process a noise signal, or a signal derived from the noise signal, using one or more flow blocks, in order to obtain the processed audio signal,
wherein the apparatus is configured to adapt a processing performed using the one or more flow blocks in dependence on the input audio signal and using a neural network;
wherein the one or more flow blocks comprise at least one double coupling flow block;
wherein the double coupling flow block is configured to apply a first affine transform to a first portion of input signals to be modified by the double coupling flow block, and
wherein the double coupling flow block is configured to apply a second affine transform to a second portion of the input signals to be modified by the double coupling flow block.

29. Apparatus according to claim 28,
wherein apparatus is configured to adapt a processing to be performed by the first affine transform of the double coupling flow block using a neural network in dependence on input signals of the second affine transform, and
wherein apparatus is configured to adapt a processing to be performed by the second affine transform of the double coupling flow block using a neural network in dependence on the first portion of the input signals to be modified by the double coupling flow block.

30. Apparatus according to claim 28,
wherein the apparatus is configured to apply a processing using a sequence of a plurality of double-coupling flow blocks,
wherein the apparatus is configured to apply an invertible convolution, in order to obtain input signals for a second double-coupling flow block on the basis of output signals of a preceding first double coupling flow block.

31. Apparatus according to claim 28,
wherein the double-coupling flow block is configured to split up the input signals of the double-coupling flow block, in order to obtain the first portion of the input signals and the second portion of the input signals, and to apply separate affine transforms to the first portion of the input signal and to the second portion of the input signal.

32. Apparatus according to claim 28,
wherein the apparatus is configured to concatenate output signals of the first affine transform and of the second affine transform, in order to obtain the output signals of the double-coupling flow block.

33. Apparatus according to claim 28,
wherein the apparatus is configured to use the second portion of the input signals as input signals of a neural network for determining transform parameters of the first affine transform and as input signals of the second affine transform.

34. Apparatus according to claim 28,
wherein the apparatus is configured to use output signals of the first affine transform as input signals of a neural network for determining transform parameters of the of the second affine transform.

35. Apparatus according to claim 28,
wherein the double-coupling flow block is configured to separate the input signals to be modified by the double coupling flow block into two halves, and
wherein the double-coupling flow block is configured to use a second half of the input signals to be modified by the double coupling flow block for estimating parameters of an affine transform to be applied to a first half of the input signals to be modified by the double coupling flow block.

36. Apparatus according to claim 28,
wherein the double-coupling flow block is configured to only modify signals of the first portion of input signals to be modified by the double coupling flow block in a first affine transform, and to only modify signals of the second portion of input signals to be modified by the double coupling flow block in a second affine transform.

37. The apparatus according to claim 1,
wherein the input audio signal is represented by a set of time domain audio samples.

38. The apparatus according to claim 1,
wherein a neural network associated with a given flow block of the one or more flow blocks is configured to determine one or more processing parameters for the given flow block in dependence on the noise signal, or a signal derived from the noise signal, and in dependence on the input audio signal.

39. The apparatus according to claim 1,
wherein a neural network associated with a given flow block is configured to provide one or more parameters of an affine processing, which is applied to the noise signal, or to a processed version of the noise signal, or to a portion of the noise signal, or to a portion of a processed version of the noise signal during the processing.

40. The apparatus according to claim 39,
wherein a neural network associated with the given flow block is configured to determine one or more parameters of the affine processing, in dependence on a first part of a flow block input signal and in dependence on the input audio signal, and
wherein an affine processing associated with the given flow block is configured to apply the determined parameters to a second part of the flow block input signal, to obtain an affinely processed signal; and
wherein the first part of the flow block input signal and the affinely processed signal form a flow block output signal of the given flow block.

41. The apparatus according to claim 40,
wherein the apparatus is configured to apply an invertible convolution to the flow block output signal of the given flow block, to obtain a processed flow block output signal.

42. The apparatus according to claim 1,
wherein the apparatus is configured to apply a nonlinear expansion to the processed audio signal.

43. The apparatus according to claim 42,
wherein the apparatus is configured to apply an inverse μ-law transformation as the nonlinear expansion to the processed audio signal.

44. The apparatus according to claim 42, wherein the apparatus is configured to apply a transformation according to
$${g}^{- 1} ( x \hat{} ) = sgn ( x \hat{} ) \cdot ( \frac{{( 1 + μ )}^{x \hat{}} - 1}{μ} ) ;$$
to the processed audio signal,
wherein sgn( ) is a sign function;
μ is a parameter defining a level of expansion.

45. The apparatus according to claim 1,
wherein neural network parameters of the neural network for processing the noise signal, or the signal derived from the noise signal, are obtained using
a processing of a training audio signal or a processed version thereof, in one or more training flow blocks in order to obtain a training result signal, wherein a processing of the training audio signal or of the processed version thereof using the one or more training flow blocks is adapted in dependence on a distorted version of the training audio signal and using the neural network, and
wherein the neural network parameters of the neural networks are determined, such that a characteristic of the training result audio signal approximates or comprises a predetermined characteristic.

46. The apparatus according to claim 1,
wherein the apparatus is configured to provide neural network parameters of the neural network for processing the noise signal, or the signal derived from the noise signal,
wherein the apparatus is configured to process a training audio signal or a processed version thereof, using the one or more flow blocks in order to obtain a training result signal, and
wherein the apparatus is configured to adapt a processing of the training audio signal or of the processed version thereof which is performed using the one or more flow blocks in dependence on a distorted version of the training audio signal and using the neural network, and
wherein the apparatus is configured to determine neural network parameters of the neural networks, such that a characteristic of the training result audio signal approximates or comprises a predetermined characteristic.

47. The apparatus according to claim 1,
wherein the apparatus comprises an apparatus for providing neural network parameters,
wherein the apparatus for providing neural network parameters is configured to provide neural network parameters of the neural network for processing the noise signal, or the signal derived from the noise signal,
wherein the apparatus for providing neural network parameters is configured to process a training audio signal or a processed version thereof, using one or more training flow blocks in order to obtain a training result signal, and
wherein the apparatus for providing neural network parameters is configured to adapt a processing of the training audio signal or the processed version thereof which is performed using the one or more flow blocks in dependence on a distorted version of the training audio signal and using the neural network;
wherein the apparatus is configured to determine neural network parameters of the neural networks, such that a characteristic of the training result audio signal approximates or comprises a predetermined characteristic.

48. The apparatus according to claim 1,
wherein the one or more flow blocks are configured to synthesize the processed audio signal on the basis of the noise signal under the guidance of the input audio signal.

49. The apparatus according to claim 1,
wherein the one or more flow blocks are configured to synthesize the processed audio signal on the basis of the noise signal under the guidance of the input audio signal using the affine processing of sample values of the noise signal, or of a signal derived from the noise signal,
wherein processing parameters of the affine processing are determined on the basis of sample values of the input audio signal using the neural network.

50. The apparatus according to claim 1,
wherein the apparatus is configured to perform a normalizing flow processing, in order to derive the processing audio signal from the noise signal.

51. An apparatus for providing neural network parameters for an audio processing,
wherein the apparatus is configured to process a training audio signal, or a processed version thereof, using one or more flow blocks in order to obtain a training result signal,
wherein the apparatus is configured to adapt a processing performed using the one or more flow blocks in dependence on a distorted version of the training audio signal and using a neural network;
wherein the apparatus is configured to determine neural network parameters of the neural networks, such that a characteristic of the training result audio signal approximates or comprises a predetermined characteristic,
wherein the apparatus is configured to apply depth-wise separable convolutions to a representation of the distorted version of the training audio signal, in order to derive a preprocessed representation of the distorted version of the training audio signal;
wherein the neural network is configured to receive the preprocessed representation of the distorted version of the training audio signal.

52. An apparatus for providing neural network parameters for an audio processing,
wherein the apparatus is configured to process a training audio signal, or a processed version thereof, using one or more flow blocks in order to obtain a training result signal,
wherein the apparatus is configured to adapt a processing performed using the one or more flow blocks in dependence on a distorted version of the training audio signal and using a neural network;
wherein the apparatus is configured to determine neural network parameters of the neural networks, such that a characteristic of the training result audio signal approximates or comprises a predetermined characteristic,
wherein the one or more flow blocks comprise at least one double coupling flow block;
wherein the double coupling flow block is configured to apply a first affine transform to a first portion of input signals to be modified by the double coupling flow block, and
wherein the double coupling flow block is configured to apply a second affine transform to a second portion of the input signals to be modified by the double coupling flow block.

53. An apparatus for providing neural network parameters for an audio processing,
wherein the apparatus is configured to process a training audio signal, or a processed version thereof, using one or more flow blocks in order to obtain a training result signal,
wherein the apparatus is configured to adapt a processing performed using the one or more flow blocks in dependence on a distorted version of the training audio signal and using a neural network;
wherein the apparatus is configured to determine neural network parameters of the neural networks, such that a characteristic of the training result audio signal approximates or comprises a predetermined characteristic,
wherein the apparatus is configured to obtain a preprocessed representation of the distorted version of the training audio signal using a filterbank comprising time resolutions and/or frequency resolutions which are adapted to time resolutions and/or frequency resolutions of a human auditory system; and
wherein the neural network is configured to receive the preprocessed representation of the distorted version of the training audio signal.

54. The apparatus according to claim 51,
wherein the apparatus is configured to evaluate a cost function in dependence on characteristics of the obtained training result signal, and
wherein the apparatus is configured to determine neural network parameters to reduce or minimize a cost defined by the cost function.

55. The apparatus according to claim 51, wherein the training audio signal and/or the distorted version of the training audio signal is represented by a set of time domain audio samples.

56. The apparatus according to claim 51, wherein a neural network associated with a given flow block of the one or more flow blocks is configured to determine one or more processing parameters for the given flow block in dependence on the training audio signal, or a signal derived from the training audio signal, and in dependence on the distorted version of the training audio signal.

57. The apparatus according to claim 51, wherein a neural network associated with a given flow block is configured to provide one or more parameters of an affine processing, which is applied to the training audio signal, or to a processed version of the training audio signal, or to a portion of the training audio signal, or to a portion of a processed version of the training audio signal during the processing.

58. The apparatus according to claim 57, wherein a neural network associated with the given flow block is configured to determine one or more parameters of the affine processing, in dependence on a first part of a flow block input signal or in dependence on a first part of a pre-processed flow block input signal and in dependence on the distorted version of the training audio signal, and
wherein an affine processing associated with the given flow block is configured to apply the determined parameters to a second part of the flow block input signal or to a second part of the pre-processed flow block input signal, to obtain an affinely processed signal; and
wherein the first part of the flow block input signal or of the pre-processed flow block input signal and the affinely processed signal form a flow block output signal of the given flow block.

59. The apparatus according to claim 58, wherein the apparatus is configured to apply an invertible convolution to the flow block input signal of the given flow block, to obtain the pre-processed flow block input signal.

60. The apparatus according to claim 51, wherein the apparatus is configured to apply a nonlinear input companding to the training audio signal prior to processing the training audio signal.

61. The apparatus according to claim 60, wherein the apparatus is configured to apply a μ-law transformation as the nonlinear input companding to the training audio signal.

62. The apparatus according to claim 60, wherein the apparatus is configured to apply a transformation according to
$$g ( x ) = sgn ( x ) \cdot \frac{ln ( 1 + μ \vert x \vert )}{ln ( 1 + μ )} ;$$
to the training audio signal,
wherein sgn( ) is a sign function;
μ is a parameter defining a level of compression.

63. The apparatus according to claim 51, wherein the one or more flow blocks are configured to convert the training audio signal into the training result signal.

64. The apparatus according to claim 51, wherein the one or more flow blocks are adjusted to convert the training audio signal into the training result signal under the guidance of the distorted version of the training audio signal signal, using the affine processing of sample values of the training audio signal, or of a signal derived from the training audio signal,
wherein processing parameters of the affine processing are determined on the basis of sample values of the distorted version of the training audio signal using the neural network.

65. The apparatus according to claim 51, wherein the apparatus is configured to perform a normalizing flow processing, in order to derive the training result signal from the training audio signal.

66. A method for providing a processed audio signal on the basis of an input audio signal,
wherein the method comprises processing a noise signal, or a signal derived from the noise signal, using one or more flow blocks, in order to obtain the processed audio signal,
wherein the method comprises adapting a processing performed using the one or more flow blocks in dependence on the input audio signal and using a neural network;
wherein the method comprises applying depth-wise separable convolutions to a representation of the input audio signal, in order to derive a preprocessed representation of the input audio signal;
wherein the neural network receives the preprocessed representation of the input audio signal.

67. A method for providing a processed audio signal on the basis of an input audio signal,
wherein the method comprises processing a noise signal, or a signal derived from the noise signal, using one or more flow blocks, in order to obtain the processed audio signal,
wherein the method comprises adapting a processing performed using the one or more flow blocks in dependence on the input audio signal and using a neural network;
wherein the one or more flow blocks comprise at least one double coupling flow block;
wherein the double coupling flow block applies a first affine transform to a first portion of input signals to be modified by the double coupling flow block, and
wherein the double coupling flow block applies a second affine transform to a second portion of the input signals to be modified by the double coupling flow block.

68. A method for providing a processed audio signal on the basis of an input audio signal,
wherein the method comprises processing a noise signal, or a signal derived from the noise signal, using one or more flow blocks, in order to obtain the processed audio signal,
wherein the method comprises adapting a processing performed using the one or more flow blocks in dependence on the input audio signal and using a neural network;
wherein the method comprises obtaining a preprocessed representation of the input audio signal using a filterbank comprising time resolutions and/or frequency resolutions which are adapted to time resolutions and/or frequency resolutions of a human auditory system; and
wherein the neural network receives the preprocessed representation of the input audio signal.

69. A method for providing neural network parameters for an audio processing,
wherein the method comprises processing a training audio signal, or a processed version thereof, using one or more flow blocks in order to obtain a training result signal,
wherein the method comprises adapting a processing performed using the one or more flow blocks in dependence on a distorted version of the training audio signal and using a neural network;
wherein the method comprises determining neural network parameters of the neural networks, such that a characteristic of the training result audio signal approximates or comprises a predetermined characteristic,
wherein the method comprises applying depth-wise separable convolutions to a representation of the distorted version of the training audio signal, in order to derive a preprocessed representation of the distorted version of the training audio signal;
wherein the neural network receives the preprocessed representation of the distorted version of the training audio signal.

70. A method for providing neural network parameters for an audio processing,
wherein the method comprises processing a training audio signal, or a processed version thereof, using one or more flow blocks in order to obtain a training result signal,
wherein the method comprises adapting a processing performed using the one or more flow blocks in dependence on a distorted version of the training audio signal and using a neural network;
wherein the method comprises determining neural network parameters of the neural networks, such that a characteristic of the training result audio signal approximates or comprises a predetermined characteristic,
wherein the one or more flow blocks comprise at least one double coupling flow block;
wherein the double coupling flow block applies a first affine transform to a first portion of input signals to be modified by the double coupling flow block, and
wherein the double coupling flow block applies a second affine transform to a second portion of the input signals to be modified by the double coupling flow block.

71. A method for providing neural network parameters for an audio processing,
wherein the method comprises processing a training audio signal, or a processed version thereof, using one or more flow blocks in order to obtain a training result signal,
wherein the method comprises adapting a processing performed using the one or more flow blocks in dependence on a distorted version of the training audio signal and using a neural network;
wherein the method comprises determining neural network parameters of the neural networks, such that a characteristic of the training result audio signal approximates or comprises a predetermined characteristic,
wherein the method comprises obtaining a preprocessed representation of the distorted version of the training audio signal using a filterbank comprising time resolutions and/or frequency resolutions which are adapted to time resolutions and/or frequency resolutions of a human auditory system; and
wherein the neural network receives the preprocessed representation of the distorted version of the training audio signal.

72. A non-transitory digital storage medium having a computer program stored thereon to perform the method of claim 66 or 67 or 68 or 69 or 70 or 71 when said computer program is run by a computer.
